(19) United States
(12) Patent Application Publication
(10) Pub. No.: US 2026/0030737 A1
(43) Pub. Date: Jan. 29, 2026

(54) METHODS AND SYSTEMS FOR DYNAMIC INSPECTION OF TRANSPORT STRUCTURES

(71) Applicant: Ivisys Sweden AB, Vallingby (SE)

(72) Inventors: Hans Stefan Bohman, Sollentuna (SE); Johan G. Forsberg, Kungsangen (SE); Jan Magnus Stjernberg, Ljungskile (SE)

(21) Appl. No.: 19/281,552

(22) Filed: Jul. 25, 2025

Related U.S. Application Data
(60) Provisional application No. 63/676,040, filed on Jul. 26, 2024.
(60) Provisional application No. 63/850,474, filed on Jul. 24, 2025.

(51) Int. Cl. G06T 7/00; G06T 5/80; G06T 7/593; G06V 10/141; G06V 10/56; G06V 10/764

(52) U.S. Cl. CPC G06T 7/0004; G06T 5/80; G06T 7/593; G06V 10/141; G06V 10/56; G06V 10/764

(57) ABSTRACT

Methods and systems for assessing, determining, or quantifying structural properties of a transport structure are provided, including methods and systems for capturing, using first and second image capture sensors of an inspection system, a plurality of 2-dimensional (2D) images of an inspection area of the inspection system; detecting, using an AI engine, a transport structure in a first image from the plurality of 2D images; extracting, using the AI engine and based on the first image, a second image from the plurality of 2D images; generating, using the AI engine and based on the first image and the second image, a computing model representing the transport structure; analyzing, using the AI engine, the computing model thereby generating analysis data; generating, using a data processing unit, a report that indicates the analysis data; and initiate formatting, using the data processing unit, for display on a graphical interface, the report.

### CROSS-REFERENCE TO RELATED APPLICATIONS

This application claims priority to U.S. Provisional Patent App. No. 63/676,040, filed on Jul. 26, 2024, and titled “AI-Driven Methods And Systems For Adaptive Inspection Of Transport Structures,” and to U.S. Provisional Patent App. No. 63/850,474, filed Jul. 24, 2025, and titled “Methods And Systems For Dynamic Inspection Of Transport Structures,” both of which are incorporated herein by reference in their entirety for all purposes.

### INTRODUCTION

This disclosure is directed to methods and systems that enable inspecting transport structures such as wood pallets and/or crates.

### BACKGROUND

A pervasive challenge in modern logistical operations, particularly within industries reliant on bulk material handling or containerized shipping, is the presence of defective transport structures such as pallets (e.g., wood pallets) or crates. These imperfections, ranging from structural damage and material fatigue to dimensional inaccuracies, significantly disrupt the efficiency and reliability of the supply chain. In particular, defective transport structures can lead to a cascade of negative consequences, including product damage during transit, increased safety risks for personnel, inefficient use of storage space, and ultimately, substantial losses due to delays, returns, and reprocessing of items on said transport structures. Current inspection methods often rely on sporadic sampling, which is inherently prone to errors, time-consuming, and insufficient for identifying all defective transport structures in a large volume of transport structures.

Therefore, there is a critical and unmet need for advanced, robust, and optimal methods for analyzing or scanning transport structures to comprehensively identify defective units. Such capabilities would not only mitigate the aforementioned risks and inefficiencies but also contribute to a streamlined, safer, and a more effective logistical ecosystem, thereby enhancing overall operational resilience. In addition, there is a clear need for intelligent control systems that can dynamically analyze transport structures to determine their structural integrity. Moreover, there is a need for methods and systems that facilitate the identification, isolation, and repair of defective transport structures, significantly enhancing logistical efficiency. Furthermore, there is a need for methods and systems that not only generate accurate structural integrity data but also do so with optimal data storage and efficient data transmission bandwidth considerations to ensure seamless integration into existing or new logistical frameworks.

### SUMMARY

This disclosure is directed to methods, systems, and computer program products for structurally analyzing transport structures. According to an embodiment, a method for structurally analyzing transport structures includes: illuminating, using an illumination subsystem of an inspection system, a transport structure undergoing inspection by the inspection system; capturing, by a first image capture sensor of the inspection system, a first image of the transport structure as the transport structure traverses an inspection area of the inspection system; capturing, by a second image capture sensor of the inspection system, a second image of the transport structure as the transport structure traverses the inspection area of the inspection system, wherein: the first image comprises a first 2-dimensional (2D) image captured using the first image capture sensor from a first perspective relative to the transport structure as the transport structure traverses the inspection area of the inspection system, and the second image comprises a second 2D image captured using the second image capture sensor from a second perspective relative to the transport structure as the transport structure traverses the inspection area of the inspection system; generating, by an artificial intelligence (AI) engine associated inspection system and based on the first image, a first computing model of the transport structure from the first perspective; generating, by the AI engine associated with the inspection system and based on the second image, a second computing model of the transport structure from the second perspective; analyzing, using the AI engine, the first computing model and the second computing model, the analyzing comprising: determining, based on the first computing model, first structural property data of the transport structure associated with the first image, determining, based on the second computing model, second structural property data of the transport structure associated with the second image, determining, based on one or more of the first structural property data and the second structural property data, impact data associated with the transport structure, and generating, using at least one data processing unit associated with the inspection system, analysis data indicating one or more of: an aggregate of the first structural property data, the second structural property data, and the impact data, dimensional data associated with the transport structure, maintenance or repair strategy data associated with the first structural property data, the second structural property data, or the impact data, sorting logic data associated with the first structural property data, the second structural property data, or the impact data, and inventory management data associated with the transport structure; generating, using the data processing unit associated with the inspection system, a report comprising a data file that indicates the analysis data; and initiate formatting, using the data processing unit associated with the inspection system, for display on a graphical interface, the report.

In another embodiment, a system and a computer program product can include or execute the one or more steps of the method described above. These and other implementations may each optionally include one or more of the following features.

In one embodiment, the transport structure is a pallet or a crate.

Furthermore, the illumination subsystem can comprise a laser illumination system that illuminates the transport structure prior to capturing the first image or the second image. In some cases, frequency data of the laser illumination system is matched to frequency data of at least the first image capture sensor or the second image capture sensor prior to capturing the first image or the second image.

In addition, the first image capture sensor or the second image capture sensor comprises at least one monochrome camera.

In some embodiments, the first image capture sensor or the second image capture sensor comprises at least one color camera.

Moreover, the AI engine referenced above can comprise a plurality of vision cores such that each vision core comprised in the plurality of vision cores analyzes a specific feature of: the first computing model of the transport structure from the first perspective; and the second computing model of the transport structure from the second perspective.

In some cases, at least one of the plurality of vision cores referenced herein can be used to map one or more datapoints in the first computing model or the second computing model to a height map data table and thereby determine height data for the transport structure.

Additionally, the first image capture sensor and the second image capture sensor do not capture 3-dimensional image data of the transport structure.

Moreover, the report referenced herein can enable confirming that the transport structure meets a predetermined structural specification.

In some embodiments, the inspection system is a multi-modal inspection system that leverages data from multiple modalities including: a first data modality associated with illuminations on the transport structure caused by the illumination subsystem; and a second data modality associated with surface indicia on the transport structure that are captured by at least one of the first image capture sensor or the second image capture sensor, the indicia comprising one or more of image or textual data.

Furthermore, the first image capture sensor includes a first application configured to capture and transmit images of the inspection area of the inspection system from the first perspective. In addition, the second image capture sensor includes a second application configured to capture and transmit images of the inspection area of the inspection system from the second perspective.

According to one embodiment, at least the first image of the transport structure or the second image of the transport structure comprises at least one of: 2D surface texture image data indicating material surface characteristics of the transport structure; and 2D deformable light pattern image data indicating a surface topology deviation caused by the illumination subsystem projecting one or more structured light patterns on the transport structure prior to capturing the first image or the second image.

The above method can further comprise preprocessing, by the data processing unit of the inspection system and prior to the analyzing, the first image and the second image to generate the first computing model of the transport structure and the second computing model of the transport structure, respectively, wherein the preprocessing comprises one or more of: normalizing lighting condition data in the first image or the second image, the lighting condition data being associated with an illumination effect on the transport structure when the illumination subsystem projects a light pattern onto the transport structure; correcting for: a first geometric distortion introduced into the first image during capturing the first image by the first image capture sensor, or a second geometric distortion introduced by the second image capture sensor during capturing the second image; and in response to the normalizing and correcting, generating the first computing model of the transport structure and the second computing model of the transport structure.

In some cases, the transport structure is propelled by a transport unit associated with the inspection system at a predetermined velocity. In addition, the predetermined velocity is matched to an image acquisition timing of the first image capture sensor and the second image capture sensor.

Furthermore, determining the first structural property data or determining the second structural property data associated with the above method can comprise identifying or quantifying structural properties of the transport structure based on 2D surface topology data or 2D surface texture data associated with the transport structure. Moreover, the identifying or quantifying can comprise: computationally correlating stored structural integrity metrics associated with the transport structure with data points comprised in the first computing model and the second computing model thereby generating structural anomaly data associated with the transport structure, the structural anomaly data including at least one of: cracks data associated with the transport structure; warps data associated with the transport structure; delamination data associated with the transport structure; joint failure data associated with the transport structure; and nail protrusion data associated with the transport structure.

In some embodiments, the impact data referenced above indicates material degradation on the transport structure based on textual or spectral features of the transport structure comprised in the first image or the second image, the material degradation comprising one or more of: moisture damage to the transport structure; chemical damage to the transport structure; operational damage due to improperly moving the transport structure from a first location to a second location; and storage damage due to improperly storing or stacking a material on the transport structure.

In some cases the report referenced above comprises comprehensive diagnostic data indicating one of: structural integrity rating data representing an assessment of an ability of the transport structure to withstand various forces and conditions without failing, deforming, or compromising safety of a load carried by the transport structure; textual or image data characterizing structural properties of the transport structure; and maintenance recommendation data representing a prescriptive plan to repair, restore, or treat the transport structure to: extend a useful life of the transport structure, ensure safety of the transport structure, or ensure that the transport structure maintains performance standards.

According to some embodiments, a method for assessing, determining, or quantifying structural properties of a transport structure comprises: capturing, using a first image capture sensor and a second image capture sensor of an inspection system, a plurality of 2-dimensional (2D) images of an inspection area of the inspection system; detecting, using an AI engine associated with the inspection system and based on the plurality of 2D images, a transport structure in a first image from the plurality of 2D images, wherein: the first image comprises a first 2D image of the transport structure in the inspection area, and the first image is captured from a first perspective of the first image capture sensor relative to the transport structure in the inspection area of the inspection system; extracting, using the AI engine associated with the inspection system and based on the first image, a second image from the plurality of 2D images, wherein: the second image comprises a second 2D image of the transport structure in the inspection area, and the second image is captured from a second perspective of the second image capture sensor relative to the transport structure in the inspection area of the inspection system; generating, using the AI engine and based on the first image and the second image: a first computing model representing the transport structure from the first perspective, and a second computing model representing the transport structure from the second perspective; analyzing, using the AI engine, the first computing model and the second computing model, the analyzing comprising one or more of: identifying or quantifying, based on the first computing model, first structural property data of the transport structure associated with the first image, identifying or quantifying, based on the second computing model, second structural property data of the transport structure associated with the second image, determining, based on one or more of the first structural property data and the second structural property data, impact data associated with the transport structure, and generating, using at least one data processing unit associated with the inspection system, analysis data indicating one or more of: an aggregate of the first structural property data, the second structural property data, and the impact data, dimensional data associated with the transport structure, maintenance or repair strategy data associated with the first structural property data, the second structural property data, or the impact data, sorting logic data associated with the first structural property data, the second structural property data, or the impact data, and inventory management data associated with the transport structure, generating, using the data processing unit associated with the inspection system, a report comprising a data file that indicates the analysis data; and initiate formatting, using the data processing unit associated with the inspection system, for display on a graphical interface, the report.

In another embodiment, a system and a computer program product can include or execute the one or more steps of the method described above. These and other implementations may each optionally include one or more of the following features.

The transport structure, in some embodiments, is a pallet or a crate.

In some embodiments, the first image capture sensor comprises at least a first color camera while the second image capture sensor comprises at least a second color camera.

Furthermore, the AI engine comprises a plurality of vision cores configured to implement feature classification computing operations on 2D images captured using one or more image capture sensors of the inspection system.

In exemplary implementations, at least one of the first image of the transport structure or the second image of the transport structure comprises or is associated with at least one of: 2D surface texture image data indicating material surface characteristics of the transport structure; or 2D deformable light pattern image data indicating a surface topology deviation caused by an illumination subsystem associated with the inspection system that projects one or more light patterns on the transport structure prior to, or during capturing the first image or the second image.

Additionally, a first application associated with the first image capture sensor can transmit, from the first image capture sensor, the first image to a non-transitory computer memory device associated with the inspection system. Similarly, a second application associated with the second image capture sensor can transmit the second image to the non-transitory computer memory device associated with the inspection system, such that: the first application and the second application operate independent of each other, and the AI engine accesses the non-transitory computer memory device to retrieve or extract the first image and the second image.

In some cases, one or more of: the first image capture sensor continuously captures a first set of images of the inspection area of the inspection system; the second image capture sensor continuously captures a second set of images of the inspection area of the inspection system; the plurality of 2D images of the inspection area comprises the first set of images and the second set of images; the plurality of 2D images of the inspection area are transmitted to a non-transitory memory device associated with the inspection system, wherein in response to the AI engine retrieving at least the first image and the second image from the non-transitory memory device thereby resulting in a reduced amount of images in the non-transitory memory device, the reduced amount of images are deleted thereby optimizing a data storage capacity of the non-transitory memory device.

In some embodiments, the first image capture sensor or the second image capture sensor can be applied to detect shadow data indicating one or more shadows projected onto the transport structure by at least an illumination unit associated with the inspection system.

The above method can further comprise analyzing, using the AI engine, the shadow data to determine at least height information associated with protrusions on the transport structure.

In some cases, the first image capture sensor captures a top view image of the transport structure while the second image capture sensor captures a side view image of the transport structure.

Additionally, the AI engine referenced herein can apply depth analysis to determine a height for the transport structure.

In exemplary embodiments, the first image capture sensor and the second image capture sensor are arranged about the inspection system to be orthogonal relative to each other.

Furthermore the first computing model and the second computing model are independently analyzed by the AI engine to generate the first structural property data, the second structural property data, and the impact data. In some embodiments, the first computing model and the second computing model are combined into an aggregate model representing the transport structure, such that the aggregate model is analyzed to generate the first structural property data, the second structural property data, and the impact data.

In some cases, the above method further comprises propelling, using a transport unit associated with the inspection system, the transport structure to the inspection area of the inspection system.

It is appreciated that the transport unit propels the transport structure at a velocity adjusted according to type data of the transport structure.

It is further appreciated that the transport unit is integrated into the inspection system and is directly controlled by a first control logic associated with the inspection system. In some cases, the transport unit is separate or distinct relative to the inspection system and is indirectly controlled by a second control logic that is not associated with the inspection system.

Also disclosed is an inspection system for assessing, determining, or quantifying structural properties of a transport structure, the inspection system comprising: a first image capture sensor configured to capture a first plurality of 2D images from a first perspective in an inspection area of the inspection system; a second image capture sensor configured to capture a second plurality of 2D images from a second perspective in the inspection area, a first application associated with the first image capture sensor, the first application comprising computing logic that is configured to transmit the first plurality of 2D images to a non-transitory computing memory device associated with the inspection system; a second application associated with the second image capture sensor, the second application comprising computing logic that is configured to transmit the second plurality of 2D images to the non-transitory computing memory device associated with the inspection system; an AI engine configured to: access the non-transitory computing memory device associated with the inspection system to retrieve a first image from the first plurality of 2D images, access, based on the first image, the non-transitory computing memory device associated with the inspection system to retrieve a second image from the second plurality of 2D images, generate, based on the first image and the second image, a computing model representing the transport structure; analyze the computing model, wherein to analyze the computing model comprises one or more of: identifying or quantifying, based on the computing model, first structural property data of the transport structure associated with the first image, identifying or quantifying, based on the computing model, second structural property data of the transport structure associated with the second image, and determining, based on one or more of the first structural property data and the second structural property data, impact data associated with the transport structure; at least one data processing unit comprising computing logic that: generates analysis data indicating one or more of: an aggregate of the first structural property data, the second structural property data, and the impact data, dimensional data associated with the transport structure, maintenance or repair strategy data associated with the first structural property data, the second structural property data, or the impact data, sorting logic data associated with the first structural property data, the second structural property data, or the impact data, and inventory management data associated with the transport structure, generates a report comprising a data file that indicates the analysis data, and initiates formatting, for display on a graphical interface, the report.

Also disclosed is a method for assessing, determining, or quantifying structural properties of a transport structure, the method comprising: capturing, using a first image capture sensor and a second image capture sensor of an inspection system, a plurality of 2-dimensional (2D) images of an inspection area of the inspection system; detecting, using an AI engine associated with the inspection system and based on the plurality of 2D images, a transport structure in a first image from the plurality of 2D images, wherein: the first image comprises a first 2D image of the transport structure in the inspection area, and the first image is captured from a first perspective of the first image capture sensor relative to the transport structure in the inspection area of the inspection system; extracting, using the AI engine associated with the inspection system and based on the first image, a second image from the plurality of 2D images, wherein: the second image comprises a second 2D image of the transport structure in the inspection area, and the second image is captured from a second perspective of the second image capture sensor relative to the transport structure in the inspection area of the inspection system; generating, using the AI engine and based on the first image and the second image, a computing model representing the transport structure; analyzing, using the AI engine, the computing model representing the transport structure, the analyzing comprising one or more of: identifying or quantifying, based on the computing model, first structural property data of the transport structure associated with the first image, identifying or quantifying, based on the computing model, second structural property data of the transport structure associated with the second image, and determining, based on one or more of the first structural property data and the second structural property data, impact data associated with the transport structure, and generating, using at least one data processing unit associated with the inspection system, analysis data indicating one or more of: an aggregate of the first structural property data, the second structural property data, and the impact data, dimensional data associated with the transport structure, maintenance or repair strategy data associated with the first structural property data, the second structural property data, or the impact data, sorting logic data associated with the first structural property data, the second structural property data, or the impact data, and inventory management data associated with the transport structure, generating, using the data processing unit associated with the inspection system, a report comprising a data file that indicates the analysis data; and initiate formatting, using the data processing unit associated with the inspection system, for display on a graphical interface, the report.

In some cases, the inspection system comprises a plurality of image capture sensors including the first image capture sensor and the second image capture sensor, wherein: the first image capture is paired with a third image capture sensor such that the first image capture sensor and the third image capture sensor are positioned to be opposite relative to each other; and the second image capture is paired with a fourth image capture sensor such that the second image capture sensor and the fourth image capture sensor are positioned to be opposite relative to each other. It is appreciated that this image capture sensor pairing beneficially enable capturing front lit and back lit images from opposite perspectives in the inspection area relative to a transport structure being imaged.

In exemplary cases, the plurality of image capture sensors comprise a fifth image capture sensor opposite to a sixth image capture sensor in the inspection area of the inspection system, such that: the fifth image capture sensor is movable to have a field of view that covers a 45-degree or a 60-degree angular span; and the sixth image capture sensor is movable to have a field of view that covers a 45-degree or a 60-degree angular span.

### BRIEF DESCRIPTION OF THE DRAWINGS

The disclosure is illustrated by way of example, and not by way of limitation in the figures of the accompanying drawings in which like reference numerals are used to refer to similar elements. It is appreciated that various features may not be drawn to scale and the dimensions of various features may be arbitrarily increased or reduced for clarity of discussion. Further, some components may be omitted in certain figures for clarity of discussion.

FIG. 1 shows an exemplary implementation where 2D cameras are used during the inspection of a pallet.

FIG. 2 also shows an exemplary bottom view of the disclosed inspection system.

FIG. 3 shows a top view of the inspection system indicating an exemplary arrangement of bottom lasers, bottom monochrome cameras, tunnel color cameras, and side color cameras of the inspection system.

FIG. 4 shows a side perspective view of the inspection system indicating a positional relationship of the various subsystems of the inspection system of FIGS. 2-3.

FIG. 5 shows an exemplary image taken by the top middle monochrome camera of the inspection system.

FIGS. 6 and 7 show exemplary 2D color images obtained using one or more 2D cameras with LED lighting of the inspection system.

FIG. 8 shows an image captured based on laser profiling of a pallet being inspected by the disclosed inspection system.

FIG. 9 shows a first exemplary workflow for structurally analyzing transport structures like pallets.

FIG. 10 shows a second exemplary workflow for analyzing image data by the AI engine of the inspection system.

FIG. 11 illustrates an exemplary computing environment for performing one or more computing operations associated with the disclosed inspection system.

FIGS. 12A and 12B show exemplary detailed workflows for non-destructively assessing structural integrity and material properties of a transport structure.

FIG. 13 shows an exemplary visualization of operations that can be implemented by the AI engine during analyzing images captured by one or more image capture sensors of the disclosed inspection system.

FIG. 14 shows an exemplary workflow for analyzing images captured by one or more image capture sensors comprised in the disclosed inspection system.

FIGS. 15 and 16 show exemplary quantification of features of a transport structure whose images are analyzed using the disclosed AI engine.

FIG. 17 highlights the AI engine's ability to detect structural distortions in a transport structure based on images of the transport structure.

FIG. 18 shows an exemplary implementation where the AI engine is used to assess fail rate data of a given transport structure.

FIGS. 19 and 20 show exemplary views/perspectives of images of a transport structure.

FIG. 21A shows an exemplary transport structure.

FIG. 21B shows an image of the exemplary transport structure that is captured using the disclosed inspection system.

FIG. 21C shows an exemplary computing model representing a data construct or a digital representation of the transport structure that is generated by the AI engine.

FIG. 22 shows an exemplary robot for dynamically moving transport structures to an inspection area of the inspection system

FIG. 23 shows a robot configured to dynamically move transport structures to the inspection system.

FIGS. 24 through 27 show exemplary user interfaces on a display computing device connected to the inspection system that beneficially enables configuring one or more subsystems of the disclosed inspection system.

FIG. 28 shows an exemplary image of a first flag generated for a first transport structure type relative to a second flag generated for a second transport structure.

FIG. 29 provides an exemplary visualization associated with a preliminary report generated in response to analyzing a plurality of transport structures.

FIG. 30A shows an exemplary top view of the disclosed inspection system.

FIG. 30B shows another exemplary top view with additional camera arrangements.

FIGS. 31A and 31B show an exemplary bottom and side brackets associated with the disclosed inspection system.

FIGS. 32 through 39 show exemplary views of the disclosed inspection system, according to some embodiments.

FIGS. 40A and 40B show views of a transport structure that is inspected by the disclosed inspection system.

FIG. 41A illustrates another exemplary workflow for assessing, determining, or quantifying structural properties of a transport structure using the disclosed inspection system.

FIG. 41B illustrates an additional exemplary workflow for assessing, determining, or quantifying structural properties of a transport structure using the disclosed inspection system.

Although similar reference numbers for the foregoing drawings may be used to refer to similar elements for convenience, it is appreciated that each of the various exemplary embodiments may be considered to be distinct variations. As used in this disclosure, the terms “embodiment,” “example embodiment,” “exemplary embodiment,” “implementation,” and the like do not necessarily refer to a single embodiment, although it may, and various example embodiments may be readily combined and interchanged, without departing from the scope or spirit of the present disclosure. Furthermore, the terminology used herein is for the purpose of describing example embodiments only, and are not intended to be limitations. In this respect, as used herein, the term “in” may include “in” and “on,” and the terms “a,” “an” and “the” may include singular and plural references. Furthermore, as used herein, the term “by” may also mean “from,” depending on the context. Furthermore, as used herein, the term “if” may also mean “when” or “upon,” depending on the context. Furthermore, as used herein, the words “and/or” may refer to and encompass any and all possible combinations of one or more of the associated listed items.

### DETAILED DESCRIPTION

Reference will now be made to various embodiments, examples of which are illustrated in the accompanying drawings and figures. In the following detailed description, numerous specific details are set forth in order to provide a thorough understanding of this disclosure. However, it will be apparent to one of ordinary skill in the art that the disclosure may be practiced without these specific details. In some instances, well-known methods, processes, components, systems, and networks have not been described in detail so as not to unnecessarily obscure aspects of the disclosed embodiments.

### Exemplary Embodiment 1

The disclosed methods and systems offer an automated inspection system for transport structures such (e.g., pallets or crates) that leverages artificial intelligence (AI) in detecting defects in pallets or crates and thereby determine or identify structurally compromised pallets or crates that need to be either repaired or replaced. According to one embodiment, the disclosed inspection system includes a machine or apparatus that has chain conveyors configured to move or optimally propel transport structures to a specific inspection position (e.g., an inspection section or an inspection area) relative to various scanning and indicator systems (e.g., cameras, lasers, light emission diodes (LEDs) comprised in the inspection system. In an exemplary embodiment, the canning and indicator systems comprised in the disclosed inspection system includes a set of cameras, lasers, and light emission diode (LED) lights that are configured to illuminate a pallet (e.g., a wood pallet, a plastic pallet, etc.) and/or a crate and/or other transport structures like skids, roll cradles, roll containers, etc. In particular, each camera system of the disclosed inspection system can have its own instance of a piece of imaging software associated with it.

According to one embodiment, the imaging software referenced above in association with each camera system of the disclosed inspection system is stored directly on each camera's internal storage device. A significant feature of this approach is that the imaging software can be specifically calibrated (e.g., automatically or dynamically calibrated from a central computing device such as a computing server with an AI engine that is proximal or distal relative to the inspection system) for each individual camera. This beneficially allows for great flexibility, as each camera system can be customized to its particular angle or perspective relative to a transport structure being scanned. This customized calibration provides a distinct advantage: some cameras can be configured for low-resolution imaging, which requires less bandwidth, while others can be precisely adjusted for high-resolution imaging to capture specific features of interest with greater detail.

According to one embodiment, the imaging software comprises device-specific grabber software configured for capturing and/or initiating the processing of image data and/or video data. In some cases, each instance of the imaging software beneficially facilitates:
maintaining a data connection link between each camara and a proximal or distal processing server (e.g., a server hosting an AI engine) configured to implement image and/or video data processing;
ensuring that each camera is live or otherwise online or active and ready to receive image capture commands (e.g., triggers);
extracting image and/or video data captured by each camera;
controlling storage of processed or unprocessed image and/or video data to a storage device integrated into each camera or a storage device proximal or distal relative to each camera; and
coordinating with an AI engine to accurately and timely process captured image and/or video data.

According to one embodiment, the imaging software comprises a combination of customized code and/or image acquisition mechanisms associated with an imaging framework (e.g., Common Vision Blox (CVB) framework).

Operationally, the inspection system has a plurality of setups or configurations including: a first setup based on 2-dimensional (2D) camera measurements; a second a setup based on 2D camera measurements with a spot height measurement feature; a third setup based on 2D camera measurements with a full height map data feature; a fourth setup based on lasers on the top side of the inspection system; and fifth a setup based on 2D camera measurements with full height map data in a table. According to one embodiment, the height map data table comprises a data table that stores spot height data values (e.g., associated with a pallet or crate being scanned) within a data table since there is no visual representation of height data associated with the pallet or crate under consideration during the imaging process. In particular, height data associated with the pallet or crate may be referenced in the height map data table based on image properties comprised in 2D images captured by one or more cameras of the inspection system.

In an exemplary embodiment, the disclosed inspection system uses two variants of a camera setup for image acquisition based on: 2D monochrome camera measurements in combination with laser lighting; or 2D color camera measurements in combination with LED lighting. These aspects are further discussed below.

According to some embodiments, the disclosed inspection system does not suffer from disadvantages associated with: converting 3-dimensional (3D) data into 2D data; creating, receiving, generating, or storing 2D data maps that indicate data values representing designated data offsets above a board surface of a transport structure (e.g., wood pallet); establishing a filter plane corresponding to specific data values and/or discarding z-coordinate data (e.g., height data) below established or predetermined data values; and/or creating or executing a repair recipe or repair strategy for repairing a defective transport structure. According to one embodiment, the repair strategy comprises determining, using the inspection system, defective aspects or sections of a pallet or crate and automatically customizing and/or implementing the repair strategy to fix or resolve the detected defect in the defective pallet or crate.

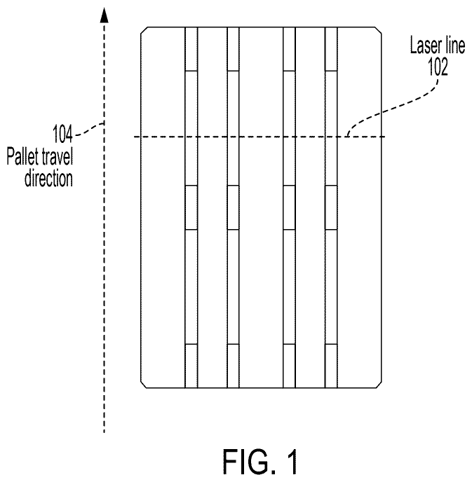

FIG. 1 shows an exemplary implementation where 2D cameras are used during the inspection of a pallet. In this setup, a laser may be positioned above the conveyers of the inspection system to shine or illuminate a laser line 102 on the pallet as pallet passes through the inspection system as shown. In one embodiment, the pallet is positioned at, or propelled to an inspection section/area or an inspection bay of the disclosed inspection system in order for the laser of the inspection system to illuminate the pallet. In some cases, the laser line 102 may be positioned to be perpendicular relative to the pallet's travel direction 104 as shown in FIG. 1.

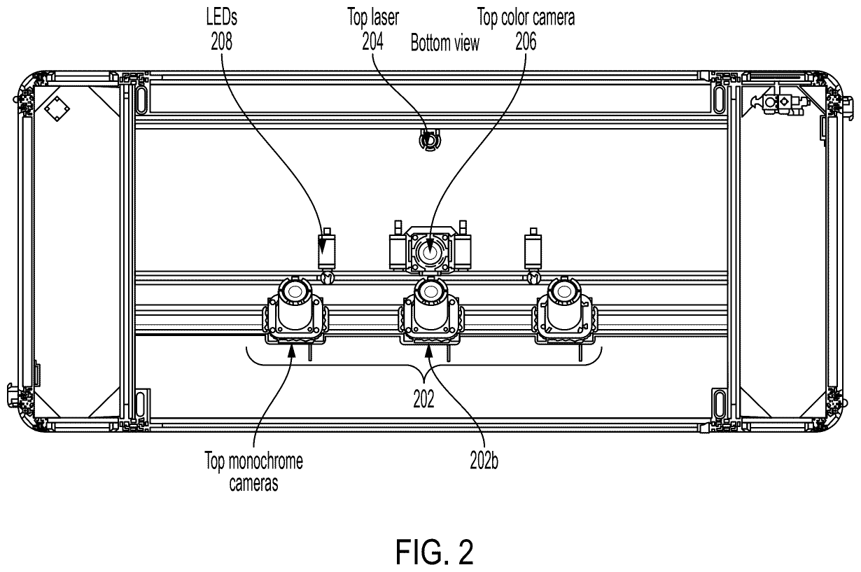

According to one embodiment, a set of top monochrome cameras 202 may be positioned or situated to face the laser line 102 as indicated in the bottom view of the inspection system of FIG. 2, such that each of the set of monochrome cameras 202 can cover a part of the laser line 102 with some overlap. This beneficially improves the resolution of the imaging of a pallet by the inspection system. It is appreciated that FIG. 2 also shows a top laser 204, a color camera 206, and at least one LED 208.

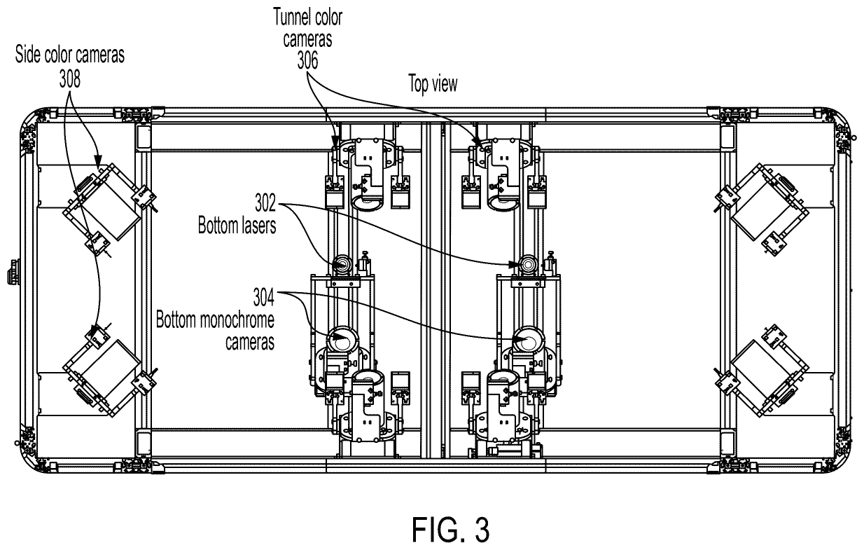

In some implementations, a set of lasers (e.g., bottom lasers) associated with the inspection system may be placed below the conveyers to shine laser lines at a pallet as the pallet passes through the inspection system. In particular, laser lines from the bottom lasers may be perpendicular relative to the pallet's travel direction as the pallet is propelled through the inspection section of the disclosed inspection system. In addition, a set of bottom monochrome cameras may also be arranged to face the laser lines from the bottom lasers such that each of the set of bottom monochrome cameras covers a part of the laser lines from the bottom lasers. These aspects are indicated in the view of the inspection system depicted in FIG. 3. In particular, FIG. 3 shows a top view of the disclosed inspection system indicating an exemplary arrangement of the bottom lasers 302, bottom monochrome cameras 304, tunnel color cameras 306, and side color cameras 308.

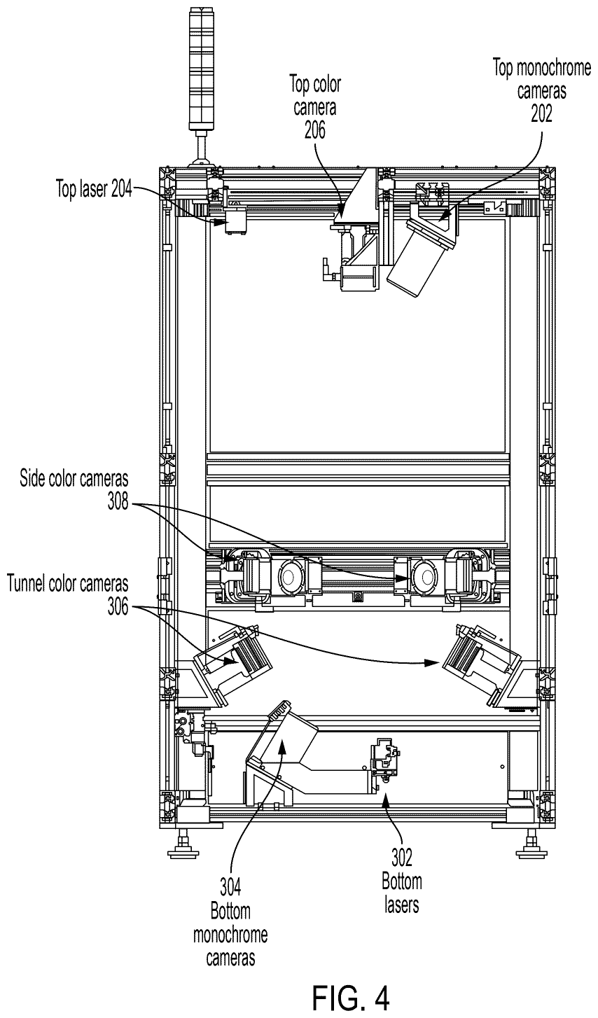

FIG. 4 shows a view of the inspection system indicating positional relationships between the aforementioned lasers and cameras, discussed in association with FIGS. 2 and 3, from a side perspective of the inspection system.

### Monochrome 2D Cameras With Laser Light

In this configuration, a pallet moves along the conveyers with the laser lines 102 hitting the pallet such that each monochrome camera produces a 2D image of the pallet. According to one embodiment, each 2D captured image may comprise a high intensity image, with one or more lasers of the inspection system acting as an intense or powerful light source. In such cases, one or more monochrome cameras of the inspection system act as line scanners that build images of the moving pallet (e.g., as the pallet moves through the inspection area) one row of pixels at the time thereby generating the 2D image. This 2D image, in some instances, does not contain any 3D data.

For example, as a pallet moves through the inspection system (e.g., through an inspection area or an inspection bay of the inspection system), a top laser may illuminate or transmit radiation that hits the pallet perpendicularly across the pallet as shown in FIG. 1. In some cases, three different top monochrome cameras 202 may be aimed at the laser line on the pallet to record the intensity of reflected laser light (e.g., reflected laser radiation), slice by slice, as the pallet moves through the laser line. According to one embodiment, pallet images are taken, built up, or constructed based on a specified amount of pictures or images indicating 2D lines which are formed into image visualizations of a pallet or crate under consideration. For example, the specified amount of pictures or images taken may range between 1500 pictures or images to 2500 pictures or images.

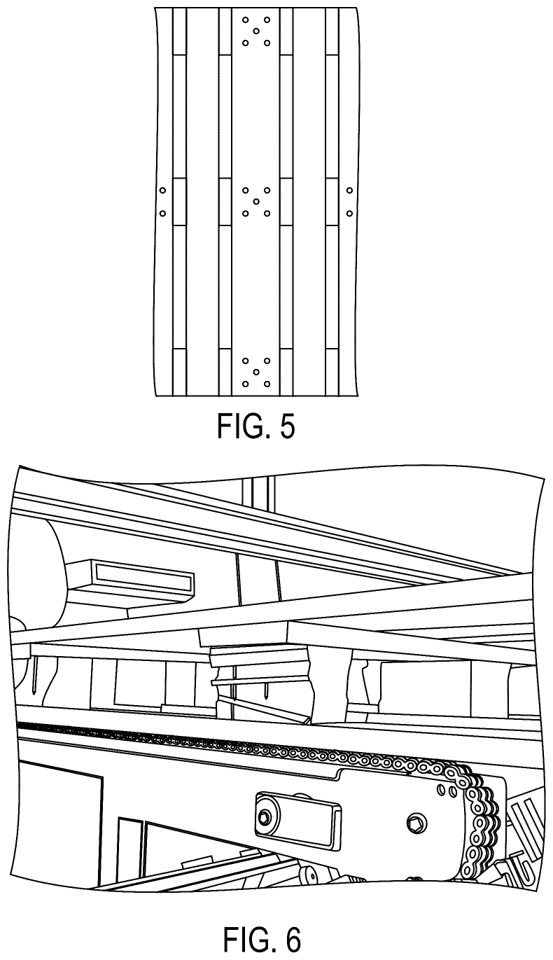

Furthermore, the disclosed methods and systems can advantageously ignore capturing height data values associated with a pallet being imaged thereby eliminating the need for capturing and storing height data of a given pallet being scanned. Rather, the disclosed methods and systems rely on a height map data table calibrated or set up for various pallets and crates being examined or inspected. This beneficially reduces the size of the images captured by the inspection system thereby saving usage of considerable amounts of computing memory within which the captured images are stored. For example, images captured by the inspection system may be saved within a computing storage structure associated with the inspection system using a 4 bit “.tiff” data format, or an 8 bit “.tiff” data format, or a 16 bit “tiff” data format thereby optimizing storage of large collections of pallet image data generated or captured by the inspection system. An example image (e.g., 2D image with height data in a height map data table)) taken by the top middle monochrome camera of the inspection system is shown in FIG. 5.

### Color 2D Cameras With LED Lighting

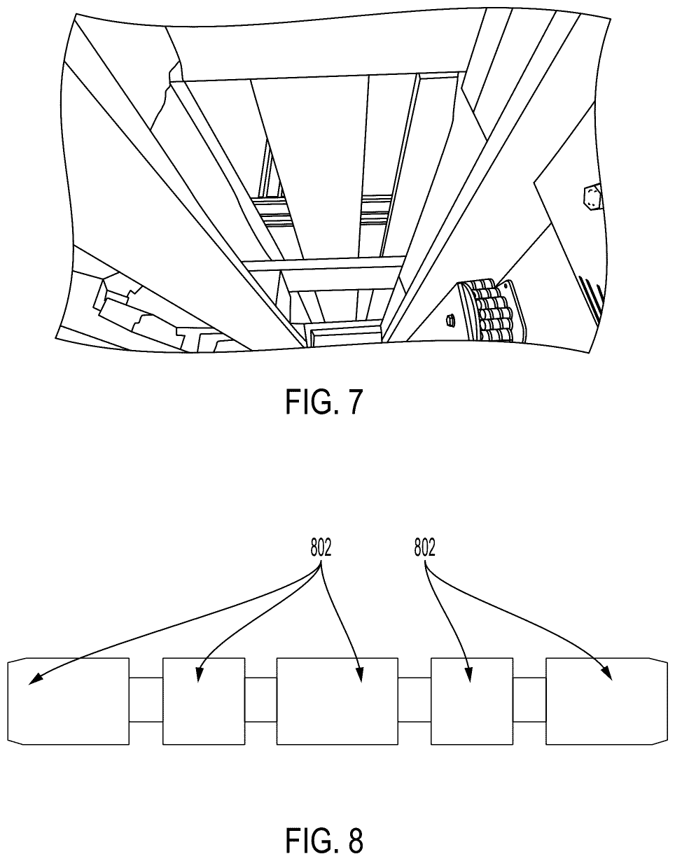

According to one embodiment, multiple color 2D cameras may be used by the inspection system to take photos or images of a pallet from multiple angles of a pallet as the pallet passes through the inspection system (e.g., through an inspection area of the inspection system). Furthermore, an image trigger frequency (e.g., a frequency with which images are taken) may be dynamically established or predetermined to capture images of the entire pallet with a framing (e.g., desired framing) of important or substantive details of the pallet. FIGS. 6 and 7 show exemplary 2D color images obtained by using one or more 2D cameras with LED lighting of the inspection system.

### Image Processing

According to some implementations, the inspection system leverages an AI intelligent or trainable data structure associated with an AI engine to optimally analyze or process captured images from one or more cameras of the inspection system. As previously stated above, the imaging software of each camera comprised in the inspection system may coordinate with the AI engine to detect defective pallets which have been inspected by the inspection system. According to one embodiment, the intelligent or trainable data structure comprises one or more neural networks, and/or one or more supervised or unsupervised learning data structures, and/or one or more decision tree data structures, and/or one or more random forest data structures, and/or one or more linear regression data structures, and/or one or more logistic regression data structures, etc. The one or more neural networks of the inspection system, for example, may be based on a Pytorch framework and/or an OpenCV framework, such that pixels of the 2D high intensity images captured by the monochrome 2D cameras of the inspection system may be grouped together based on pattern recognition associated with annotating and/or training the intelligent or trainable data structure of the AI engine. When a height value is needed for finding a specific defect, logic associated with the inspection system can use a lookup table (e.g., a height map data table) to find the height value corresponding to a set of pixels under consideration comprised in the grouped pixels (e.g., pixels grouped using the neural networks referenced above) of an image being analyzed.

The following additional features of the disclosed inspection system are provided by way of example, and not by way of limitation:
Finding pallet top boards: In one embodiment, 2D top high intensity images captured by one or more cameras of the inspections system may be segmented using the AI engine and thereby classify and group sets of pixels together of the 2D top high intensity images. This can result in a set of bounding boxes (e.g., 2D starting coordinates indicating width and length data in pixels) representing each board of a pallet associated with the 2D top high intensity images. From each bounding box, the inspection system extrapolates board characteristics of a pallet under consideration including determining: 2D position data of the board, length data of the board, width data of the board, rotation data of the board, displacement data of the board, etc.
Finding cracks in top boards: Here, 2D top high intensity image data (e.g., image data captured using one or more cameras of the inspection system) associated with a scanned pallet and machine learning can be used to find and measure any cracks within each top board bounding box.
Finding material losses in top boards: The inspection system may determine top board bounding boxes obtained from, for example, 2D top high intensity images (referenced above). These top board bounding boxes may be applied to height map information (e.g., from a height map data table) associated with a pallet. Any sufficient height differences within said bounding boxes may be detected and measured using the AI engine using, for example, the height map data table.
Finding bottom boards: Here, the 2D bottom high intensity images (e.g., images captured using one or more cameras of the inspection system) may be segmented with the AI engine to classify and group sets of pixels together. This can result in a set of bounding boxes (e.g., 2D starting coordinate data, width data, and length data in pixels) representing each board of a pallet being scanned. From each bounding box, the inspection system extrapolates board characteristics including 2D position data of the board, length data of the board, width data of the board, rotation data of the board, displacement data of the board, etc.).
Finding cracks in bottom boards: In these cases, the 2D bottom high intensity image (e.g., high intensity images captured using one or more cameras of the inspection system) of a board in combination with the AI engine can be used to find and measure any cracks within each bottom board's bounding box.
Finding discoloration of top boards: In instances such as these, the downward facing 2D color cameras can take pictures of the pallet as it moves along the inspection system. In particular, the AI engine may be used to find and measure discolored areas within a pallet, classifying said discolored areas by type (e.g., mold properties of the discolored areas, contamination properties of the discolored areas, paper label properties of the discolored areas, etc.).
Finding material loss, cracks, nails in pallet blocks: A set of 2D color cameras may be placed on each horizontal side of the conveyer (e.g., conveyor of the inspection system) facing towards the pallet path (see “side color camera” 308 in FIGS. 3 and 4). Another set of 2D color cameras of the inspection system may be placed underneath the conveyers facing upwards at an angle towards the pallet path (see tunnel color cameras 306 in FIGS. 3 and 4). The AI engine may be used to segment the images from these cameras to find regions of the images that contain the pallet blocks. Within these regions, the AI engine may be used to find and measure material losses, cracks, and nails, if present in a pallet being inspected, according to some embodiments.
Verifying block logo stamps: Here, a set of 2D color cameras 308 of the inspection system may be placed on each horizontal side of the conveyer facing towards the pallet path. The AI engine may be used to find and classify any logo or stamps on a pallet under consideration. Such classifications may include classifying manufacturer data associated with the pallet, production information data associated with the pallet, and International Plant Protection Convention (IPPC) data and International Standards for Phytosanitary Measures (ISPM) heat treatment data associated with the pallet.

When the inspection system collects the different data referenced above, it can store said data in a database proximal and/or distal relative to the inspection system. In some embodiments, a user database associated with the inspection system can contain user-specific tolerance level data that constraints or bounds or sets a data ranges between a lower and upper. The data ranges can be used to inform a calibration strategy for configuring one or more systems (e.g., cameras or one or more laser systems or one or more LEDs) of the inspection system. In some cases, the data ranges can be used to analyze images captured using the inspection system to ensure that the captured image conform to, or are within appropriate expected values with outlier values indicating measurement deviations, which can trigger a retaking of images or additional analysis of images with outlier data. In one embodiment, the inspection system compares measured data via captured images with user-specific tolerance level data and generates an indication (e.g., visual indication such as lights, alarms, etc.) when measurements (e.g., image measurements comprised in a captured image) deviate from the user-specific tolerance level data. For example, the inspection system may have one or more visual indicators such as lights that are automatically activated to: indicate that captured image measurements satisfy user-specific or user defined tolerance level data (e.g., a green light indication); and indicate that captured image measurements do not satisfy the user-specific tolerance level data (e.g., a red light indication). These indications may or may not include auditory indications (e.g., alarms) as well. It is appreciated that such an approach beneficially enables customizing the operation of the inspection system to adaptively analyze pallet image data based on user preferences and/or based on compliance requirements associated with an institution or a jurisdiction.

### Setup Using 2D Cameras With Spot Height Measurements

In some embodiments, as high-intensity data slices or lines are adaptively integrated into images captured by the inspection system, each top monochrome camera simultaneously collects a laser profile. This profile may be generated as laser lines 802 strike a pallet during the imaging process, as shown in FIG. 8. In particular, between about 1500 to 2500 data lines 802 may be built into each image captured by the inspection system to enable, for example, each top monochrome camera to collect or otherwise capture information that can be used for height data mapping associated with each pixel hit by the laser. To reiterate, FIG. 8 shows a laser profile collected by the top middle monochrome camera 202b of FIG. 1. According to one embodiment, the laser profile facilitates generating pallet or crate dimension data (e.g., pallet distance data, etc.) that are then stored in a height data table to facilitate the mapping of the dimension data, using one or more AI models, to height information associated with a pallet or crate under consideration.

From the laser profile data, the inspection system extrapolates pallet distance data from the laser origin to each captured pixel point along the slice and stores the distance data in a height data table. The height data table, according to one embodiment, is saved as a text file, for later parsing into a faster height data lookup table. The height data table for each acquired laser line may be saved as an array of height values (e.g., an x-value and a z-value). Each data point associated with the laser line, according to one embodiment, may be saved as a separate entry in the height data lookup table. This process beneficially allows for the following additional advantages:
Finding pallet planarity: The top board bounding boxes (e.g., obtained from high intensity 2D image data as discussed above) may be correlated with the height data lookup table. Height map values associated with a pallet being scanned may also be measured in, for example, four corners of the pallet and compared to each other.
Finding protruding nails on pallet top boards: The high intensity 2D images can also be used to identify and locate nails protruding from the surface of the deck boards within specified zones within each top board. The height data lookup tables can be used to find the heights in these areas to compare nail height with the area around the nail to determine how much the nail is protruding.
Finding material losses in bottom boards: The bottom board bounding boxes (e.g., obtained from bottom intensity 2D images as discussed above) may be correlated with the height data lookup table. Any sufficient height differences within said bounding boxes may then be determined and measured with the AI engine associated with the inspection system.
Finding tunnel height: The bottom high intensity 2D images obtained using cameras of the inspection system may be used to find tunnel boundary data of a pallet being inspected. The height data lookup table referenced above may be used to look up or identify the height of a tunnel comprised in a scanned pallet at one or more regions of the tunnel comprised in the scanned image of a pallet.

### Setup Using 2D Measurements and Full Height Map Data

In a third setup, in addition to the details noted above, height mapping may be performed on an entire expected surface of a pallet when the pallet passes through the inspection system.

### Setup Using Only Lasers On The Top Side

According to some embodiments, the setup or configuration of the inspection system is such that the bottom lasers may be removed, resulting in lasers only being positioned on one side (e.g., a top side) of the inspection system facing the top of a pallet undergoing inspection.

### Additional Aspects

According to some embodiments, the following process may be implemented using the inspection system to detect deckboards:
segmenting every pixel (e.g., comprised in a captured image) belonging to deck boards on each image of a pallet based on a deep neural network (DNN) analysis of one or more images of the pallet being scanned;
segmenting close-board cracks on each image of the pallet based on DNN analysis of images associated with the pallet being scanned;
stitching all images of the pallet based on the aforementioned segmentations;
aligning a digital orientation of the pallet being scanned based on the stitching;
if pallet-type data of the scanned pallet belongs to a given data category (e.g., perimeter bottom), then a deck board (db) mask of pallet may be split, based on the aligning, into horizontal and vertical db masks;
excluding close-board cracks from the db masks;
applying signal preprocessing on db masks;
fitting rotated rectangles over components on the db masks;
merging said rotated rectangles (e.g., if a board is broken such that merger would occur at this step; and
refining (e.g., expanding or shrinking based on fill ratio data) data boundaries associated with the merged rotated rectangles of a pallet under inspection.

According to some embodiments, the following process may be implemented using the inspection system to detect cracks in pallets:
segmenting cracks associated with a pallet being scanned based on each image of the pallet using a DNN on said image;
stitching crack masks associated with the image based on the segmenting;
finding initial crack component data associated with the pallet based on the stitching associated with the image;
filtering-out, based on a minimum overlap with boards, to remove one or more patterns that are similar to found cracks and close to the edges of the pallet;
filtering-out aspects outside the board parts; and
measuring width data, coverage data, distance-to-edge data associated with the pallets.

According to some embodiments, the following process may form part of a material loss detection process implemented by the inspections system:
considering all empty spaces in deckboard mask as initial material loss (ml) mask (DNN) associated with captured images of a pallet undergoing scanning;
stitching material loss masks associated with the inspected pallet based on the considering;
filtering-out outside data range values of the board boundaries from the stitched ml masks;
finding/determining components data in response to the filtering;
measuring density data and edge regularity data for each component datapoint and thereby remove detected image capturing issues;
calibrating various subsystems of the inspection system based on the density data and the edge regularity data; and
filtering, by size and distance to the edges.

According to some embodiments, the following process may form part of a protruding nail detection process (associated with a pallet with a protruding nail) implemented using the inspections system:
segmenting all nails detected in a captured image of the pallet, using a deep neural network;
stitching nail masks based on the segmenting to generate a stitched image;
finding nail components data in the stitched image based on the stitching;
calibrating and filtering-out small nails in the stitched image based on the nail component data;
measuring height data for each detected nail in the stitched image, and determining if the nail is protruding or not within the stitched image;
classifying, based on the measuring, the nail component into two protruding and regular parts;
finding the main protruding subcomponent based on the classifying;
measuring its height (e.g., the protruding nail's height) to determine if it (e.g., the nail whose height is measured) is large enough (e.g., based on the local difference);
finding the base material (e.g., deck board/cross board/block/background) associated with a nail whose height has been measured;
measuring a minimum distance from the nail whose height has been measured to board and thereby localize said nail and/or other nails comprised in the pallet whose image was taken by the inspection system; and
assigning a zone identifier to each nail on the pallet under consideration based on the minimum distance.

### Training Data

According to some embodiments, a plurality of images from multiple angles of a pallet or other transport structures are taken while passing one or more pallets through the disclosed inspection system. These images may be automatically collected and annotated by drawing (e.g., computationally or digitally drawing) segmentation masks around pallet components (e.g., boards, nails, blocks, etc.) during the imaging process by the inspection system. For example, the segmentation masks may comprise one or more binary images used to highlight specific regions or objects within subsequent images captured by the inspection system after training the AI engine of the inspection system. The one or more segmentation masks may be computationally used like a stencil, where pixels belonging to the subsequent pallet images of interest are marked (e.g., often with the value 1) and the background pixels are typically marked with 0. This allows for isolating and analyzing specific parts of an image of a pallet being scanned by the inspection system.

In some cases, segmentation masks for defects associated with one or more pallets can also be annotated to indicate cracks, material losses, protruding nails, contaminations, plastic wraps, etc., associated with the plurality of pallets being scanned. For example, some of the foregoing image annotations may be classification based where a pallet block is developed to have a stamp showing manufacturer data (e.g., data associated with the manufacturer of the pallet and/or data associated with the manufacturer of goods being transported using the pallet) including other qualitative data. In some cases, the annotations can be implemented using a tool that is trained to make annotation predictions for images of pallets being scanned. To artificially increase variations, some data transformations including skewing, resizing, and mirroring can be applied to images of pallets captured by the inspection system.

### Data Outputs

In some instances, a data report comprising multidimensional visualizations may be generated in response to inspecting a given pallet by the inspection system. It is appreciated that the disclosed inspection system can be used to determine, based on the data report, whether a given pallet meets a specific operational specification.

### Other Advantages

According to some implementations, use of one or more lasers of the inspection system beneficially facilitate filtering out all forms of radiations (e.g., lights) being incident on the pallets during the imaging process except for radiations from the laser. In particular, bandwidth data (e.g., signal frequency information) of the radiations of the various lasers of the inspection system can be matched to bandwidth data (e.g., signal frequency information) of one or more cameras of the inspection system to facilitate this filtering process and thereby enable the capturing of precise images with fine resolution. In some cases, the various lasers of the inspection system beneficially enable mapping of data components of captured images to data lookup table(s) and thereby determine z-coordinate values (e.g., height data values) of a pallet under consideration. These values are then requested after finding areas of interest via the DNNs as discussed above.

It is appreciated that one or more lasers of the inspection system advantageously enable acquiring image height data (e.g., also referred to as the z-value) for each of the pixels which can be used to intelligently determine specific height information corresponding to the acquired image data. In particular, this benefit is achieved using one or more AI models associated with the AI engine of the inspection system to adaptively or dynamically map specific datapoints (e.g., data points associated with determining height information for a pallet being scanned) comprised in the acquired image to information in height lookup data tables of the inspection system. This allows acquiring low latency image information that provide context on determining height data for a pallet or crate under consideration without the need for high data transmission bandwidth requirements and/or expensive storage demands associated with 3D imaging.

Furthermore, the disclosed methods and systems provide a technical solution for conducting full dimensional analysis of transport structures by leveraging captured two-dimensional (2D) precision images and a height map data table, thereby eliminating the requirement for three-dimensional (3D) imaging systems.

Specifically, the system acquires high-resolution 2D images of a transport structure(s) using the inspection system. Concurrently or subsequently, the height map data table is generated or accessed. This table contains precise depth or elevation data corresponding to specific points or regions within the 2D image's field of view of the transport structure(s). By programmatically correlating the spatial coordinates from the 2D precision image with the corresponding depth information in the height map data table, the inspection system can computationally reconstruct the three-dimensional characteristics (e.g., height, depth, volumetric data, surface contours) of the transport structure(s). This allows for comprehensive dimensional analysis, including but not limited to, cross-sectional profiling, wear detection, and structural integrity assessment, using inherently 2D captured data supplemented by external height intelligence (based on the height map table), rather than relying on complex and often costly 3D volumetric capture technologies.

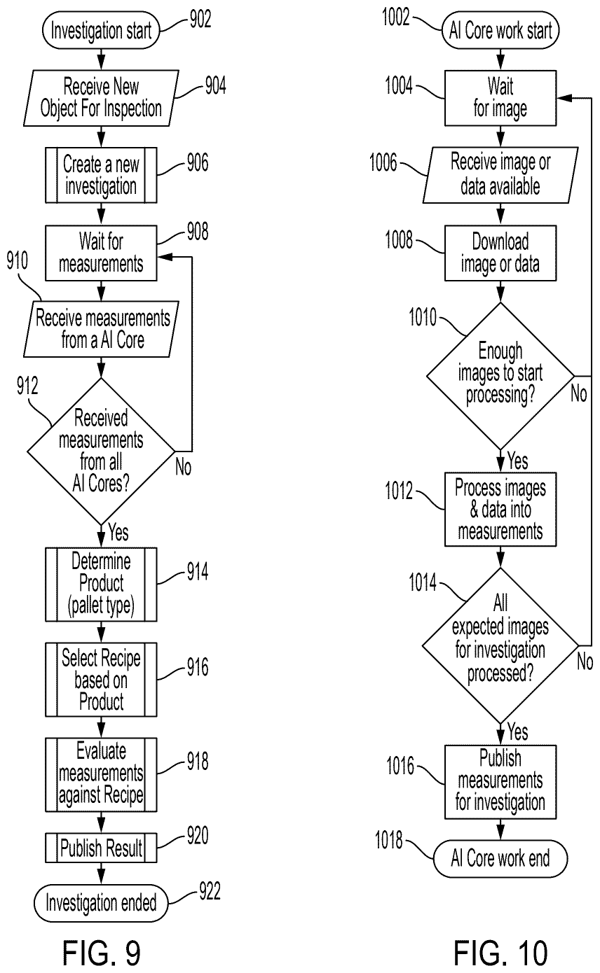

FIG. 9 shows an exemplary workflow for structurally analyzing transport structures like pallets. At block 902, a given pallet is designated as one to undergo an investigation or inspection process. This designation stage may include automatically loading the pallet onto the conveyor mechanism of the inspection system for reception by the inspection system at block 904 in order to inspect said pallet at the inspection area of the inspections system.

At block 906, a new investigation record is created for the loaded pallet. Turning to block 908, data measurements (e.g., image measurements) may be acquired using the inspection system such that the data measurements are transmitted to one or more AI models (e.g., also called AI cores) associated with the AI engine of the inspection system for further analysis at block 910.

In response to analyzing the captured images of the pallet by the AI models, various types of determinations can be made including: determinations regarding product type data associated with the pallet at block 914; determinations, at block 916, regarding “recipe” selections for the pallet based on the product type data; evaluation of measurements, at block 918, against the selected “recipe;” and publishing of results associated with blocks 914-920. It is appreciated that the “recipe” selections can comprise a “recipe” typically refers to a set of computing instructions or a defined computing workflow for configuring, processing, and manipulating images of the pallet under consideration. In particular, the “recipe” selections can serve as one or more blueprints for how to transform the image of the pallet under consideration from an initial state to a desired output, specifying the sequence of operations, filters, and settings to be applied.

In one embodiment, the results (e.g., results generated based on the selected “recipe”) may be comprised in a report including image and/or textual data indicating structural integrity properties of the pallet under consideration. Furthermore, the AI engine publishes the results in the form of a report or a file or a record comprising the fundamental data elements used to generate the published results associated with block 920 of FIG. 9.

FIG. 10 shows an exemplary workflow for analyzing image data by the AI engine of the disclosed inspection system. At blocks 1002-1006, the AI engine is initiated or otherwise initialized with appropriate AI models or AI cores to receive one or more images of a given pallet under consideration. Once an established or predetermined amount of images of the pallet is received or downloaded at block 1008, the AI engine determines whether enough images have been received based on the established or predetermined amount. Once this is confirmed, the AI engine processes the received images, at block 1012, to determine measurement data associated with the pallet under consideration. Once the AI engine confirms that all expected images of the pallet have been processed at block 1014, the AI engine publishes, at block 1016, results from the various processing stages of FIG. 10 and terminates the image analysis operations.

### Computing Environment

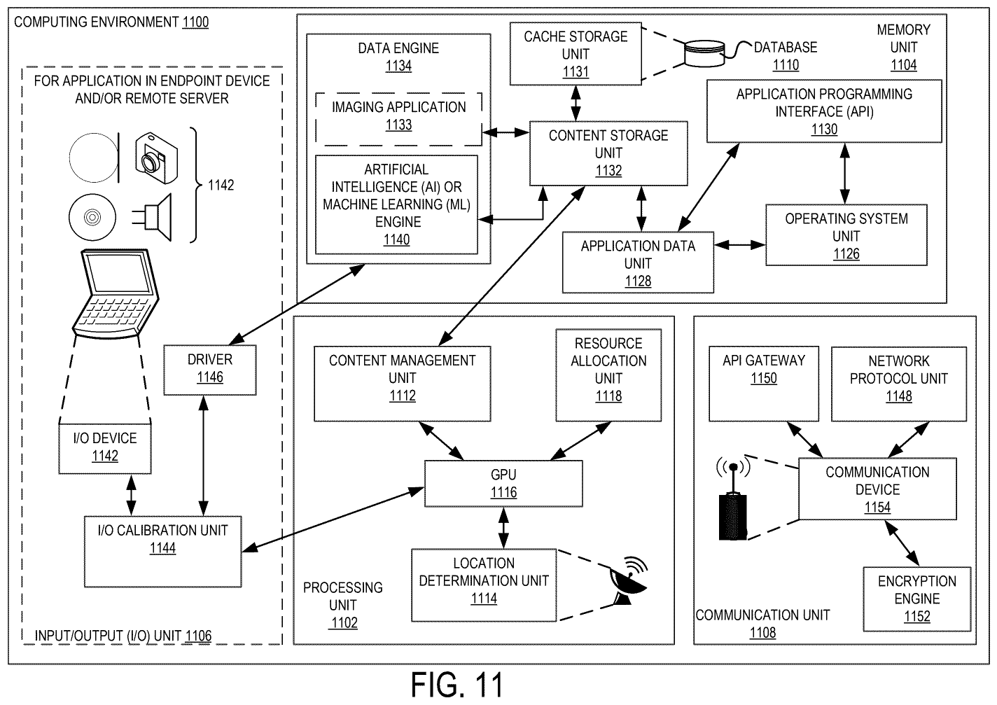

FIG. 11 illustrates an exemplary computing environment 1100 for performing one or more computing operations associated with the disclosed inspection system. It is appreciated that the computing environment 1100 may be implemented in in one or more elements of the inspection system such as servers hosting the AI engine and/or hardware and/or software comprised in the various cameras of the inspection system.

As seen in FIG. 11, the computing environment 1100 may include a processing unit 1102, a memory unit 1104, an I/O unit 1106, and a communication unit 1108. The processing unit 1102, the memory unit 1104, the I/O unit 1106, and the communication unit 1108 may include one or more subunits for performing operations described herein. Additionally, each unit and/or subunit may be operatively and/or otherwise communicatively coupled with each other so as to facilitate the operations described herein. The computing environment 1100 including any of its units and/or subunits may include general hardware, specifically-purposed hardware, and/or software (e.g., imaging software such as the Grabber software).

The processing unit 1102 may control one or more of the memory unit 1104, the I/O unit 1106, and the communication unit 1108 of the computing environment 1100, as well as any included subunits, elements, components, devices, and/or functions performed by the memory unit 1104, I/O unit 1106, and the communication unit 1108. The described sub-elements of the computing environment 1100 may also be included in similar fashion in any of the other units and/or devices included in the inspection system. Additionally, any actions described herein as being performed by a processor may be taken by the processing unit 1102 of FIG. 11 alone and/or by the processing unit 1102 in conjunction with one or more additional processors, units, subunits, elements, components, devices, and/or the like. Further, while one processing unit 1102 may be shown in FIG. 11, multiple processing units may be present and/or otherwise included in the computing environment 1100 or elsewhere in the overall inspection system. Thus, while instructions may be described as being executed by the processing unit 1102 (and/or various subunits of the processing unit 1102), the instructions may be executed simultaneously, serially, and/or otherwise by one or multiple processing units 1102 on one or more devices.

In some embodiments, the processing unit 1102 may be implemented as one or more computer processing unit (CPU) chips and/or graphical processing unit (GPU) chips and may include a hardware device capable of executing computer instructions. The processing unit 1102 may execute instructions, codes, data engines, artificial intelligent engines, computer programs, and/or scripts. The instructions, codes, computer programs, and/or scripts may be received from and/or stored in the memory unit 1104, the I/O unit 1106, the communication unit 1108, subunits, and/or elements of the aforementioned units, other devices, and/or computing environments, and/or the like.

In some embodiments, the processing unit 1102 may include, among other elements, subunits such as a content management unit 1112, a location determination unit 1114, a graphical processing unit (GPU) 1116, and a resource allocation unit 1118. Each of the aforementioned subunits of the processing unit 1102 may be communicatively and/or otherwise operably coupled with each other.

The content management unit 1112 may facilitate generation, modification, analysis, transmission, and/or presentation of content. Content may be file content, media content, image content, video content, or any combination thereof. In some instances, content on which the content management unit 1112 may operate includes device information, user interface data, images, text, themes, audio files, video files, documents, and/or the like. Additionally, the content management unit 1112 may control the audio-visual environment and/or appearance of application data during execution of various processes. In some embodiments, the content management unit 1112 may interface with a content server and/or memory location for execution of its operations.

The location determination unit 1114 may facilitate detection, generation, modification, analysis, transmission, and/or presentation of location information. Location information may include global positioning system (GPS) coordinates, an Internet protocol (IP) address, a media access control (MAC) address, geolocation information, a port number, a server number, a proxy name and/or number, device information (e.g., a serial number), an address, a zip code, and/or the like. In some embodiments, the location determination unit 1114 may include various sensors, radar, and/or other specifically-purposed hardware elements for the location determination unit 1114 to acquire, measure, and/or otherwise transform location information.

The GPU 1116 may facilitate generation, modification, analysis, processing, transmission, and/or presentation of content described above, as well as any data (e.g., scanning instructions, scan data, and/or the like) described herein. In some embodiments, the GPU 1116 may be used to render content for presentation on a computing device. The GPU 1116 may also include multiple GPUs and therefore may be configured to perform and/or execute multiple processes in parallel.

The resource allocation unit 1118 may facilitate the determination, monitoring, analysis, and/or allocation of computing resources throughout the computing environment 1100 and/or other computing environments. For example, the computing environment may facilitate a high volume of data (e.g., image data, video data, file data, audio data, etc.), to be processed and analyzed. As such, computing resources of the computing environment 1100 used by the processing unit 1102, the memory unit 1104, the I/O unit 1106, and/or the communication unit 1108 (and/or any subunit of the aforementioned units) such as processing power, data storage space, network bandwidth, and/or the like may be in high demand at various times during operation. Accordingly, the resource allocation unit 1118 may include sensors and/or other specially-purposed hardware for monitoring performance of each unit and/or subunit of the computing environment 1100, as well as hardware for responding to the computing resource needs of each unit and/or subunit. In some embodiments, the resource allocation unit 1118 may use computing resources of a second computing environment separate and distinct from the computing environment 1100 to facilitate a desired operation.

For example, the resource allocation unit 1118 may determine a number of simultaneous computing processes and/or computing requests. The resource allocation unit 1118 may also determine that the number of simultaneous computing processes and/or requests meets and/or exceeds a predetermined threshold value. Based on this determination, the resource allocation unit 1118 may determine an amount of additional computing resources (e.g., processing power, storage space of a particular non-transitory computer-readable memory medium, network bandwidth, and/or the like) required by the processing unit 1102, the memory unit 1104, the I/O unit 1106, the communication unit 1108, and/or any subunit of the aforementioned units for safe and efficient operation of the computing environment while supporting the number of simultaneous computing processes and/or requests. The resource allocation unit 1118 may then retrieve, transmit, control, allocate, and/or otherwise distribute determined amount(s) of computing resources to each element (e.g., unit and/or subunit) of the computing environment 1100 and/or another computing environment.

In some embodiments, factors affecting the allocation of computing resources by the resource allocation unit 1118 may include the number of computing processes and/or requests, a duration of time during which computing resources are required by one or more elements of the computing environment 1100, and/or the like. In some implementations, computing resources may be allocated to and/or distributed amongst a plurality of second computing environments included in the computing environment 1100 based on one or more factors mentioned above. In some embodiments, the allocation of computing resources of the resource allocation unit 1118 may include the resource allocation unit 1118 flipping a switch, adjusting processing power, adjusting memory size, partitioning a memory element, transmitting data, controlling one or more input and/or output devices, modifying various communication protocols, and/or the like. In some embodiments, the resource allocation unit 1118 may facilitate utilization of parallel processing techniques such as dedicating a plurality of GPUs included in the processing unit 1102 for running a multitude of processes.

The memory unit 1104 may be used for storing, recalling, receiving, transmitting, and/or accessing various files and/or data (e.g., image data, video data, etc.) during operation of computing environment 1100. For example, memory unit 1104 may be used for storing, recalling, and/or updating image and/or video data as well as other data associated with, resulting from, and/or generated by any unit, or combination of units and/or subunits of the computing environment 1100. In some embodiments, the memory unit 1104 may store instructions, code, and/or data that may be executed by the processing unit 1101. For instance, the memory unit 1104 may store code that execute operations associated with one or more units and/or one or more subunits of the computing environment 1100. For example, the memory unit 1104 may store code for the processing unit 1102, the I/O unit 1106, the communication unit 1108, and for itself.

Memory unit 1104 may include various types of data storage media such as solid state storage media, hard disk storage media, virtual storage media, and/or the like. Memory unit 1104 may include dedicated hardware elements such as hard drives and/or servers, as well as software elements such as cloud-based storage drives. In some implementations, memory unit 1104 may be a random access memory (RAM) device, a dynamic random access memory (DRAM) device, a static random access memory (SRAM) device, flash memory, read only memory (ROM) device, and/or various forms of secondary storage. The RAM device may be used to store volatile data and/or to store instructions that may be executed by the processing unit 1102. For example, the instructions stored by the RAM device may be a command, a current operating state of computing environment 1100, an intended operating state of computing environment 1100, and/or the like. As a further example, data stored in the RAM device of memory unit 1104 may include instructions related to various methods and/or functionalities described herein. The ROM device may be a non-volatile memory device that may have a smaller memory capacity than the memory capacity of a secondary storage. The ROM device may be used to store instructions and/or data that may be read during execution of computer instructions. In some embodiments, access to both the RAM device and ROM device may be faster to access than the secondary storage.

Secondary storage may comprise one or more disk drives and/or tape drives and may be used for non-volatile storage of data or as an over-flow data storage device if the RAM device is not large enough to hold all working data. Secondary storage may be used to store programs that may be loaded into the RAM device when such programs are selected for execution. In some embodiments, the memory unit 1104 may include one or more databases 1110 for storing any data described herein.

In some embodiments, memory unit 1104 and/or its subunits may be local relative to the inspection system. In other embodiments, the memory unit 1104 may be distal relative to the inspection system.

Turning back to FIG. 11, the memory unit 1104 may include subunits such as an operating system unit 1126, an application data unit 1128, an application programming interface 1130, a content storage unit 1132, a data engine 1134, and a cache storage unit 1131. Each of the aforementioned subunits of the memory unit 1104 may be communicatively and/or otherwise operably coupled with each other and other units and/or subunits of the computing environment 1100. It is appreciated that the memory unit 1104 may include other modules, instructions, or code that facilitate the execution of the techniques described herein. For instance, the memory unit 1104 may include one or more modules such as a receiving module, a mapping module, a determining module, a sequencing module, a quantifying module, a resolving module, a parsing module, a visualization module, etc., that comprise instructions executable by one or more computing device processors to accomplish the steps in the flowcharts of FIG. 9 and FIG. 10.

The operating system unit 1126 may facilitate deployment, storage, access, execution, and/or utilization of an operating system used by computing environment 1100 and/or any other computing environment described herein. In some embodiments, operating system unit 1126 may include various hardware and/or software elements that serve as a structural framework for processing unit 1102 to execute various operations described herein. Operating system unit 1126 may further store various pieces of information and/or data associated with the operation of the operating system and/or computing environment 1100 as a whole, such as a status of computing resources (e.g., processing power, memory availability, resource utilization, and/or the like), runtime information, modules to direct execution of operations described herein, user permissions, security credentials, and/or the like.

The application data unit 1128 may facilitate deployment, storage, access, execution, and/or utilization of an application utilized by computing environment 1100 and/or any other computing environment described herein. As such, application data unit 1128 may store any information and/or data associated with an application (e.g., Grabber imaging application). Application data unit 1128 may further store various pieces of information and/or data associated with the operation of an application and/or computing environment 1100 as a whole, such as a status of computing resources (e.g., processing power, memory availability, resource utilization, and/or the like), runtime information, user interfaces, modules to direct execution of operations described herein, user permissions, security credentials, and/or the like.

The application programming interface (API) unit 1130 may facilitate deployment, storage, access, execution, and/or utilization of information associated with APIs of computing environment 1100 and/or any other computing environment described herein. For example, computing environment 1100 may include one or more APIs for various devices, applications, units, subunits, elements, and/or other computing environments to communicate with each other and/or utilize the same data. Accordingly, API unit 1130 may include API databases containing information that may be accessed and/or utilized by applications, units, subunits, elements, and/or operating systems of other devices and/or computing environments. In some embodiments, each API database may be associated with a customized physical circuit included in memory unit 1104 and/or API unit 1130. Additionally, each API database may be public and/or private, and so authentication credentials may be required to access information in an API database. In some embodiments, the API unit 1130 may enable communication between one or more cameras of the inspection system with, for example, the AI engine 1140.

The content storage unit 1132 may facilitate deployment, storage, access, and/or utilization of information associated with performance of pallet inspection operations and/or framework processes performed by computing environment 1100 and/or any other computing environment described herein. In some embodiments, content storage unit 1132 may communicate with content management unit 1112 to receive and/or transmit content files (e.g., image and/or video content, media content, etc.).

The imaging application 1133 comprised in the data engine 1134 may be instantiated on each camera of the inspection system and may include instructions that facilitate taking of images of a transport structure (e.g., pallet or crate) and transmitting said images to, for example, an AI engine 1140 of the inspection system as discussed elsewhere herein. It is appreciated that the data engine 1134 may be adapted or include code or logic that coordinate the performance of any computing operation discussed in this disclosure. It is further appreciated that the AI engine 1140 may comprise and/or direct a plurality of vision cores such that each of the plurality of vision cores includes at least one computing model configured to analyze and/or process, and/or evaluate, and/or resolve image data or video data. According to one embodiment, the AI engine 1140 is configured to receive captured images (e.g., image data) or videos (e.g., video data) from a set of cameras of the inspection system. The AI engine 1140 may also be used to analyze the captured images or videos from the set of cameras of the inspection system and thereby generate structural analysis data associated with a transport structure such as a crate or a pallet (e.g., wood pallet). In some implementations, the AI engine 1140 achieves this by controlling a plurality of vision cores such that at least one vision core includes a computing model configured for image data analysis or video data analysis. In other words the AI engine can include sub-units such as the plurality of vision cores which it (the AI engine 1140) controls or otherwise directs to analyze and/or evaluate and/or process image data or video data associated with a crate or a pallet. As previously noted, the AI engine 1140 can comprise computing logic configured to implement the plurality of vision cores or AI models including the segmentation model, the classification model, the stitching model, the contrastive model, and the detection model, all of which are discussed above.

The cache storage unit 1131 may facilitate short-term deployment, storage, access, analysis, and/or utilization of data. In some embodiments, cache storage unit 1131 may serve as a short-term storage location for data so that the data stored in the cache storage unit 1131 may be accessed quickly. In some instances, the cache storage unit 1131 may include RAM devices and/or other storage media types for quick recall of stored data. The cache storage unit 1131 may include a partitioned portion of storage media included in memory unit 1104.

The I/O unit 1106 may include hardware and/or software elements for the computing environment 1100 to receive, transmit, and/or present information useful for inspecting pallets, crates, or other transport structures and/or other processes as described herein. For example, elements of the I/O unit 1106 may be used to receive input from a user. As described herein, I/O unit 1106 may include subunits such as I/O device(s) 1142, an I/O calibration unit 1144, and/or driver 1146.

The I/O device 1142 may facilitate the receipt, transmission, processing, presentation, display, input, and/or output of information as a result of executed processes described herein. In some embodiments, the I/O device 1142 may include a plurality of I/O devices. In some embodiments, I/O device 1142 may include a variety of elements that enable a user to interface with computing environment 1100. For example, I/O device 1142 may include a keyboard, a touchscreen, a button, a sensor, a biometric scanner, a laser, a microphone, a camera, and/or another element for receiving and/or collecting input from a user. Additionally and/or alternatively, I/O device 1142 may include a display, a screen, a sensor, a vibration mechanism, a light emitting diode (LED), a speaker, a radio frequency identification (RFID) scanner, and/or another element for presenting and/or otherwise outputting data to a user. In some embodiments, the I/O device 1142 may communicate with one or more elements of processing unit 1102 and/or memory unit 1104 to execute operations associated with inspecting transport structures including pallets and crates.

The I/O calibration unit 1144 may facilitate the calibration of the I/O device 1142. For example, I/O calibration unit 1144 may detect and/or determine one or more settings of I/O device 1142, and then adjust and/or modify settings so that the I/O device(s) 1142 may operate more efficiently.

In some embodiments, I/O calibration unit 1144 may use a driver 1146 (or multiple drivers) to calibrate I/O device 1142. For example, driver 1146 may include software that is to be installed by I/O calibration unit 1144 so that an element of computing environment 1100 (or an element of another computing environment) may recognize and/or integrate with I/O device 1142 for the disclosed methods.

The communication unit 1108 may facilitate establishment, maintenance, monitoring, and/or termination of communications between computing environment 1100 and other computing environments, third party server systems, and/or the like. Communication unit 1108 may also facilitate internal communications between various elements (e.g., units and/or subunits) of computing environment 1100. In some embodiments, communication unit 1108 may include a network protocol unit 1148, an API gateway 1150, an encryption engine 1152, and/or a communication device 1154. Communication unit 1108 may include hardware and/or software elements.

The network protocol unit 1148 may facilitate establishment, maintenance, and/or termination of a communication connection for computing environment 1100 by way of a network. For example, network protocol unit 1148 may detect and/or define a communication protocol required by a particular network and/or network type. Communication protocols used by network protocol unit 1148 may include Wi-Fi protocols, Li-Fi protocols, cellular data network protocols, Bluetooth® protocols, WiMAX protocols, Ethernet protocols, powerline communication (PLC) protocols, and/or the like. In some embodiments, facilitation of communication for computing environment 1100 may include transforming and/or translating data from being compatible with a first communication protocol to being compatible with a second communication protocol. In some embodiments, network protocol unit 1148 may determine and/or monitor an amount of data traffic to consequently determine which particular network protocol is to be used for establishing a secure communication connection, transmitting data, and/or performing malware scanning operations and/or other processes described herein.

The application programming interface (API) gateway 1150 may facilitate other devices and/or computing environments to access API unit 1130 of memory unit 1104 comprised in computing environment 1100. In some embodiments, API gateway 1150 may be required to validate user credentials associated with a user of an endpoint device prior to providing access to API unit 1130 to a user. API gateway 1150 may include instructions for computing environment 1100 to communicate with another device and/or between elements of the computing environment 1100.

The encryption engine 1152 may facilitate translation, encryption, encoding, decryption, and/or decoding of information received, transmitted, and/or stored by the computing environment 1100. Using encryption engine 1152, each transmission of data may be encrypted, encoded, and/or translated for security reasons, and any received data may be encrypted, encoded, and/or translated prior to its processing and/or storage. In some embodiments, encryption engine 1152 may generate an encryption key, an encoding key, a translation key, and/or the like, which may be transmitted along with any data content.

The communication device 1154 may include a variety of hardware and/or software specifically purposed to facilitate communication for computing environment 1100. In some embodiments, communication device 1154 may include one or more radio transceivers, chips, analog front end (AFE) units, antennas, processing units, memory, other logic, and/or other components to implement communication protocols (wired or wireless) and related functionality for facilitating communication for computing environment 1100. Additionally and/or alternatively, communication device 1154 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes.

### First Exemplary Detailed Workflow

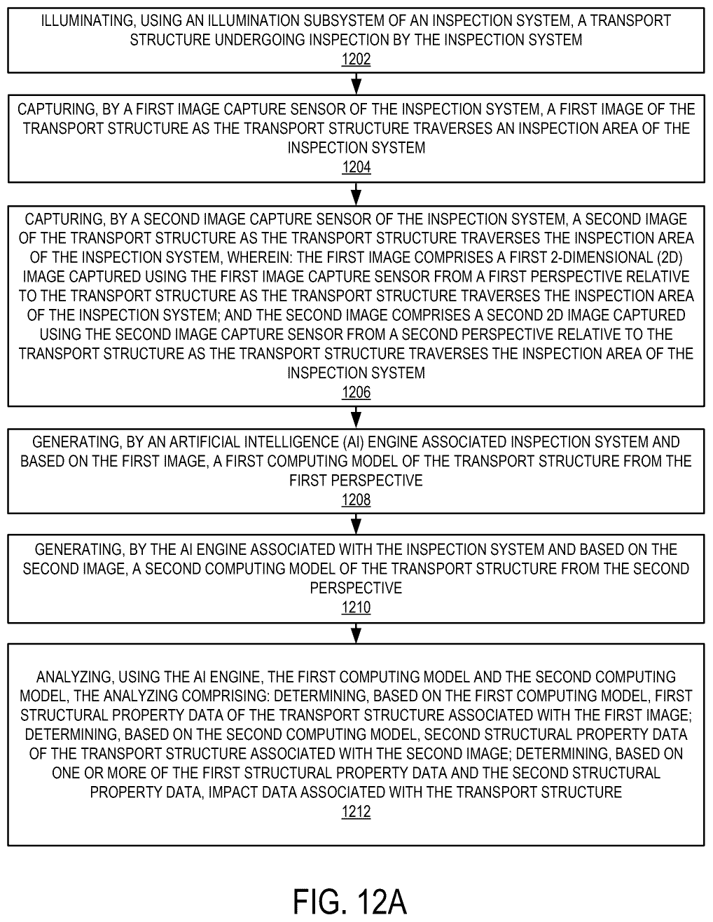

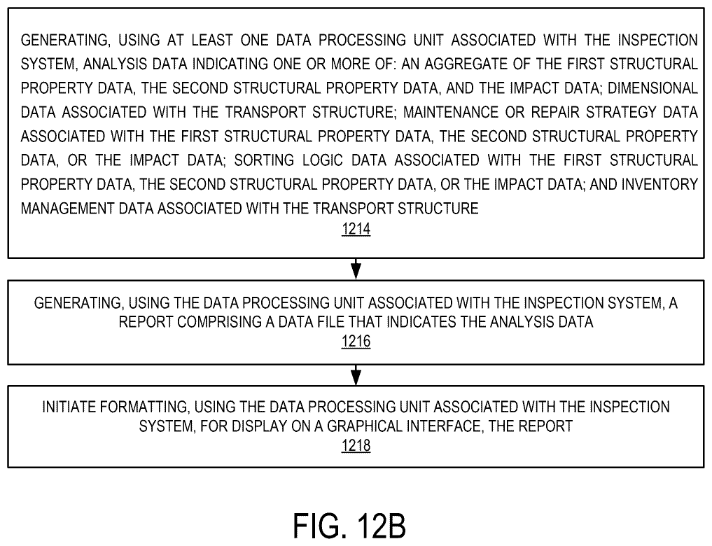

FIGS. 12A and 12B shows an exemplary detailed workflow for non-destructively assessing structural integrity and material properties of a transport structure. It is appreciated that one or more data engines stored in a memory device may enable or facilitate executing one or more of the various stages of the workflow of FIGS. 12A and 12B. For example, the one or more data engines can operate independently or in conjunction with a logistical software tool for transport structure monitoring and management.

At block 1202, the data engines can facilitate illuminating, using an illumination subsystem of an inspection system, a transport structure undergoing inspection by the inspection system

At block 1204, the one or more data engines can facilitate capturing, by a first image capture sensor of the inspection system, a first image of the transport structure as the transport structure traverses an inspection area of the inspection system. Similarly, the one or more data engines can enable capturing, by a second image capture sensor of the inspection system, a second image of the transport structure as the transport structure traverses the inspection area of the inspection system, as indicated at block 1206. It is appreciated that the first image comprises a first 2-dimensional (2D) image captured using the first image capture sensor from a first perspective relative to the transport structure as the transport structure traverses the inspection area of the inspection system. It is further appreciated that the second image comprises a second 2D image captured using the second image capture sensor from a second perspective relative to the transport structure as the transport structure traverses the inspection area of the inspection system.

Turning to block 1208, the one or more data engines can prompt an artificial intelligence (AI) engine associated inspection system and based on the first image, to generate a first computing model of the transport structure from the first perspective. In addition, the one or more data engines can also enable, at block 1210, the AI to generate, based on the second image, a second computing model of the transport structure from the second perspective. Additionally, the one or more data engine can enable the AI engine to analyze, at block 1212, the first computing model and the second computing model. The analyzing can comprise: determining, based on the first computing model, first structural property data of the transport structure associated with the first image; determining, based on the second computing model, second structural property data of the transport structure associated with the second image; and determining, based on one or more of the first structural property data and the second structural property data, impact data associated with the transport structure.

At block 1214, the one or more data engines can enable at least one data processing unit associated with the inspection system to generate, at block 1214, analysis data indicating one or more of: an aggregate of the first structural property data, the second structural property data, and the impact data; dimensional data associated with the transport structure; maintenance or repair strategy data associated with the first structural property data, the second structural property data, or the impact data; sorting logic data associated with the first structural property data, the second structural property data, or the impact data; and inventory management data associated with the transport structure.

Turning to block 1216, the one or more data engines may prompt the data processing unit associated with the inspection system, to generate a report comprising a data file that indicates the analysis data. At block 1218, the one or more data engines can cause the data processing unit associated with the inspection system, to initiate formatting, for display on a graphical interface, the report.

In another embodiment, a system and a computer program product can include or execute the one or more steps of the method described above. These and other implementations may each optionally include one or more of the following features.

In one embodiment, the transport structure is a pallet or a crate.

Furthermore, the illumination subsystem can comprise a laser illumination system that illuminates the transport structure prior to capturing the first image or the second image. In some cases, frequency data of the laser illumination system is matched to frequency data of at least the first image capture sensor or the second image capture sensor prior to capturing the first image or the second image.

In addition, the first image capture sensor or the second image capture sensor comprises at least one monochrome camera.

In some embodiments, the first image capture sensor or the second image capture sensor comprises at least one color camera.

Moreover, the AI engine referenced above can comprise a plurality of vision cores such that each vision core comprised in the plurality of vision cores analyzes a specific feature of: the first computing model of the transport structure from the first perspective; and the second computing model of the transport structure from the second perspective.

In some cases, at least one of the plurality of vision cores referenced herein can be used to map one or more datapoints in the first computing model or the second computing model to a height map data table and thereby determine height data for the transport structure.

Additionally, the first image capture sensor and the second image capture sensor do not capture 3-dimensional image data of the transport structure.

Moreover, the report referenced herein can enable confirming that the transport structure meets a predetermined structural specification.

In some embodiments, the inspection system is a multi-modal inspection system that leverages data from multiple modalities including: a first data modality associated with illuminations on the transport structure caused by the illumination subsystem; and a second data modality associated with surface indicia on the transport structure that are captured by at least one of the first image capture sensor or the second image capture sensor, the indicia comprising one or more of image or textual data.

Furthermore, the first image capture sensor includes a first application configured to capture and transmit images of the inspection area of the inspection system from the first perspective. In addition, the second image capture sensor includes a second application configured to capture and transmit images of the inspection area of the inspection system from the second perspective.

According to one embodiment, at least the first image of the transport structure or the second image of the transport structure comprises at least one of: 2D surface texture image data indicating material surface characteristics of the transport structure; and 2D deformable light pattern image data indicating a surface topology deviation caused by the illumination subsystem projecting one or more structured light patterns on the transport structure prior to capturing the first image or the second image.

The method described in FIGS. 12A and 12B can further comprise preprocessing, by the data processing unit of the inspection system and prior to the analyzing, the first image and the second image to generate the first computing model of the transport structure and the second computing model of the transport structure, respectively, wherein the preprocessing comprises one or more of: normalizing lighting condition data in the first image or the second image, the lighting condition data being associated with an illumination effect on the transport structure when the illumination subsystem projects a light pattern onto the transport structure; correcting for: a first geometric distortion introduced into the first image during capturing the first image by the first image capture sensor, or a second geometric distortion introduced by the second image capture sensor during capturing the second image; and in response to the normalizing and correcting, generating the first computing model of the transport structure and the second computing model of the transport structure.

In some cases, the transport structure is propelled by a transport unit associated with the inspection system at a predetermined velocity. In addition, the predetermined velocity is matched to an image acquisition timing of the first image capture sensor and the second image capture sensor.

Furthermore, determining the first structural property data or determining the second structural property data associated with FIGS. 12A and 12B can comprise identifying or quantifying structural properties of the transport structure based on 2D surface topology data or 2D surface texture data associated with the transport structure. Moreover, the identifying or quantifying can comprise: computationally correlating stored structural integrity metrics associated with the transport structure with data points comprised in the first computing model and the second computing model thereby generating structural anomaly data associated with the transport structure, the structural anomaly data including at least one of: cracks data associated with the transport structure; warps data associated with the transport structure; delamination data associated with the transport structure; joint failure data associated with the transport structure; and nail protrusion data associated with the transport structure.

In some embodiments, the impact data referenced above in association with FIGS. 12A and 12B indicate material degradation on the transport structure based on textual or spectral features of the transport structure comprised in the first image or the second image, the material degradation comprising one or more of: moisture damage to the transport structure; chemical damage to the transport structure; operational damage due to improperly moving the transport structure from a first location to a second location; and storage damage due to improperly storing or stacking a material on the transport structure.

In some cases the report referenced in association with FIGS. 12A and 12B comprise comprehensive diagnostic data indicating one of: structural integrity rating data representing an assessment of an ability of the transport structure to withstand various forces and conditions without failing, deforming, or compromising safety of a load carried by the transport structure; textual or image data characterizing structural properties of the transport structure; and maintenance recommendation data representing a prescriptive plan to repair, restore, or treat the transport structure to: extend a useful life of the transport structure, ensure safety of the transport structure, or ensure that the transport structure maintains performance standards.

According to one embodiment, multiple techniques are leveraged to optimally operate the disclosed inspection system. For example, the disclosed inspection system is optimized with image capture sensors (e.g., cameras) and one or more illumination subsystems (e.g., a laser) to dynamically acquire (e.g., synchronous or asynchronous acquisition) of transport structures. This can be achieved by strategically positioning various systems and subsystems of the inspection system to obtain 2-dimensional images of a transport structure being scanned or imaged. In addition, the lenses of the image capture sensors can be selected to enable the inspection system to robustly operate on large volumes of industrial type transport structures. Furthermore, selected lenses can be selected to account for variances in materials and/or color properties of a transport structure being scanned or imaged. Furthermore, the inspection system can include narrow filter systems comprised in, for example, the image capture sensors, thereby allowing the inspection system to beneficially enable capturing images of transport structures using a broad spectrum of light using the image capture sensors in combination with the one or more illumination subsystems of the inspection system. According to one embodiment, the image capture sensors can be configured to capture images of a transport structure under consideration at a rate of at least 1/850 seconds. This image capture rate beneficially ensures that the image capture system is independent of vibrations associated with moving the transport structure on the transport mechanism (e.g., conveyor mechanism) and/or induced vibrations from other systems proximal or distal relative to the inspection system. In some cases, images captured by the image capture sensors can comprise noise data that can be filtered out using, for example, a data processing unit comprising an artificial intelligence (AI) engine. Additionally, at least one image capture system of the disclosed inspection system can have at least 10× resolution thereby beneficially enabling the each image capture sensor to make image of the transport structure to appear at least ten times larger (e.g., to have a magnification of 10) or at least 15 times or at least 30 times or at least 40 times or at least 50 times or at least between 50-100 times than the actual size of the transport structure.

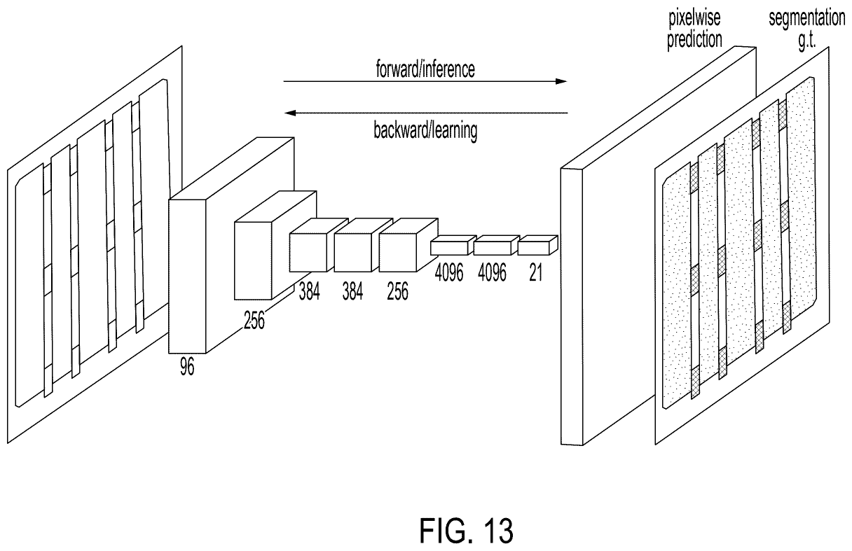

In some implementations, the AI engine referenced above can assess various features on images captured of transport structures that are scanned or imaged using the inspection system. For example, the AI engine can apply a deep multi-layered neural network during analysis of transport structure images by augmenting an intelligent structure (e.g., neural network structure) based on computationally fitting complex image patterns of the transport images using the AI engine prior to, or during analysis of images by the AI engine. By so doing, the AI engine to adapt or otherwise reconfigure itself as needed, to detect various data properties or details associated with a scanned transport structure. Thus, the AI engine is able to infer, based on captured images of transport structures as well as adaptively learn from new transport structure images as it is making inferences about said images. These aspects are illustrated in FIG. 13.

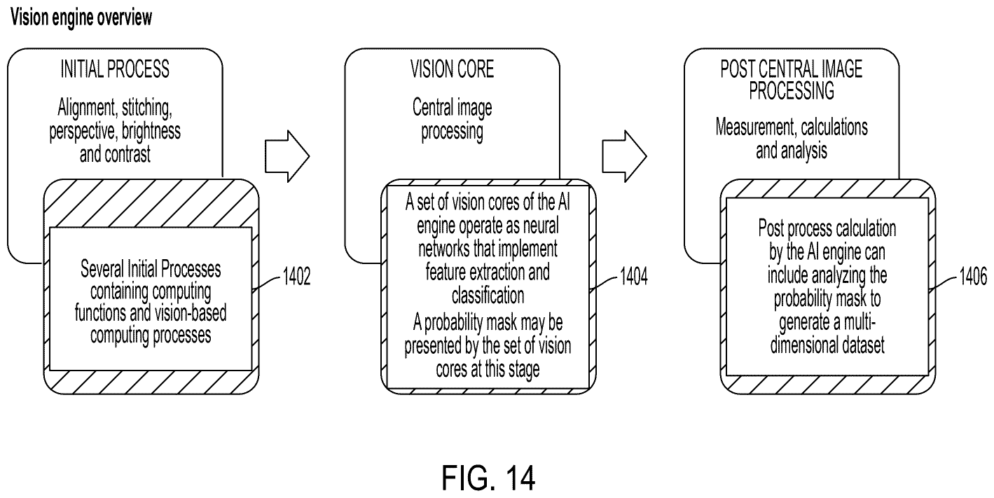

FIG. 14 shows an exemplary workflow for analyzing images captured by one or more image capture sensors comprised in the disclosed inspection system. As can be seen in the figure, received images captured by the image capture sensors can be preconditioned, at block 1402. This preconditioning can include: applying an alignment computing operation on the captured images; an image combining computing operation (e.g., stitching computing operation) that combines two or more of the captured images; a perspective and/or brightness and/or contrast adjustment computing operation on the captured images, etc.

At block 1404, one or more vision cores comprised in, or associated with the AI engine operate on the preconditioned image data generated from block 1402. This process can include applying the one or more vision cores to implement: feature extraction from the preconditioned images; feature classification of the extracted features; etc. It is appreciated that a probability mask may be applied to the preconditioned images to designate pixel data in the preconditioned images to facilitate the feature classification step by designating pixel values comprised in the pixel data as belonging to a specific data class or a specific feature of the transport structure whose image(s) are being analyzed. For example, the probability map can be used to quantify the likelihood of a pixel's (e.g., a pixel comprised in the preconditioned image data) association with a particular feature of the transport structure.

At block 1406, post processing computing operations can be implemented by the AI engine on the classifications implemented at block 1404. This can include transforming and/or formatting the generated classifications into a multi-dimensional dataset from which a report that indicates at least structural properties of the transport structure is generated.

According to one embodiment, the inspection system can beneficially sort a plurality of transport structures into various categories based on, for example, analyzing images of said pallets as said pallets traverse the inspection area of the inspection system. This can involve real-time or near real-time capturing and analysis of transport structures such that control logic is transmitted to a sortation system connected to the transport mechanism of the inspection system to beneficially enable the sortation system to sort the transport structures into various categories (e.g., healthy/strong/undamaged transport structures, defective transport structures, etc.).

According to one embodiment, the inspection system is able to classify transport structures stable or unstable transport structures based on the structural properties or structural characteristics of the transport structures. In some cases, the inspection system is configured to classify transport structures by type, meaning that different types of transport structures (e.g., wood pallets, plastic pallets, wood crates, plastic crates, etc.) to facilitate storing the transport structures by type based on analyzing imaging data of the different transport structures by the AI engine of the inspection system.

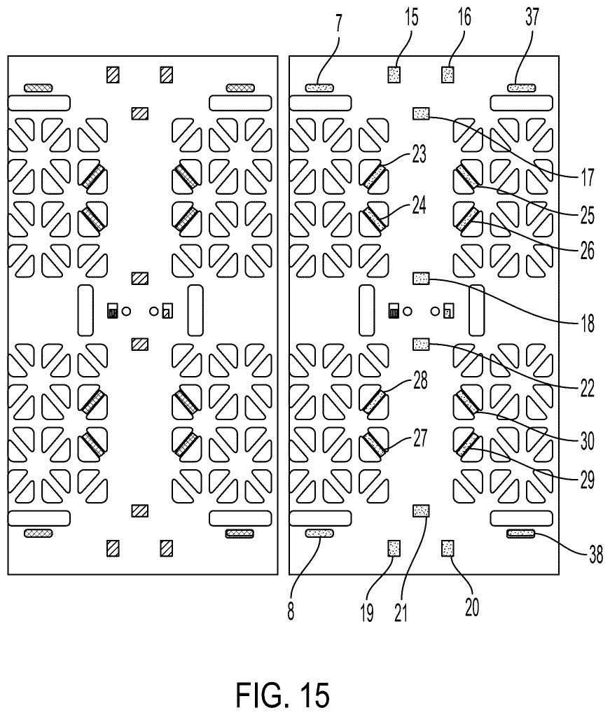

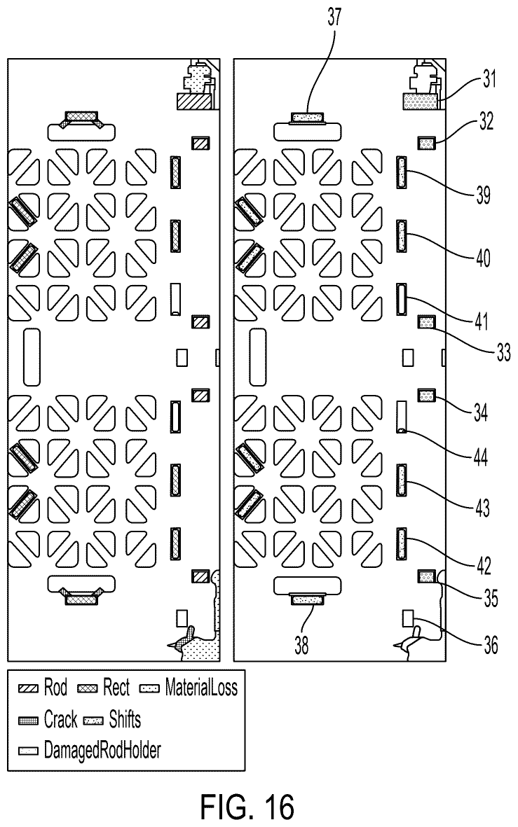

In FIGS. 15 and 16 of the disclosed inspection system is used to detect a missing component (FIG. 15) and material loss and cracks (FIG. 16) on a given transport structure. This can be achieved using an intelligent structure (e.g., a neural network structure) of the AI engine to map or quantify (see right images of FIGS. 15 and 16) various features on the transport structure in question and thereby generate a feature map (based on the quantification) that indicates the presence or absence of specific features on the transport structure being analyzed.

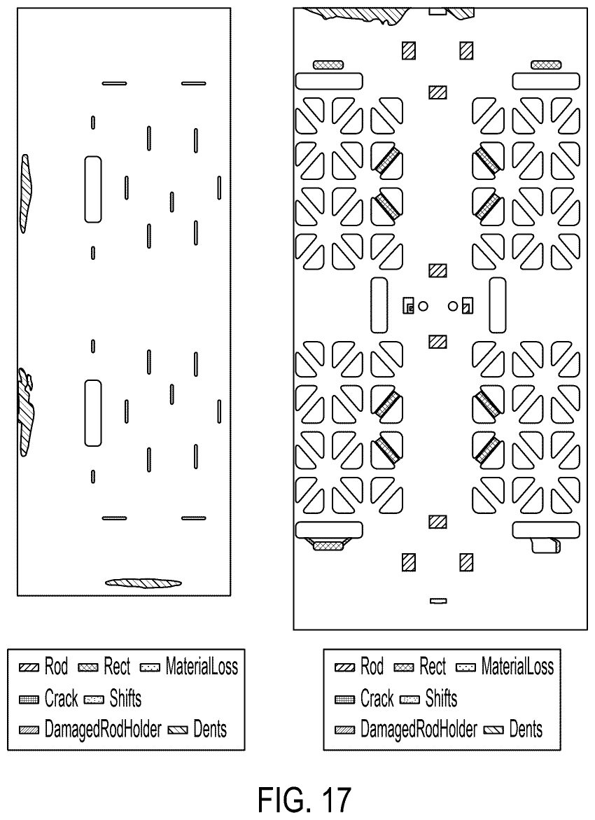

FIG. 17 highlights the AI engine's ability to detect structural distortions in a transport structure based on images of the transport structure. This process can involve classifying, using the intelligent structure of the AI engine, various measurements of the transport structure such as the length or width of the transport structure to assess whether the transport structure has dents, structural misalignments, structural deviations, or other structural damage.

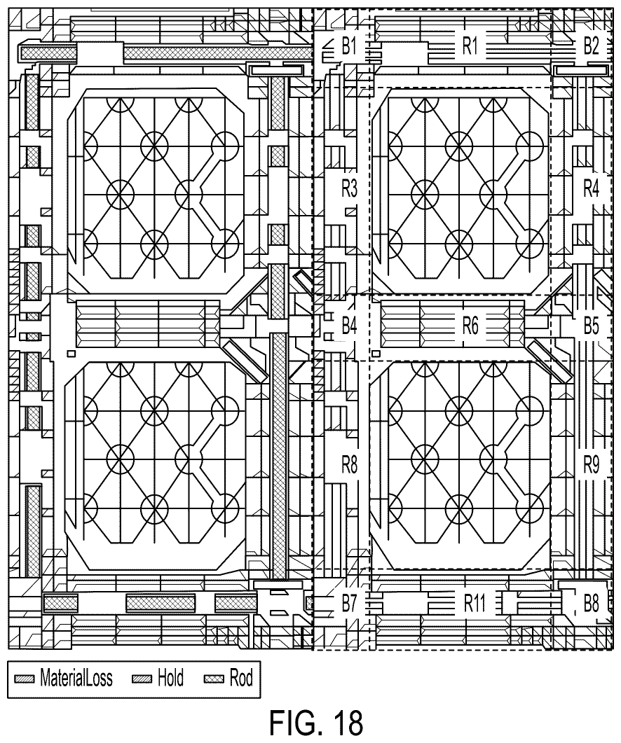

FIG. 18 shows an exemplary implementation where the AI engine is used to assess fail rate data of a given transport structure. This can involve using the intelligent structure of the AI engine to determine or quantify a probability of failure (e.g., structural compromise) of the transport structure using one or more images of the transport structure. This can be achieved by dimensional zoning (e.g., see zones B1, B2, B4, B5, B7, B8, R1, R3, R4, R6, R8, and R11 of figure) various features of the transport structure and determining whether the zoned areas meet certain criteria. The criteria can include a total length threshold parameter associated with the zoned areas of the transport structure indicating a structural defect or anomaly related to the components of the transport structure itself. The criteria may also include a continuous length threshold parameter indicating a metric used to quantify the severity of certain types of linear defects on the transport structure.

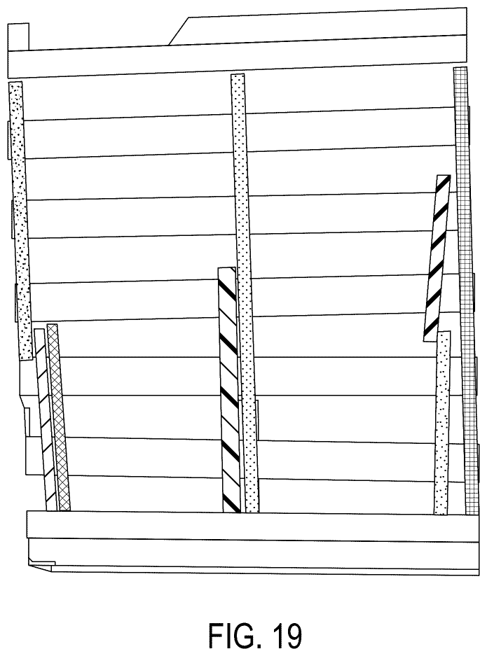

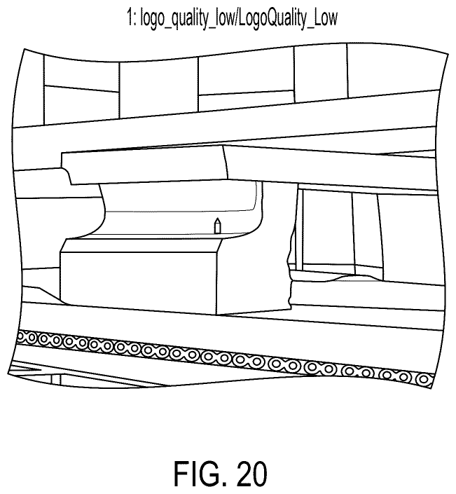

According to one embodiment, images of transport structures captured by the transport structures include a top view (e.g., see FIG. 19), and a bottom view (e.g., see FIG. 20). The top view image, for example, can be parameterized using one or more of: a length parameter associated with the top view of the transport structure; a width parameter associated with the top view of the transport structure; a length and width individual board parameter associated with the top view of the transport structure; a material loss on edge parameter associated with the top view of the transport structure; a material loss within envelope parameter associated with the top view of the transport structure; a protruding material parameter associated with the top view of the transport structure; a component alignment parameter associated with the top view of the transport structure; a cracks on boards parameter associated with the top view of the transport structure; a skewness and planarity parameter associated with the top view of the transport structure; a distance between boards parameter associated with the top view of the transport structure; a distance to edge parameter associated with the top view of the transport structure; a number of boards parameter associated with the top view of the transport structure; a board thickness parameter associated with the top view of the transport structure. Similarly, the bottom view of the transport structure can be parameterized using one or more of: an analysis of tunnels parameter associated with the bottom view of the transport structure; a tunnel width and height parameter associated with the bottom view of the transport structure; a no material in tunnels parameter associated with the bottom view of the transport structure; an analysis of deck and cross boards parameter associated with the bottom view of the transport structure; a chips/wanes/cracks parameter associated with the bottom view of the transport structure; a material loss parameter associated with the bottom view of the transport structure; a missing components parameter associated with the bottom view of the transport structure; a rotation parameter associated with the bottom view of the transport structure; a material loss/missing component parameter associated with the bottom view of the transport structure; a cracks parameter associated with the bottom view of the transport structure; a broken and repaired parameter associated with the bottom view of the transport structure; a nails parameter associated with the bottom view of the transport structure; a stamps parameter associated with the bottom view of the transport structure; a staples parameter associated with the bottom view of the transport structure; a plastic wrap/threads parameter associated with the bottom view of the transport parameter. It is appreciated that the one or more parameters of the top view and the one or more parameters of the bottom view are used, by the AI engine, to categorize and/or classify various features of a given transport structure.

According to one embodiment, the disclosed inspection system is configured to include complex hardware such as: two or more 2D image capture sensors that are combined to achieve maximum imaging effects of the transport structure during the imaging process; both color and black-white images are acquired using the two or more 2D image capture sensors; an illumination subsystem (e.g., a laser) configured to provide tailored illumination of the transport structures during imaging of the transport structures; filter systems communicatively connected to the two or more image capture sensors to filter captured images of the transport structure and/or guarantee that images of the transport structures are is in focus thereby creating a robust system that accounts for a location (e.g., industrial location, warehouse location, outdoor locations, etc.) or a changing environment within which the inspection system is implemented; a precise triggering and instant analysis mechanism that speeds up image capture and analysis by the AI engine. In addition, the AI engine leverages pattern recognition in analyzing images captured by the inspection system. In some cases, the AI engine is based on an intelligent data structure such as a deep neural network intelligent structure to facilitate complex analysis of images of transport structures. This advantageously provides consistent, precise, and timely analysis of transport structures to granularly determine and or differentiate various structural features (e.g., cracks vs holes vs deformations vs nail protrusions, etc.) of transport structures with accuracy. In some embodiments, the AI engine operates based on 26 or more neural networks, 30 or more neural networks, 40 or more neural networks, or at least 60 neural networks. With the increased number of neural networks comes substantial accuracy of the AI engine's analysis of images of the transport structures.

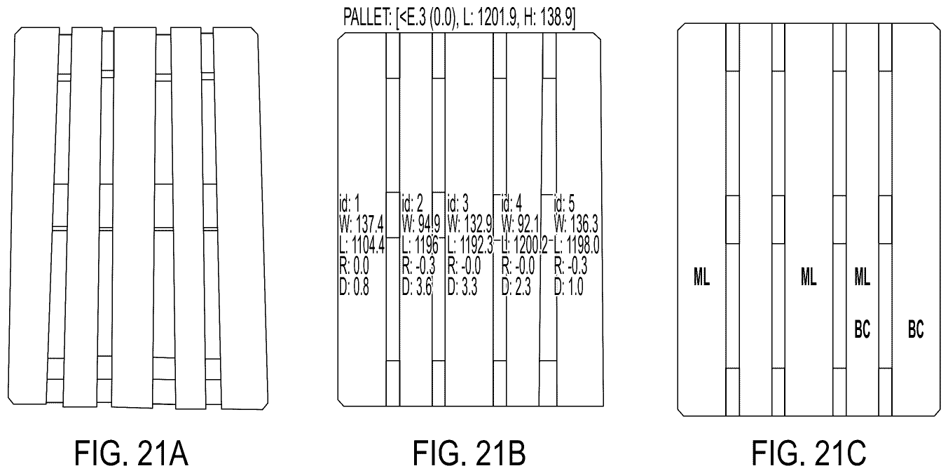

FIG. 21A shows an exemplary transport structure. FIG. 21B shows an image of the exemplary transport structure that is captured using the disclosed inspection system. In FIG. 21C, an exemplary computing model representing a data construct of the transport structure may derived and operated on by the AI engine. It is appreciated that the representation in FIG. 21C may not be derived from the image of FIG. 21B. Rather, FIG. 21C may represent a computing model of defect-free transport that is used by the AI engine to analyze the image of FIG. 21B.

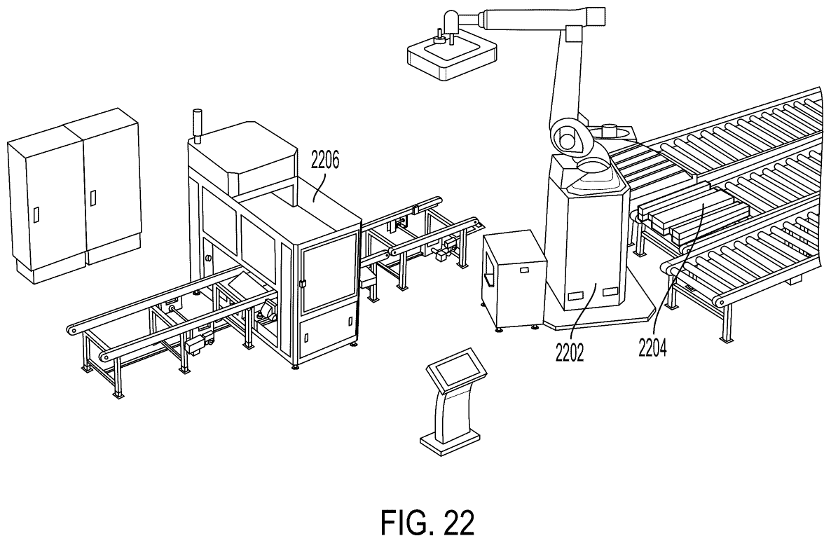

According to one embodiment, the disclosed inspection system is connected to a robot mechanism that is configured to dynamically move or load transport structures onto the transport mechanism with timing configurations that prevent jams on the transport mechanism as well as improve the transfer of transport structures from a stationary state onto the transport mechanism of the transport structure. In FIG. 22, robot 2202 is configured to dynamically move transport structures 2204 to the inspection system (e.g., to an inspection area of the inspection system).

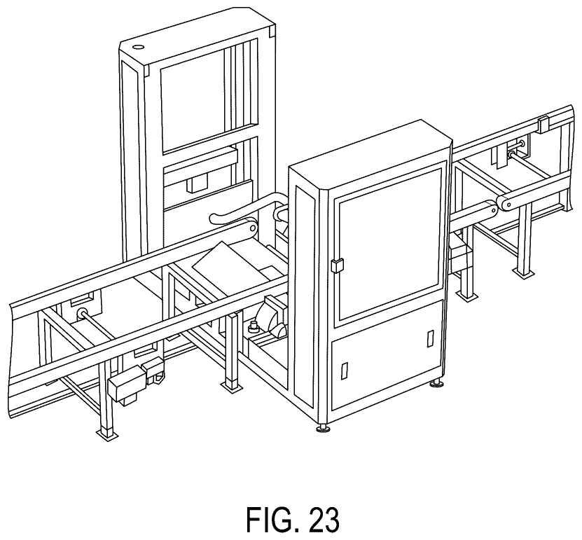

According to one embodiment, the disclosed inspection system is modularly designed so that a validation system is connected to the inspection system to implement quality control operations on pallets that have been scanned or imaged. For example, the validation system shown in FIG. 23 can be upstream coupled to the disclosed inspection system or downstream coupled to the inspection system.

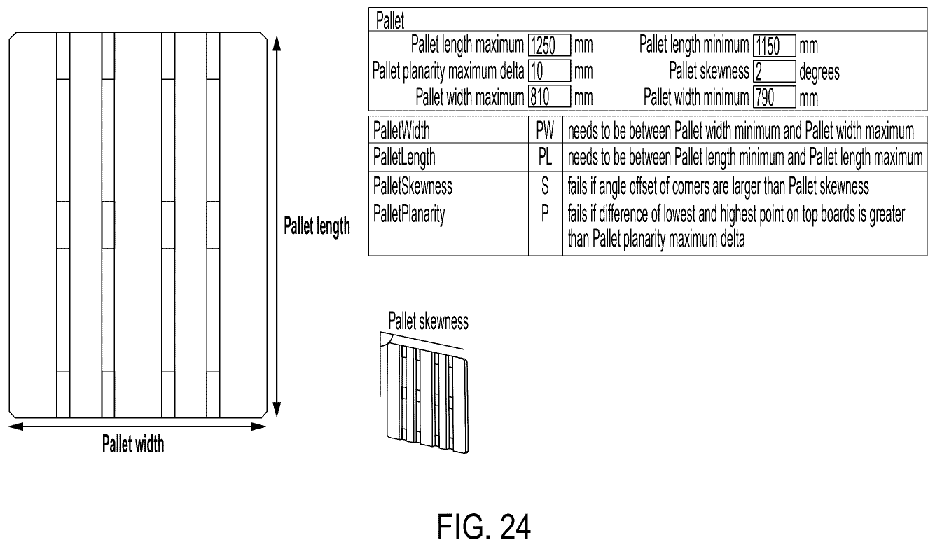

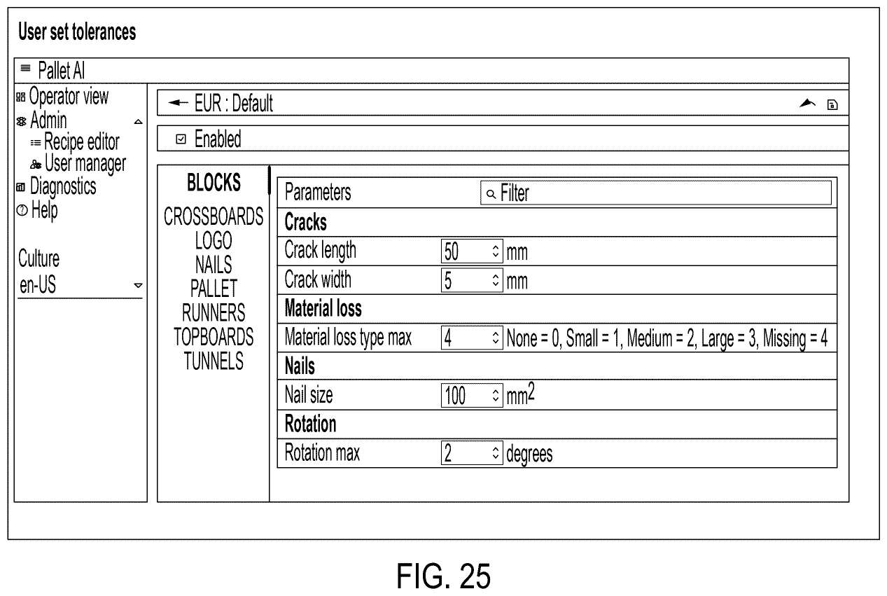

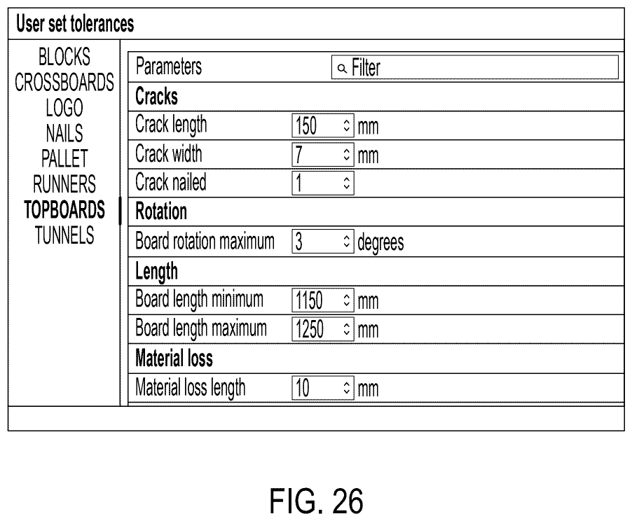

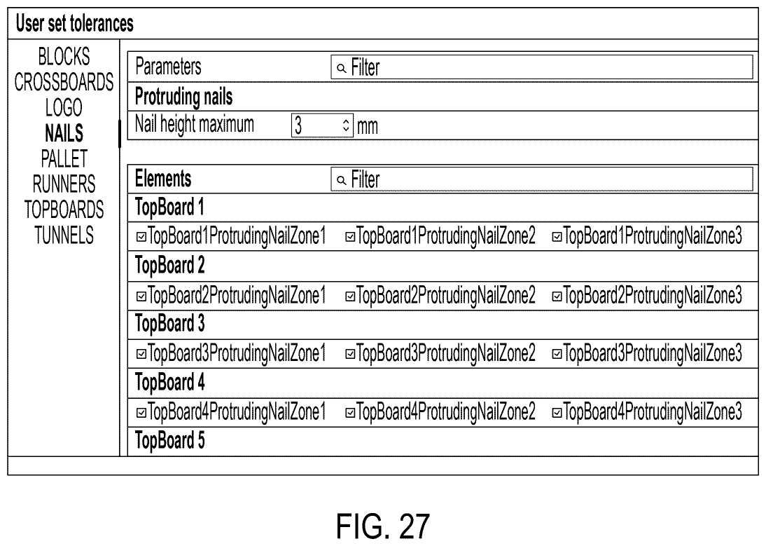

In some implementations, the disclosed inspection system can be configured or calibrated based on user-specific tolerances. For example, FIGS. 24 through 27 show exemplary user interfaces on a display computing device connected to the inspection system that beneficially enables setting data boundaries and/or data tolerances for capturing and/or analyzing images captured by the one or more image capture sensors and/or tolerance data associated with the operations executed by the AI engine.

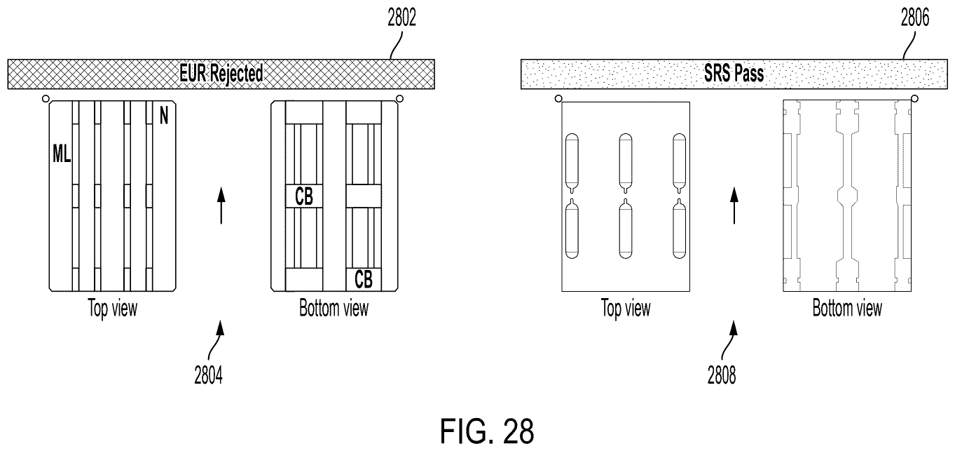

According to one embodiment, the disclosed inspection system can classify and/or determine the type of transport structure being analyzed and generate flags if non-compliant and/or inappropriate transport structures are being analyzed for a given jurisdiction. For example, FIG. 28 shows an exemplary image of a first flag 2802 generated for a first transport structure 2804 type relative to a second flag 2808 generated for a second transport structure 2808. It is appreciated that the disclosed inspection system is configured to adapt to different transport structure types and can be remotely calibrated and or supervised from locations that or proximal or distal relative to the inspection system.

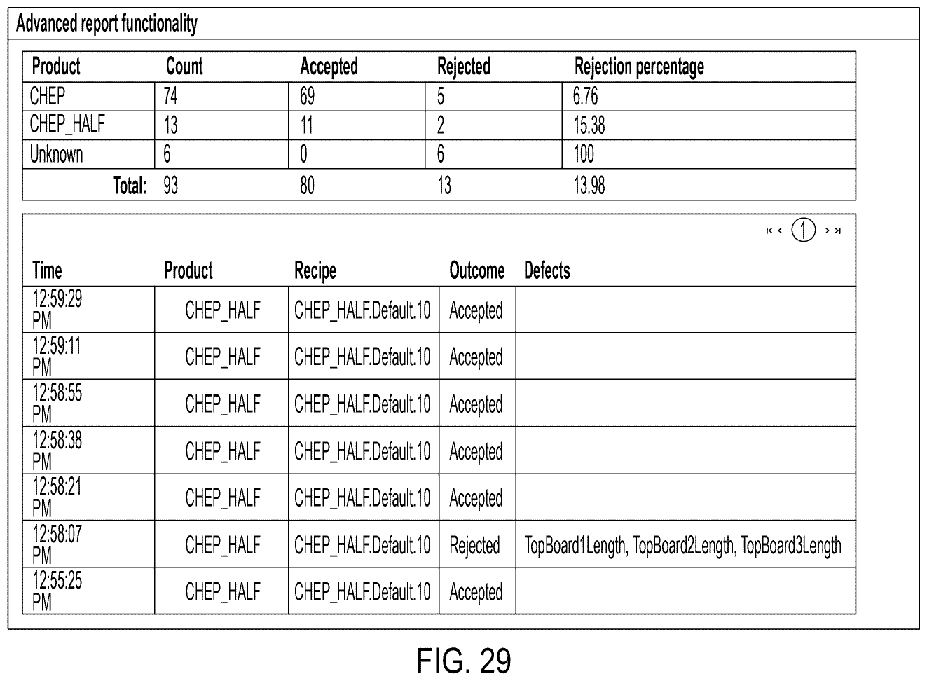

FIG. 29 provides an exemplary visualization associated with a preliminary report generated in response to analyzing a plurality of transport structures.

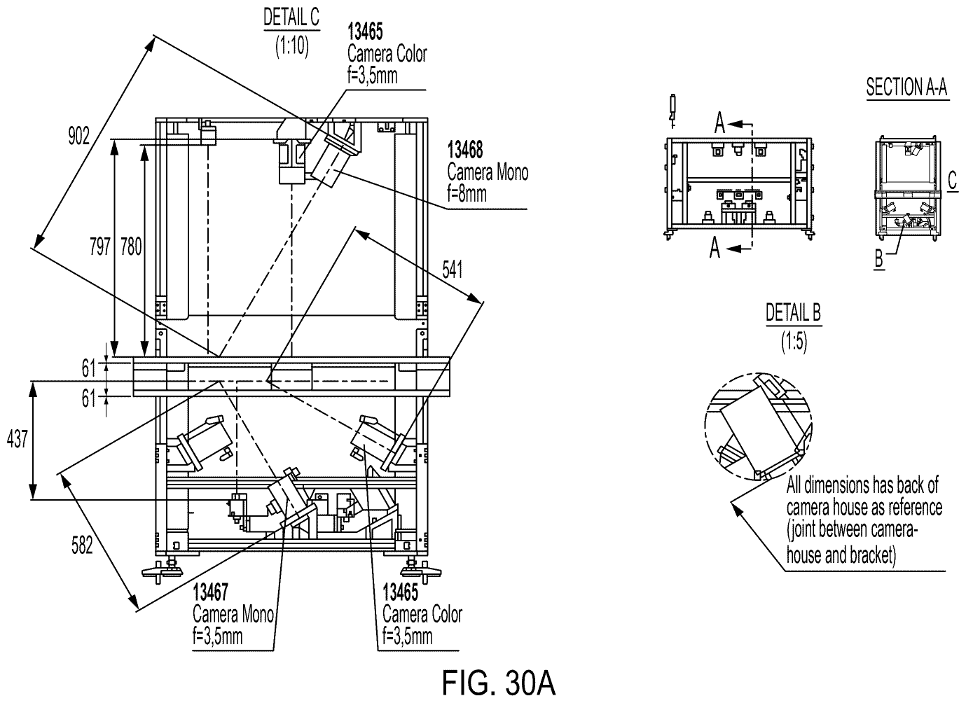

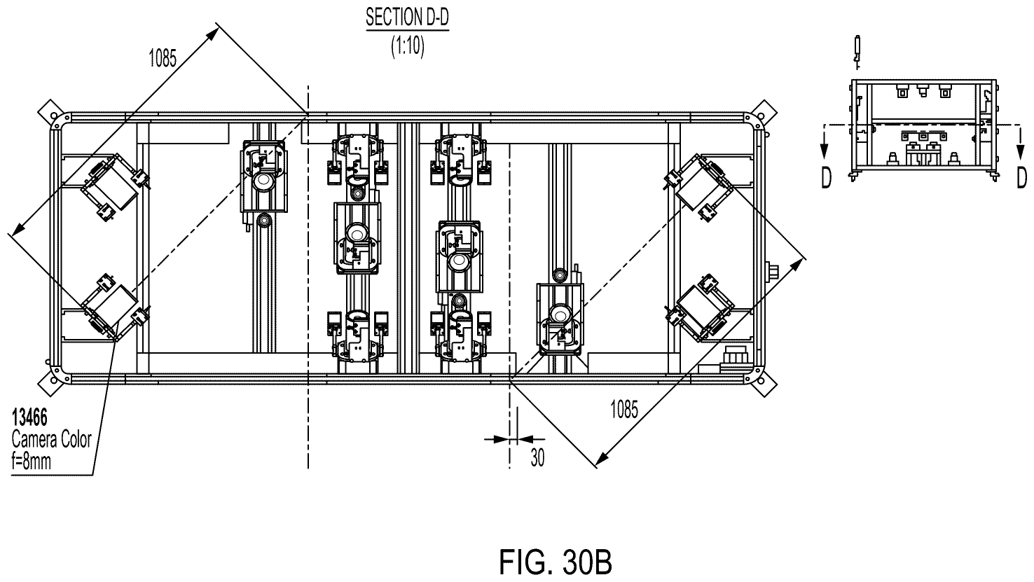

FIG. 30A shows an exemplary top view of the disclosed inspection system.

FIG. 30B shows another exemplary top view with additional camera arrangements.

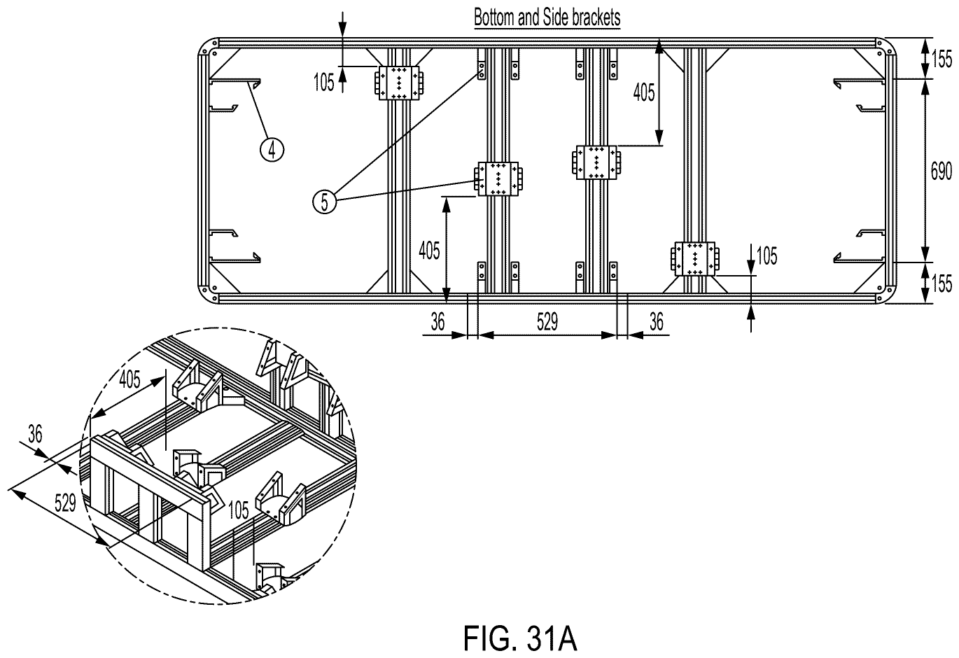

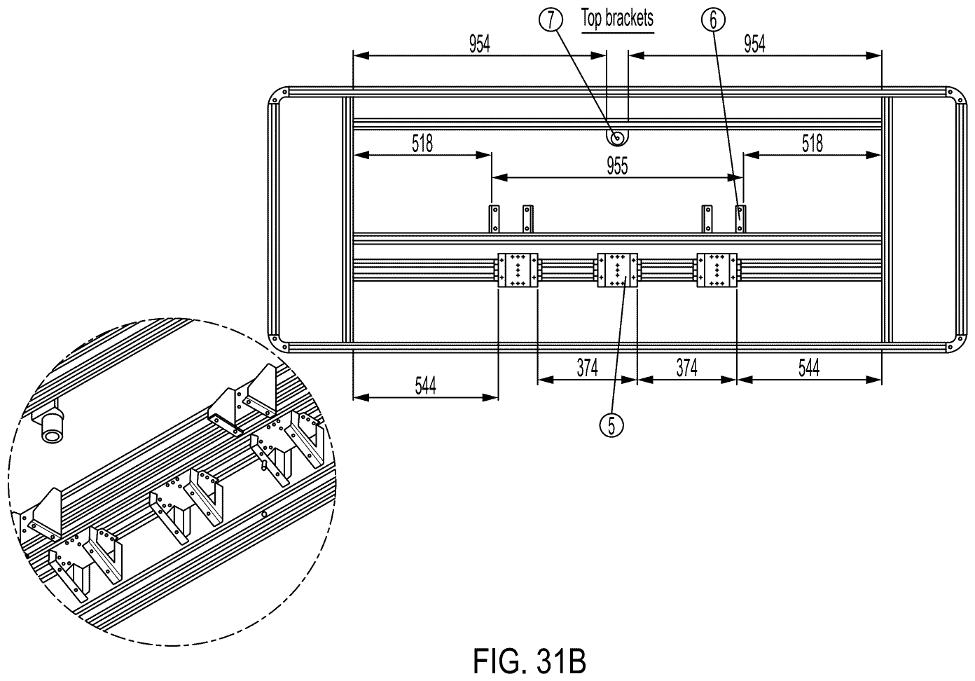

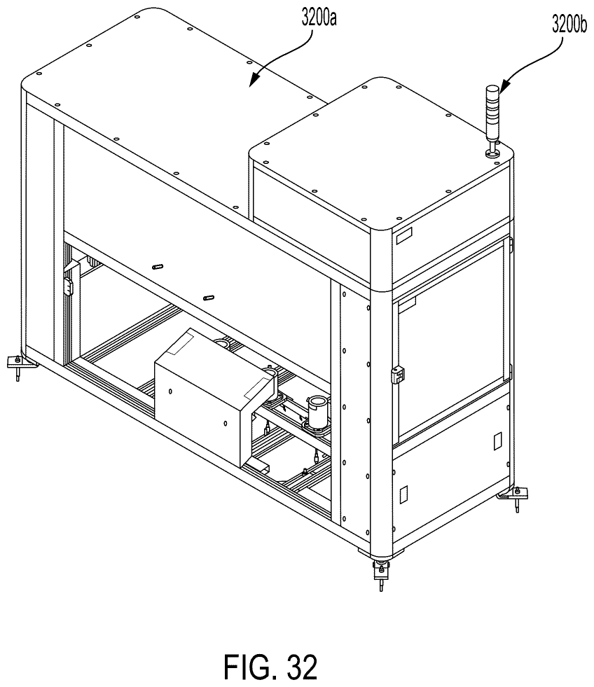

FIGS. 31A and 31B shows an exemplary bottom and side brackets associated with the disclosed inspection system. In one embodiment, the brackets illustrated can be used to provide structural support, connect different structural members of the inspection system securely, and reinforce areas or systems of the disclosed inspection system needing strong coupling.

### Exemplary Embodiment 2

According to some embodiments, the disclosed methods and systems beneficially enable solving the problem of lost information in image analysis of transport structures as well as speeding constraint or feature detection associated with inspecting transport structures. Moreover, the disclosed methods and systems are associated with an inspections system that leverages an artificial intelligence (AI) engine that is configured to scan or analyze transport structures per time unit based on the rapid internal communication of between various cameras of the inspection system and an artificial intelligence engine of the inspection system. According to one embodiment, the disclosed methods and systems use image capture sensors (e.g., color cameras) for image acquisition of a transport structure, such that the image capture sensors do not rely on lasers to illuminate the transport structures prior to acquiring images of the transport structures. In addition, the inspection system can be configured to perform non-contact measurement and inspection of transport structures automatically. In exemplary embodiments, the disclosed inspection system relies on image synchronization of images captured by the inspection system to extract dimensional features such as length, width, height, and other spatial information associated with a transport structure from different vantage points or perspectives.

According to one embodiment, the disclosed methods and systems comprise a distributed array of image capture sensors, each equipped with internally synchronized clocks to ensure accurate temporal alignment across image frames of a transport structure. In particular, each camera of the disclosed inspection system can capture image frames of a transport structure continuously, thereby generating both image data with attendant metadata (e.g., identifier data associated with the image capture sensors, exact timestamp of when said images were captured, and location data associated where the images of the transport structures are captured) for storage in a database (e.g., centralized database). This setup enables the reconstruction of transport structure movement and structure across both time and space.

It is appreciated that after multiple images of the transport structure are captured within the inspection area, the system adaptively filters these multiple images to identify and select pertinent images of the transport structure for further analysis. The criteria for this adaptive selection include: the location where each image was captured, allowing for spatial correlation and the exclusion of out-of-bounds or redundant views; the velocity of the transport unit (e.g., conveyor) that moves the transport structure to, or through the inspection area, as image quality (e.g., motion blur) can be velocity-dependent; type data associated with the transport structure, which may dictate specific features or areas of interest of the transport structure that is inspected based on at least the material properties of the transport structure and/or structural properties of the transport structure and/or surface properties of the transport structure and/or design properties of the transport structure; the lighting conditions prevalent during image capture, enabling the AI engine to discard images taken under insufficient or excessive illumination; the orientation or angle of the image capture sensors relative to the transport structure at the moment of image capture, ensuring that only images providing a suitable perspective for analysis are retained; the presence of occlusions or obstructions within the image, which would render the image unhelpful for analysis by the AI engine; and the resolution or focus quality of the captured images of the transport structure, ensuring that only clear and sharp images are processed to maintain accuracy in feature detection. This adaptive filtering process significantly reduces data redundancy and computational load, focusing subsequent analysis on the most valuable captured images of the transport structure.

In exemplary implementations, captured images of transport structures by the inspection system are processed using AI-based detection computing processes to determine the presence of a transport structure within an inspection area of the inspection system. Upon detection, entry and exit times into, and out of, respectively, the inspection system by the transport structure are derived from line-scan image data, specifically through an analysis of sliced image sequences captured by the two or more image capture sensors of the inspection system. In some cases, the width of the transport structure may be determined using the aforementioned line-scan image data. By combining time-of-entry, image capture sensor positioning, and synchronized metadata, the disclosed inspection system determines the most appropriate image frames (e.g., image data) for inspecting individual components of the transport structure such as blocks, stringers, connector boards, and deckboards.

According to one embodiment, an AI engine comprised in the disclosed inspection system can select optimal data frames comprised in aforementioned image data associated with a scanned transport data. Once optimal frames are selected, the AI engine may apply a segmentation computing process to the selected data frames. The segmentation computing process can beneficially decompose or analyze each image comprised in the selected data frames into individual data components (e.g., board surfaces, nail heads, defects) of the transport structure, assigning unique identifiers to each distinct instance of a component (e.g., each block) of the transport structure. To optimize processing, images (e.g., image data) captured by the disclosed inspection system are temporarily downscaled for preliminary segmentation computing operations thereby generating segmentation masks associated with the transport structure. This lies in the fact that the originally captured images comprise high-resolution images requiring significant data bandwidth and processing power for analysis. The resulting segmentation masks can be subsequently rescaled and mapped back to the original full-resolution images for precise final analysis if needed.

For enhanced multi-dimensional (e.g., 2D or 3D) understanding of scanned transport structures, paired area scan image capture sensors are used to capture transport structure features from opposing angles. By leveraging known image capture sensor positions, orientations, and temporal synchronization, along with data such as transport structure width (e.g., measured via a line-scan) and inferred position of a transport structure over time in the inspection system, the disclosed inspection system can estimate transport structure height at specific locations within the inspection system. This advantageously enables the calculation or determination of millimeter-per-pixel scaling ratios, facilitating precise measurement of subcomponents of the transport structure, visible within the same image frame of the transport structure.

Furthermore, the disclosed inspection system may comprise in line-scan image capture sensors, lighting that can be controlled using depth analysis associated with a given transport structure. Specifically, controllable light sources of the inspection system can be placed before (B) and after (A) the scan-line position relative to the transport structure being scanned. These lights can be triggered in a cyclic strobe sequence synchronized with acquiring images of the transport structure, using for example, the following image capture patterns/configurations: “both A and B on,” “A on, B off,” and “A off, B on.” The result is a series of images with differential lighting conditions, allowing the inspection system to analyze shadow patterns associated with transport structures and estimate depth-related features of the transport structures, such as protruding materials or crack depths.

Scan lines, which can be extracted from images captured by the inspection system of the transport structure can be assembled into multi-dimensional composite images (e.g., 2D color composite images), which are processed by one or more machine learning models to identify and classify transport structure components, including but not limited to: top deckboards, connector boards, stringer boards, bottom deckboards, blocks, keg holders, nails, as well as defects like cracks, missing material, protrusions, and contamination. Additional attributes such as board coloration and production markings (e.g., logos or stamps) associated with the transport structure can also be identified. Each component of the transport structure can be measured and its relative 3D position and orientation (x, y, z coordinates and rotation) within the transport structure is determined or calculated and recorded or stored in a centralized database.

A library of transport structure types is maintained, with each type characterized by predefined dimensions and structural configurations. As measurement data is collected from a given transport structure, the inspection system dynamically filters this library to eliminate incompatible types. For example, if the detected material is wood, plastic transport structure types are excluded; if the configuration matches a stringer transport structure, block-style transport structures are ruled out. Based on the refined list and comparative analysis, the inspection system identifies the most likely transport structure type—for example, a stringer-type 48×40 4-way transport structure.

Some advantages of the disclosed inspection system include:

### 1. Laser-Free, Non-Contact Inspection

Unlike traditional systems that rely on lasers for depth sensing or object detection, the disclosed inspection system operates using image capture sensors (e.g., color cameras) thereby eliminating cost concerns associated with laser systems, safety concerns associated with using laser systems, and maintenance complexity associated with using laser-based systems while still enabling 3D reconstruction and dimensional analysis of transport structures.

### 2. Synchronized, Distributed Image Sensor System Network

The disclosed inspection system uses a distributed array of synchronized image capture sensors, each with precise internal clock alignment. This beneficially enables accurate temporal and spatial correlation between transport structure image frames from different locations or perspectives, allowing high-resolution, multi-angle reconstruction of transport structures in motion.

3. Continuous Data Capture with Metadata-Enriched Storage

According to one embodiment, each image of a transport structure is captured in a continuous stream and stored with rich metadata (e.g., time or temporal data, image sensor ID data, position or location or perspective data associated with the image), enabling retrospective analysis, traceability, and flexible reprocessing. This supports time-aligned tracking of transport structure components across multiple views and/or perspectives of the image capture sensors.

### 4. AI-Powered Detection and Segmentation

The disclosed inspection system incorporates artificial intelligence models or machine learning models for real-time object detection, classification, and segmentation of transport structure components (e.g., boards, nails, blocks, defects, etc.). This automated approach significantly increases accuracy and repeatability over rule-based or traditional image processing techniques which cannot be feasibly performed mentally.

### 5. Dynamic Frame Selection for Optimal Inspection

By using entry/exit timing, image capture sensor positioning, and width measurement, the disclosed inspection system determines or calculates the best inspection frames for each transport structure component. This improves inspection precision and reduces computational load by avoiding redundant or suboptimal frames.

### 6. Depth Estimation Through Lighting Variations, not Hardware

The disclosed inspection system introduces a novel use of strobing light sources placed before and after an imaging section or path (e.g., line-scan path). By varying lighting conditions per frame, the inspection system captures shadow information that allows estimation of depth features (e.g., protrusions, cracks) without any need for depth sensors or stereo imaging systems.

### 7. Paired Camera Height Estimation

Height of transport structure elements can be inferred using paired area-scan image capture sensors positioned at known or established angles. Combined with movement data and width measurements, the inspection system can calculate scale (mm/pixel) for each image of a transport structure, enabling precise physical measurements of the transport structure without physical contact or embedded sensors.

8. High-Fidelity Image Segmentation with Scaled Masking

Image segmentation of images of transport structures can be achieved at reduced resolution for speed, then upscaled and applied to the original full-resolution images of the transport structures, allowing efficient processing without sacrificing accuracy. This hybrid approach improves computations without requiring expensive hardware or computing resources.

### 9. Component-Level Identification and Tracking

The disclosed inspection system can identify each physical instance of transport structure components (e.g., differentiating between multiple blocks), allowing per-instance tracking, defect localization, and other data analytics associated with the transport structures over time.

### 10. Adaptive Transport Structure Type Classification

By comparing measured transport structure parameters against a database of supported types, the disclosed inspection system can dynamically classify transport structure types while discarding incompatible transport structure profiles. This beneficially enhances flexibility for multi-type inspection environments and reduces setup/configuration time.

### Inspection System

According to one embodiment, the disclosed inspection system comprises two or more image sensors (e.g., color cameras) that are configured to synchronously capture images of a transport structure, such that the captured images of the transport structures are synthesized or otherwise combined by an artificial intelligence (AI) engine to generate length, width, and height data for the transport structure. The length, width, and height data of the transport structure can be used by the AI engine, for example, to generate a multi-dimensional representation (e.g., 2-dimensional (2D) representation, 3-dimensional (3D) representation) of the transport structure.

In some embodiments, each of the two or more image capture sensors can comprise internal clocks or timing devices that are synchronized when capturing image or video data of a transport structure. This synchronization beneficially enables accurate time matching between the two or more of the image capture sensors and/or accurate matching and synthesis of images captured by the two or more image capture sensors. Furthermore, continuous capturing of frame data or image data from each of the two or more image capture sensors can be stored in a database along with metadata associated with the frame data. In some cases, the two or more image capture sensors are configured to capture not only still images (e.g., pictures) but also, continuous or video data or video frames of the transport structure. In one embodiment, the metadata associated with a given frame data includes: image capture sensor name/identifier (image capture sensor name, image capture sensor manufacturer, image capture sensor model, image capture sensor software); image capture time associated with when the image capture sensors captured the frame data; date data associated with a date the image was captured; calibration data associated with configuring the image capture sensors capturing the frame data; location data associated with where the image capture sensors are capturing the frame data; AI generated metadata including object/feature detection data that assists in classifying or categorizing features in the captured frame data or image data; etc. It is appreciated that the metadata associated with the frame data or image data beneficially facilitate image match or synthesis, image tracking, transport structure measurement determinations, etc. In effect, the metadata can be used by the AI engine to track and measure transport structure features or components both in time and space between different perspectives of the two or more image capture sensors.

According to one embodiment, images captured by the two or more sensors can be analyzed by the AI engine to determine if a transport structure is inside the inspection system or not. When a transport structure is detected, the exact position, entry and exit times relative to the inspection system can be deduced from line scan image capture sensors that detect or capture slice images of the transport structure. In some cases, the width of the transport structure can be measured from the slice images. Based on the width of the transport structure, an entry time of the transport structure into the inspection system, as well as using the various positions of the image capture sensors about the inspection system, a selection of optimal images of the transport structure can be made for inspection or analyses. The analyses can comprise block data analysis of the transport structure, stringer data analysis of the transport structure, connector board data analysis of the transport structure, deckboard data analysis of the transport structure, etc.

In some cases, a specific image capture sensor is selected to generate a specific image data of the transport structure. This image (e.g., frame data) may be analyzed by the AI engine which then segments the content of the image into one or more parts (e.g., a block surface part, a board surface part, nails part, a defects part, etc.). The AI engine can also keep track of the one or more parts for separate and/or different instances of similar or dissimilar parts (e.g., multiple blocks are not treated as the same block, and given unique identifiers). Prior to segmenting the content of the image, the AI engine can temporarily scale down the image for quicker processing. The image can then be scaled up with data masks being applied to the original image at full resolution for final processing by, for example, the AI engine.

In some implementations, area scan image capture sensors are paired so that each feature of a transport structure can be captured in opposing angles, using meta-data like time and position associated with capturing images using the paired image capture sensors. Using the known positions and direction of the image capture sensors, in combination with inferred data (e.g., position relative to machine over time, measured width from line scan), inferences can be made, by the AI engine, regarding total height of a transport structure at given location within the inspection system. Once this height is known, the AI engine can determine: a pixel size ratio (e.g., a millimeter (mm) per pixel ratio) in images of the transport structure in question; edge data of the transport structure; subcomponent measurements of the transport structure in the same image for which the height is determined; etc.

According to one embodiment, the two or more image capture sensors may be arranged in a manner that beneficially enables placing light sources both before (B) and after (A) a scan-line-position relative to a transport structure moving through the inspection system. By controlling the light sources to strobe in a specific repeating pattern in sync with a capture trigger configuration comprising one of: “both A and B on” and “A on, B off,” “A off, B on,” differently lit images from the same camera may be obtained, depending on how the two or more image capture sensors are arranged (e.g., line arrangements of the two or more image capture sensors). Having same lines captured with different lighting positions means that shadow data of features on the transport structure can be determined in the resulting images captured by the two or more image capture sensors. This can also enable detecting protruding and non-protruding features including depth and crack estimations associated with the transport structure.

In some embodiments, the disclosed inspection system is configured to project scan lines, using the light sources (e.g., light emission diode sources) onto a transport structure traversing the inspection system such that the scan lines beneficially enable optimally capturing images of the transport structure, such that the scan lines on the transport structure can be used to assemble at least 2D images (e.g., 2D color images). In some cases, the AI engine or one or more machine learning models can be used to segment the assembled 2D images into transport structure components including: boards (e.g., top deckboard of transport structure, connector boards of the transport structure, stringer boards of the transport structure, bottom deckboard of the transport structure, blocks associated with the transport structure, keg holders of the transport structure, recessed or protruding nails on the transport structure, etc.); defects (e.g., cracks on the transport structure, broken or missing material on the transport structure, protruding material of the transport structure, contamination of the transport structure); and other quality control parameters (e.g., board color of the transport structure, production stamps/logos on the transport structure, etc.). The individual components of the transport structure can be measured; their position in relation to the transport structure being determined and stored for later evaluation. The position in relation to the transport structure can be modeled using a 4-dimensional (4D) coordinate system (e.g., x-length, y-width, z-height, rotation).

In some cases, supported transport structure type data may be stored in a list with their given characteristics. Captured measurements and data points for transport structures may be used to reduce the list by excluding transport structure types with conflicting data. For example, control logic of the inspection system can be used to exclude plastic transport structures relative to wood transport structures if the inspection system is configured to examine wood transport structures based on the aforementioned list. Other exclusionary logic for the disclosed inspection system include disregarding images of stringer transport structure types, ignoring images of block transport structure type, etc.

The disclosed methods and systems are directed to an automated inspection system for transport structures such (e.g., pallets or crates) that leverages artificial intelligence (AI) in detecting features of transport structures. According to one embodiment, the disclosed inspection system includes a machine or apparatus that has transport mechanisms (e.g., conveyors) configured to move or optimally propel transport structures to a specific inspection position (e.g., an inspection section or an inspection area) relative to various scanning and indicator systems (e.g., image capture sensors, light emission diodes (LEDs)) comprised in the inspection system. In an exemplary embodiment, the scanning and indicator systems comprised in the disclosed inspection system includes a set of image capture sensors (e.g., cameras) and light emission diode (LED) lights that are configured to illuminate a transport structure (e.g., a wood pallet, a plastic pallet, a crate a skid, a roll cradle, a roll container, etc.). In particular, each image capture sensor of the disclosed inspection system can have its own instance of a piece of imaging software associated with it.

According to one embodiment, the imaging software referenced above in association with each image capture sensor of the disclosed inspection system is stored directly on each image capture sensor's internal storage device. A significant feature of this approach is that the imaging software can be specifically calibrated (e.g., automatically or dynamically calibrated from a central computing device such as a computing server with an AI engine that is proximal or distal relative to the inspection system) for each individual image capture sensor. This beneficially allows for great flexibility, as each image capture sensor can be customized to its particular angle or perspective relative to an in-motion transport structure being scanned. This customized calibration provides a distinct advantage: some capture sensors can be configured for low-resolution imaging, which requires less bandwidth, while others can be precisely adjusted for high-resolution imaging to capture specific features of interest with greater detail.

According to one embodiment, the imaging software comprises device-specific grabber software configured for capturing and/or initiating the processing of image data and/or video data. In some cases, each instance of the imaging software beneficially facilitates:
maintaining a data connection link between each image capture sensor and a proximal or distal processing server (e.g., a server hosting an AI engine) configured to implement image and/or video data processing;
ensuring that each image capture sensor is live or otherwise online or active and ready to receive image capture commands (e.g., triggers);
extracting image and/or video data captured by each image capture sensor;
controlling storage of processed or unprocessed image and/or video data to a storage device integrated into each image capture sensor or a storage device proximal or distal relative to each image capture sensor; and
coordinating with an AI engine to accurately and timely process captured image and/or video data.

According to one embodiment, the imaging software comprises a combination of customized code and/or image acquisition mechanisms associated with an imaging framework (e.g., Common Vision Blox (CVB) framework).

Operationally, the inspection system has a plurality of setups or configurations including: a first setup based on 2-dimensional (2D) image capture sensor measurements; a second a setup based on 2D image capture sensor measurements with a spot height measurement feature; a third setup based on 2D image capture sensor measurements with a shadow detection of features on a transport structure.

According to some embodiments, the disclosed inspection system does not suffer from disadvantages associated with: converting 3-dimensional (3D) data into 2D data; creating, receiving, generating, or storing 2D data maps that indicate data values representing designated data offsets above a board surface of a transport structure (e.g., wood pallet); establishing a filter plane corresponding to specific data values and/or discarding z-coordinate data (e.g., height data) below established or predetermined data values; and/or creating or executing a repair recipe or repair strategy for repairing a defective transport structure. According to one embodiment, the repair strategy comprises determining, using the inspection system, defective aspects or sections of a transport structure and automatically customizing and/or implementing the repair strategy to fix or resolve the detected defect in the defective transport structure.

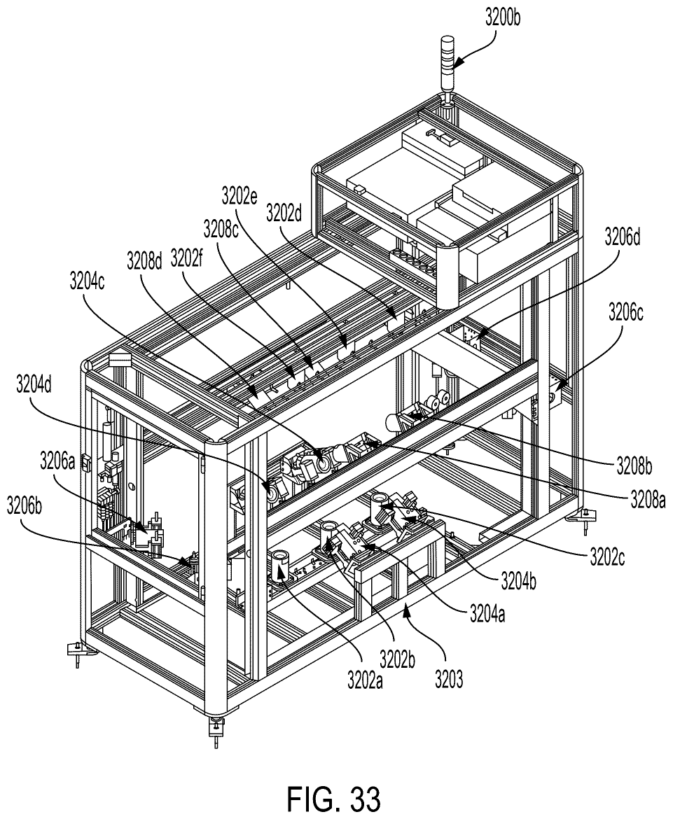

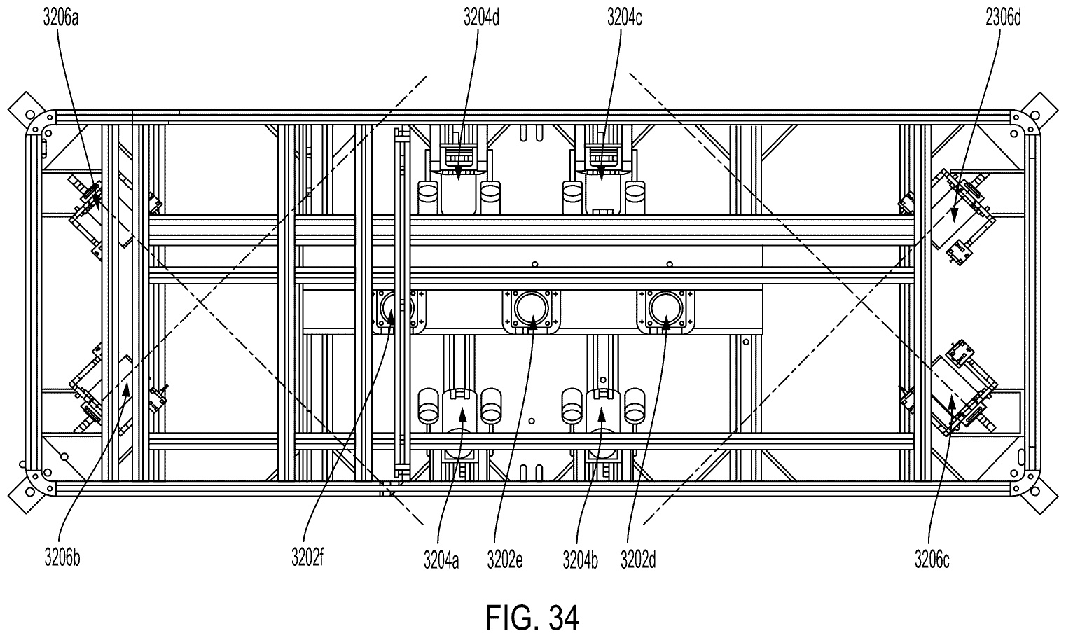

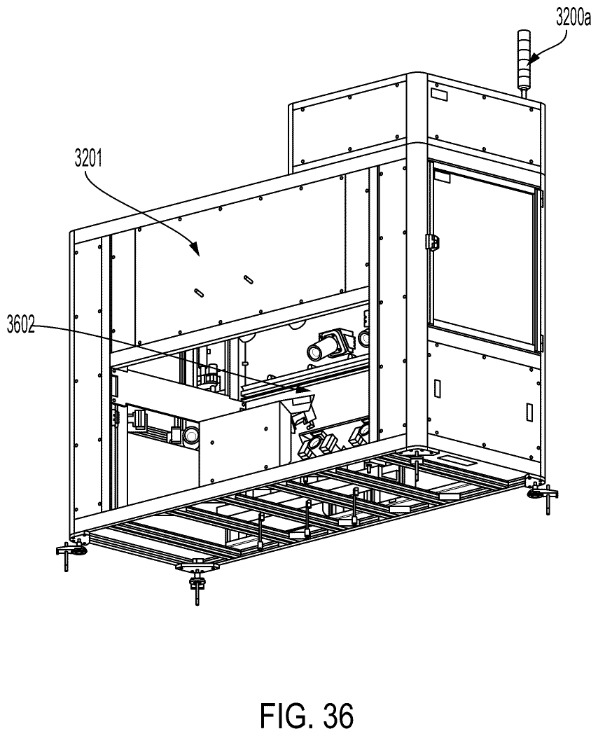

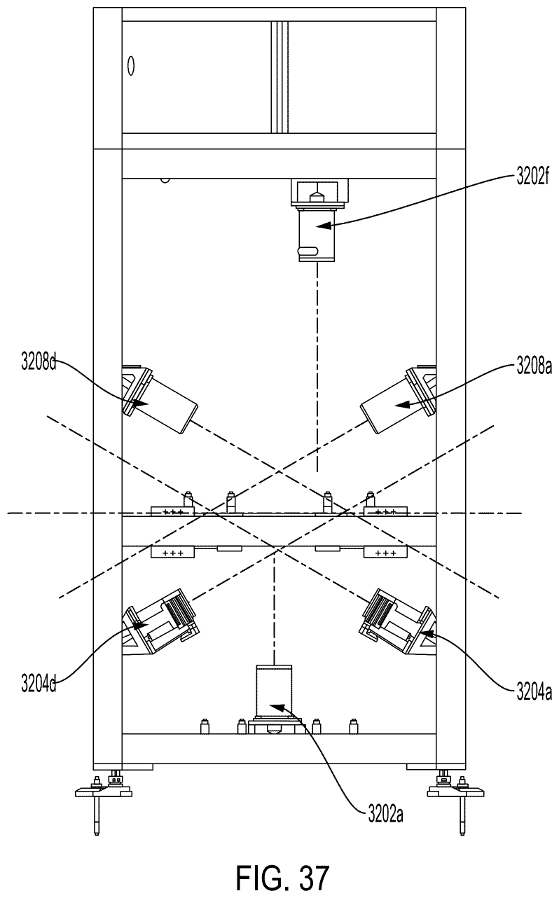

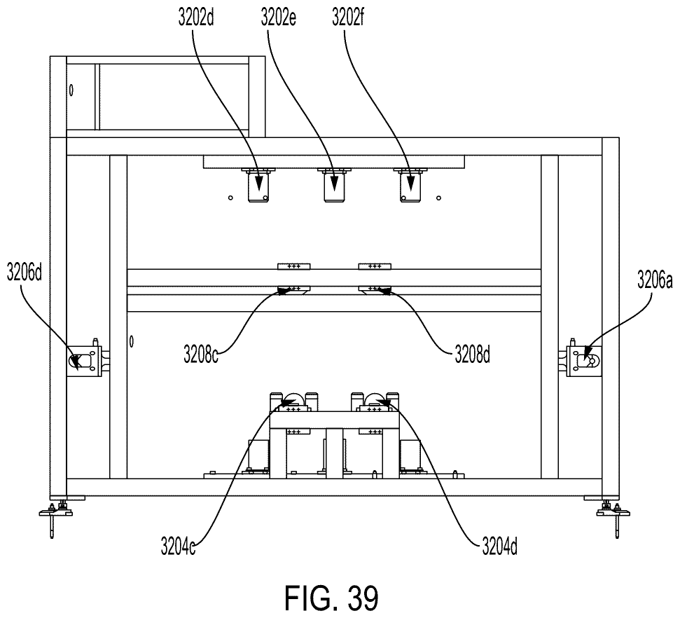

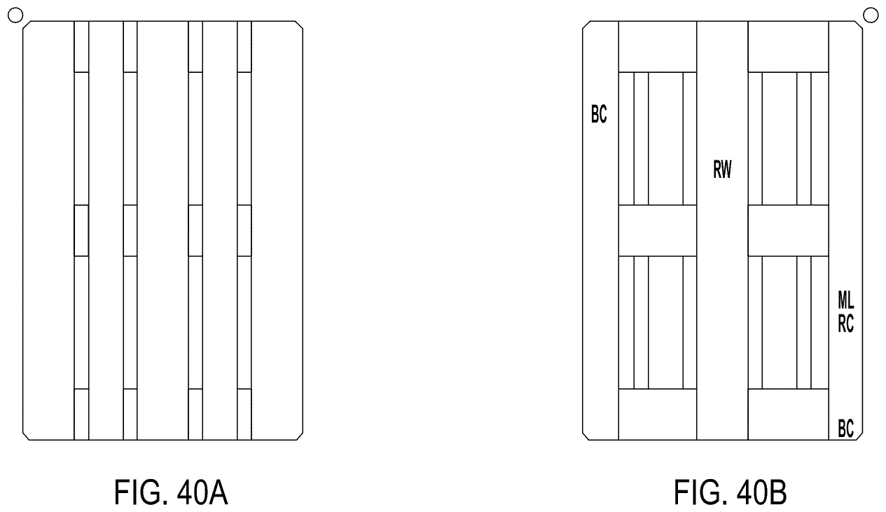

FIGS. 32 through 39 show exemplary views of the disclosed inspection system while FIGS. 40A and 40B show views of a transport structure that is inspected by the disclosed inspection system. As can be seen in these figures, the disclosed inspection system can include a casing 3200a that substantially covers a frame 3203 to which is coupled a plurality of image capture sensors (e.g., high resolution color cameras such as cameras with at least 4 k resolution). According to one embodiment, the plurality of image capture sensors include a set of bottom cameras 3202a, 3202b, and 3202c which are paired with a set of top cameras 3202d, 3202e, and 3202f. The plurality of image capture sensors can also include a first set of tunnel cameras 3204a and 3204b that are paired or matched to a second set of tunnel cameras 3204c and 3204d. Similarly, a third set of tunnel cameras 3208a and 3208b may be paired with a fourth set of tunnel cameras 3208c and 3208d. Furthermore, the plurality of image capture sensors coupled to the frame 3203 can include multiple side cameras 3206a, 3206b, 3206c, and 3206d. It is appreciated that the various image capture sensor parings (e.g., bottom cameras 3202a, 3202b, and 3202c paired with top cameras 3202d, 3202c, and 3202f; tunnel cameras 3204a and 3204b paired with tunnel cameras 3204c and 3204d; tunnel cameras 3208a and 3208b paired with tunnel cameras 3208c and 3208d) beneficially enable capturing both front lit and back lit images of a transport structure being inspected. In particular, capturing the front lit and back lit images can involve simultaneously or independently capturing at least two images of the transport structure using, for example: a first set of image capture sensors (e.g., tunnel cameras 3208a and 3208b) that capture images from a first perspective relative to a transport structure being imaged/scanned; and a second set of image capture sensors (e.g., tunnel cameras 3208c and 3208d) that capture images from a second perspective relative to the transport structure being imaged/scanned. In some cases, having these two image perspectives beneficially enable detecting: a first shadow signature (e.g., shadow signature of a protruding object) from the first perspective, projected onto the surface of a transport structure; and a second shadow signature (e.g., shadow signature of the same protruding object) from a second perspective, projected onto the surface of the transport structure being inspected. These two shadow signature may be used, by the AI engine, for example, to determine the height of an object on the transport structure creating the two shadow signatures. It is appreciated that exemplary objects for which the first and second shadow signatures can be determined include a protruding nail, a protruding splinter objects associated with the transport structure, bumps on the transport structure, materials that attach to the transport structure, protruding screws, protruding staples, broken sections of the transport structure that distort surface evenness of the transport structure, strappings to the transport structure, debris on the transport structure, bolts attached to the transport structure, washers attached to the transport structure, loose or protruding knots attached to the transport structure, etc.

According to one embodiment, the set of bottom cameras 3202a, 3202b, and 3202c together with the set of top cameras 3202d, 3202e, and 3202f can be configured to capture (e.g., continuously capture) a plurality of line scan images. According to one embodiment, the plurality of line scan images comprise two-dimensional images that are constructed by sequentially acquiring or capturing, using the set of bottom cameras 3202a, 3202b, and 3202c and the set of top cameras 3202d, 3202e, and 3202f, one-dimensional “lines” of pixel data associated with a transport structure being imaged. In some implementations, the set of bottom cameras 3202a, 3202b, and 3202c and/or the set of top cameras 3202d, 3202e, and 3202f can leverage a single row of sensor pixels when capturing the line scan images in a first dimension. The second dimension of the line scan images can be generated by the relative motion between the object being imaged (e.g., a transport structure) and the set of bottom cameras 3202a, 3202b, and 3202c and/or the set of top cameras 3202d, 3202e, and 3202f. In an exemplary implementation, the line scan images generated using the set of bottom cameras 3202a, 3202b, and 3202c and/or the set of top cameras 3202d, 3202e, and 3202f can analyzed by, for example, the AI engine to determine whether the line scans comprise transport structure features or not. In effect, the line scan images generated using the set of bottom cameras 3202a, 3202b, and 3202c and/or the set of top cameras 3202d, 3202c, and 3202f can beneficially transform the set of bottom cameras 3202a, 3202b, and 3202c and/or the set of top cameras 3202d, 3202e, and 3202f into a transport structure detection system, effectively obviating the need for other object detection systems. This ensures that the disclosed inspection system does not suffer from costs of adding other object detection systems as well as simplifies the design and maintenance of the inspection system described herein.

Other than the set of bottom cameras 3202a, 3202b, and 3202c and/or the set of top cameras 3202d, 3202e, and 3202f, the remaining image capture systems (e.g.: the first set of tunnel cameras 3204a and 3204b and the second set of tunnel cameras 3204c and 3204d; the third set of tunnel cameras 3208a and 3208b paired with the fourth set of tunnel cameras 3208c and 3208d; and the multiple side cameras 3206a, 3206b, 3206c, and 3206d) coupled to the frame 3203 may be considered as area scan cameras or imaging systems that do not capture line scan images but rather, capture 2D images in a single snapshot. These 2D images can be regarded as area scans or area images that show a 2D area/surface representation of a transport structure being imaged. Furthermore, this 2D data can be used by the AI engine to generate analysis data comprising dimensional data of the transport structure. This dimensional data can include one or more of: width data and height data of the transport structure; or width data and length data associated with the transport structure; or length data and height data associated with the transport structure in question. In particular, the 2D images can be analyzed by the AI engine to generate analysis data that indicates multiple properties (e.g., structural properties, texture properties, protrusion properties, etc.) of the transport structure. These properties can include: dimensional data such as those discussed above associated with the transport structure; gap data associated with two or more components (e.g., deckboards) associated with the transport structure; alignment data associated with two or more components of the transport structure; fastener presence/or absence data (e.g. presence/absence of fasteners such as screws, nails, staples, etc.) associated with the transport structure; fastener protrusion data associated with the transport structure; integrity data (e.g., cracks data, splits data, splinter data, chipping data, material impact data (simply called impact data elsewhere herein) such as rot data or decay data or stain data or discoloration data or mold data or fungus data or deformation data or warpage data or abrasion data or wear data) associated with the transport structure; material properties data including grain pattern data, knot presence/absence data, and surface texture data; and identification and/or compliance data associated with the transport such as stamps/markings data and transport structure type data. It is appreciated that the various properties outlined above can be analyzed by the AI engine to generate analysis data for a transport structure that has been analyzed by the AI engine. It is further appreciated that the analysis data does not only outline the various properties of the transport structure but can also include one or more of: a maintenance or repair strategy associated with correcting or fixing issues related to the identified properties of the transport structure; control logic that automatically or semi-automatically drives other systems connected to the inspection system to initiate such maintenance or repair strategy; control logic (e.g., sorting logic) that automatically or semi-automatically sorts various scanned or analyzed transport structures into various categories; an outline of one or more quality control operations that can be implemented on the scanned transport structure; inventory management of one or more items that can be stored using the transport structure; design optimization recommendations to enhance or improve the structure or use of a scanned transport structure; performance metric generation associated with the an expected lifespan of a transport structure; trend analysis of a collection of transport structures that indicates various datapoints including failure rates, lifespan ranges, etc., of the collection of transport structures; repair instruction generation for fixing or correcting identified issues associated with a scanned pallet; etc.

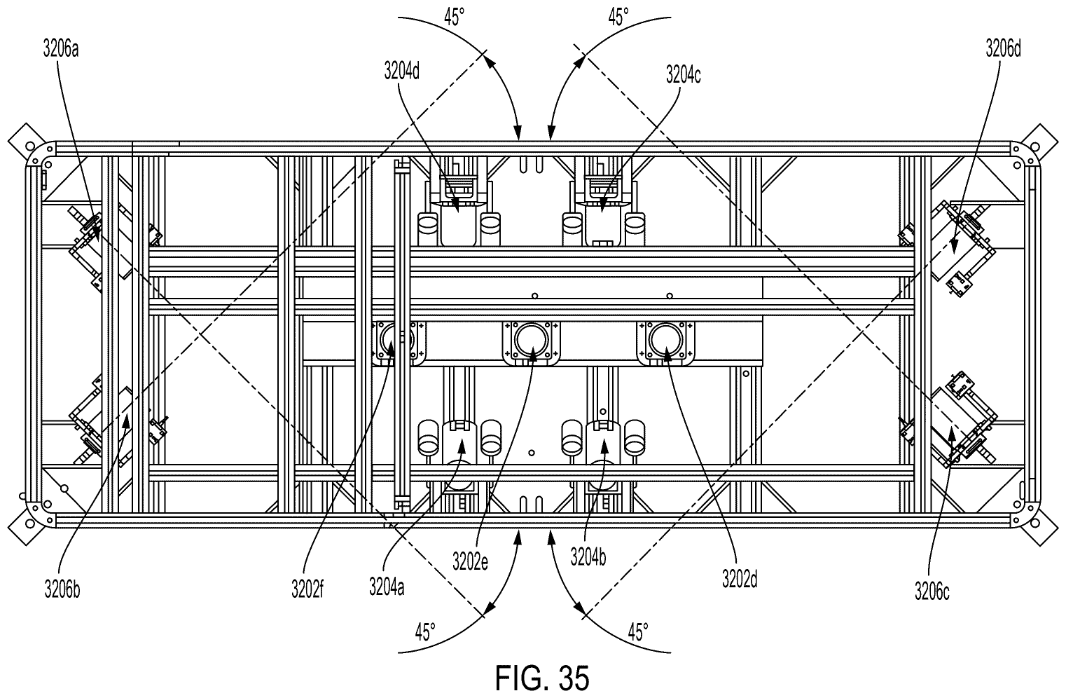

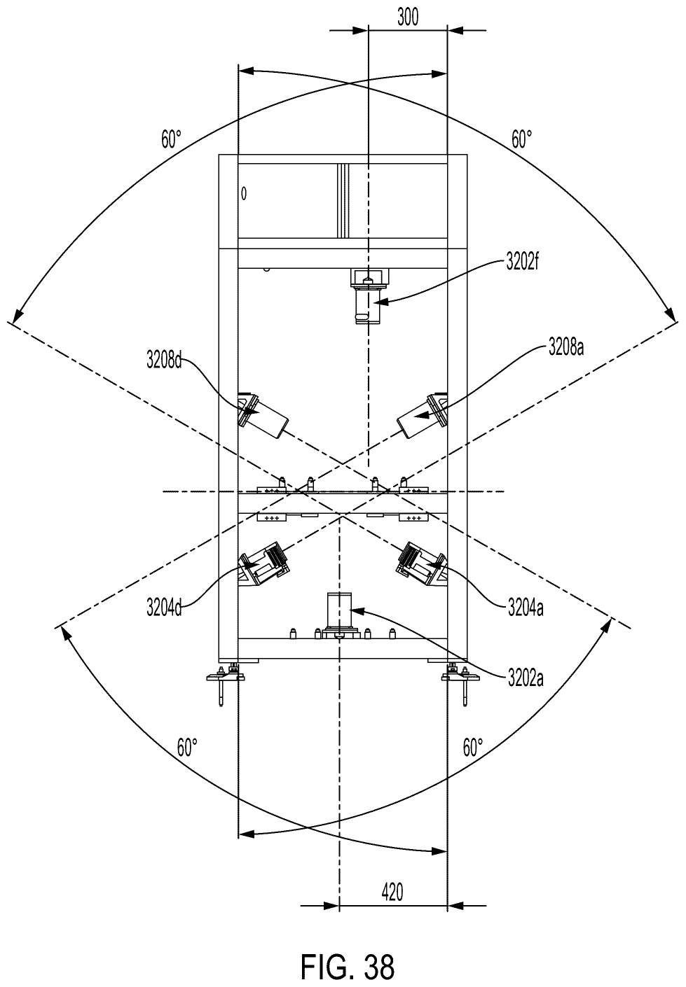

As illustrated in FIGS. 35 and 38, the image capture sensors of the inspection system can be strategically tilted or deviated to varying degrees. This adjustable positioning allows for the capture of multiple, distinct perspectives of the transport structure as it passes through the inspection area 3602. In particular, one or more of the image capture sensors of the disclosed inspection system can be configured to have at least a 30-degree or at least a 45-degree or at least a 50-degree or at least a 60-degree or at least a 70-degree or at least an 80-degree or at least a 90-degree angular span or field of view. This can be achieved using a rotation mechanism configured to move the one or more image capture sensors of the inspection system. Some embodiments, the one or more image capture sensors can be configured to conduct dynamic surveillance of the transport structure, allowing control over their horizontal (pan) and vertical (tilt) orientations, as well as their optical zoom features. Additionally, each of the one or more image capture sensors can have its own rotation mechanism including an integrated motor and/or gearing system for the pan (horizontal rotation) and/or tilt (vertical rotation) orientation movements.

In addition, each one of the plurality of image capture sensors can include data connectivity logic/application or circuit that is configured to transmit images captured of the transport structure to a memory device associated with the inspection system. The connectivity logic/application or circuit can include IP-based (Ethernet/PoE or Wi-Fi) connectivity for remote control and image data capture or video streaming associated with a transport structure.

According to one embodiment, the various image capture sensors of the disclosed inspection system may be configured to continuously capture a plurality images within the inspection area 3602 of the inspection system regardless of whether a transport structure is in the inspection area 3602 or not. This plurality of images may be initially transmitted, using an application (e.g., Grabber application/software) comprised in each image capture sensor, to a memory buffer or a cache storage system that can be directly accessed by an AI engine associated with the inspection system. In exemplary implementations, the AI engine is configured to first analyze images captured by the set of bottom cameras 3202a, 3202b, and 3202c and/or the set of top cameras 3202d, 3202e, and 3202f to detect the presence or absence of a transport structure based on the line scans (e.g., line scan images) of the transport structure captured using the set of bottom cameras 3202a, 3202b, and 3202c and/or the set of top cameras 3202d, 3202e, and 3202f. As would be appreciated by those skilled in the art, this initial phase of detecting the presence or absence of a transport structure in the inspection area 502 using line scan images from the set of bottom cameras 3202a, 3202b, and 3202c and/or the set of top cameras 3202d, 3202e, and 3202f is orders of magnitude faster (e.g., at least 100 times faster, or at least 500 times faster, or at least 1000 times faster or at least a 10000 times faster) than relying on the area scan images (e.g., 2D images) from the first set of tunnel cameras 3204a and 3204b and/or the second set of tunnel cameras 3204c and 3204d and/or the third set of tunnel cameras 3208a and 3208b and/or the fourth set of tunnel cameras 3208c and 3208d and/or the multiple side cameras 3206a, 3206b, 3206c, and 3206d. This is in part due to the fact that the line scan images have a far smaller data size (e.g., byte size) compared to the area scan images.

Once detection of the transport structure is made by the AI engine using one or more line scan images, a temporal window is created for concatenating a plurality of line scan images to create a first 2D image captured by the set of bottom cameras 3202a, 3202b, and 3202c and/or the set of top cameras 3202d, 3202c, and 3202f. This temporal window can be precisely determined using one or more of: velocity data associated with a transport unit moving the transport structure into the inspection area 502; and/or transport structure type data associated with the transport structure. As noted elsewhere herein, type data associated with the transport structure may dictate specific features or areas of interest of the transport structure based on at least the material properties of the transport structure and/or surface properties of the transport structure and/or structural properties of the transport structure and/or design properties of the transport structure.

The temporal window referenced above can also be applied to selecting relevant or attendant 2D area scan images (e.g., second 2D image) of the transport structure captured using the first set of tunnel cameras 3204a and 3204b and/or the second set of tunnel cameras 3204c and 3204d and/or the third set of tunnel cameras 3208a and 3208b and/or the fourth set of tunnel cameras 3208c and 3208d. In one embodiment, the temporal window comprises at least a 1 millisecond time window, or at least 5 millisecond time window, or at least a 1 microsecond time window or at least a 5 microsecond time window or at least a 1 nanosecond time window or at least a 5 nanosecond time window or at least a 1 picosecond time window or at least a 5 picosecond time window. Furthermore, the temporal window can be implemented as a data counter at a reference point (e.g., specific point in time) that indicates when a given line scan image is captured. In particular, the temporal window can be constructed using the reference point and a bidirectional data counter that defines a segment of time that extends both before and after the reference point. This allows filtering or selecting images captured by one or more of the image capture sensors of the inspection system within the temporal window. After extracting the images captured in the temporal window, the extracted images may be further analyzed by the AI engine or stored in a permanent storage system prior to the AI engine analyzing said permanently stored images. It is appreciated that images falling outside of the temporal window may be discarded by the AI engine the data engine. This technique of discarding images (e.g., images captured in the inspection area 502 of the inspection system) that do not fall in one or more temporal windows beneficially optimizes or improves data storage when implementing the disclosed inspection system.

Once the first 2D image and the second 2D image is determined by the AI engine, the AI engine can implement a plurality of analytics on both images to generate analysis data. While the first 2D image and the second 2D image is used to illustrate an exemplary implementation, it is appreciated that multiple 2D images of the transport structure from multiple perspectives can be analyzed by the AI engine to generate the disclosed analysis data. For example, once the AI engine determines the temporal window, a first front lit 2D image (e.g., first 2D image) of the transport structure from a first perspective may be selected/generated following which a back lit 2D image (e.g., a second 2D image) of the transport structure from a second perspective may be selected/generated following which a third image of the transport structure within the temporal window may be selected for analysis. Having the flexibility to select a plurality of images of the transport structure captured within the temporal window beneficially enables analyzing multiple features of the transport structure, including shadow data on the transport structure which enriches the datapoints in the resultant analysis data. This enriched or enhanced analysis data can provide valuable insight into various properties of the transport structure as discussed above.

It is appreciated that the disclosed approach allows the AI engine to not only serve as an object detection system that obviates the need for laser sensors or other object detection systems, but also allows the AI engine to operate as both a motion sensor and/or a velocity detection system based on images of the transport structure captured within a given time window. In particular, one or more line scan images of a given pallet can be used to determine the presence of the pallet (e.g., object detection/motion sensor feature). This determination can help identify a temporal window which in turn can be matched to transport structure type data that indicates when the images of the transport structure were captured in the temporal window. This matching of the temporal window with transport structure type data can be used by the AI engine to estimate a speed with which the transport structure is propelled through the inspection area 3602 of the inspection system. In some cases, the AI engine can dynamically transmit control signals to adjust or calibrate the speed with which subsequent transport structures are moved (e.g., using a transport unit associated with the inspection system) through the inspection area 3602 so that more or less 2D images of said subsequent transport structures can be captured.

According to one embodiment, the AI engine comprises a plurality of vision cores. The plurality of vision cores can include a vision processing unit comprising a specialized microprocessor designed to accelerate computer vision tasks. This can include image and video processing, object detection, feature extraction, and machine learning inference. Each of the plurality of vision cores can include a neural processing unit (NPU) with vision acceleration circuitry with a specialized AI accelerator computing chip optimized for deep learning and/or image processing tasks including feature identification and classification of 2D image data. In some cases, each of the plurality of vision cores can include an AI vision accelerator that speeds up AI vision tasks. In exemplary implementations, each of the vision cores of the AI engine includes a deep learning inference engine configured for inference computing operations associated with computer vision tasks. Furthermore, at least one of the vision cores referenced herein can include an image processing accelerator with machine learning capabilities. Additionally, each vision core disclosed herein can be associated with a vision co-processor comprising a dedicated processing unit working alongside a main central or distributed processing unit of the disclosed inspection system.

According to one embodiment, the plurality of vision cores associated with the disclosed AI engine are configured to implement feature classification computing operations on 2D images captured using one or more of the image capture sensors of the disclosed inspection system. This can be achieved using a specialized hardware architecture designed for parallel and/or distributed image processing computing operations. In particular, each “vision core” can represent an independent, high-performance computational unit such as an Application-Specific Integrated Circuit (ASIC), a Field-Programmable Gate Array (FPGA), or a dedicated processing cluster within a Graphics Processing Unit (GPU), optimized for neural network inference or conventional computer vision processes. According to one embodiment, these cores are not merely software processes but distinct physical or logical processing elements, each capable of executing portions of the feature classification processes concurrently. For instance, in a deep learning context, individual vision cores might be assigned to process different layers of a Convolutional Neural Network (CNN) or to analyze distinct regions of interest (ROIs) within the same input 2D image of a transport structure. Alternatively, if traditional computer vision is employed, one core might handle edge detection, another perform shape analysis, and a third execute template matching, all in parallel on incoming 2D images of the transport structure.

The configuration for implementing feature classification computing operations associated with 2D images of a transport structure can be established through specific hardwired logic, firmware, or loaded bitstream of each vision core of the AI engine, along with their interconnectivity. For a deep learning-based approach, this configuration can entail an optimized MAC (Multiply-Accumulate) units for efficient matrix multiplications associated with neural networks, dedicated memory caches for weights and activations, and specialized instruction sets for operations like convolution, pooling, and activation functions. The plurality of vision cores of the AI engine can be orchestrated by a data processing unit or a high-speed interconnect fabric (e.g., PCIe, NVLink, or a custom on-chip network) that distributes the 2D image data of a transport structure from the image capture sensors of the inspection system and aggregates the classification results. This parallelism allows for real-time or near real-time processing of high-resolution 2D images, ensuring rapid identification and categorization of features such as defects, material types, or structural anomalies present on the inspected or imaged transport structure, thereby meeting throughput requirements of an industrial inspection system.

Furthermore, the “captured images” from the image capture sensors (e.g., line scan cameras, area scan cameras) can be streamed directly into a shared high-bandwidth memory accessible by the vision cores, or into dedicated buffers for each core via DMA (Direct Memory Access) controllers. The “feature classification computing operations” can involve the execution of computing operations designed to assign categories or labels to specific image features. This could range from Support Vector Machines (SVMs) processes or K-Nearest Neighbors (KNNs, after feature extraction) processes to sophisticated deep learning models. For instance, for identifying material properties of a transport structure, one vision core of the AI engine might run a texture classification computing operation to distinguish between different grain patterns or detect regions of rot or material damage associated with the transport structure. Another vision core of the AI engine could simultaneously execute a structural analysis computing operation to identify cracks or missing components based on geometric feature detection and segmentation. The parallel execution across these distinct vision cores provides not only computational speed but also potential redundancy or specialization, where different vision cores are pre-trained or configured for specific types of feature detection, ensuring robust and comprehensive analysis of the 2D image data of transport structures using the disclosed inspection system.

According to one embodiment, the AI engine can operate on independent images representing different views of the transport structure captured using the image capture sensors of the disclosed inspection system without necessarily combining all the images to create a digital representation (e.g., a computing model of the transport structure). In particular, the disclosed AI engine can analyze images of the individual views of the transport structure to generate the analysis data that indicates the various properties of the transport structure. In other embodiments, the AI engine can combine images of the various views of the transport structure to create a digital representation of the transport structure.

According to one embodiment, the disclosed AI engine operates using one of two operational modes directed to specifically handling 2D images representing one or more views of a transport structure. These two modes can comprise: an independent image analysis mode with no explicit combination into a unified model of the transport structure; and a combined image analysis mode that create a digital representation of the transport structure.

Because 2D color images of the transport structure are used, the disclosed approach beneficially eliminates false positive classifications that are problematic in monochrome image processing and analysis to determine properties of a given transport structure. Furthermore, because the disclosed system continuously captures images within the inspection area 502 and operates on images captured within a given temporal window, the inspection system can continuously examine on an industrial scale, a plurality of transport structures without the need for motion sensors, collision or impact sensors, etc.

### Mode 1: Independent Image Analysis

According to one embodiment, the AI engine can operate on independent images representing different image views of the transport structure captured using the image capture sensors of the disclosed inspection system without necessarily combining all the images to create a digital representation (e.g., a computing model of the transport structure). This mode can emphasize a decentralized or modular analysis approach. Instead of building a complex, unified model of the transport structure based on 2D images or a holistic 2D stitched image of the entire transport structure, the AI engine processes each individual 2D image view (e.g., top view, side view 1, side view 2, bottom view) as a separate analytical unit. Each image, regardless of its origin (e.g., which sensor captured it, from what angle, etc.), is fed independently into the AI engine's processing pipeline. For instance, the AI engine can implement parallel computing operations that ensures that each image view of the transport structure can be processed simultaneously by different vision cores (as discussed previously) or by different threads/processes, reducing overall processing time. Furthermore, this approach can have the benefit of reduced computational overhead that avoids the complex task of image registration, image reconstruction, or stitching (which can be computationally intensive and error-prone) to save significant processing power and memory. In some cases, the simplicity of this approach can enable detecting properties of from a single 2D view of the transport structure such as: whether a missing deckboard is evident from a top-down view; whether a broken stringer is clear from a side view; whether a visible International Plant Protection Convention (IPPC) stamp can be read from given view; whether there are protruding nails, screws, splinters, etc., on a top surface of the transport structure.

In some cases, this operating mode of the AI engine can be achieved using specialized sub-modules or intelligent network structures trained specifically for each view type. For example, one neural network might be optimized for detecting surface defects from a top view, while another is optimized for structural integrity checks from a side view. The outputs from these individual analyses are then aggregated to form the analysis data. In particular, the disclosed AI engine can analyze images of the individual views of the transport structure to generate the analysis data that indicates the various properties of the transport structure. This means that after analyzing each independent image, the AI engine generates specific outputs for each. For example, after analyzing the top view, the AI engine might report: “Top surface: no missing boards, 2 protruding nails, 1 crack of 5 cm, etc.” After analyzing a side view, the AI engine might report: “Side 1: stringer 2 has a split, no mold.” These individual reports are then combined or summarized into the final analysis data. This final data can comprise an aggregation of findings from each view, not necessarily derived from a single, unified visual representation of the transport structure

### Mode 2: Combined Image Analysis

In other embodiments, the AI engine can combine images of the various views of the transport structure, based on a given temporal window within which said images are captured, to create a digital representation of the transport structure prior to analyzing the images. In particular, this mode comprises an approach where the AI engine actively fuses or registers data from multiple 2D image views to construct a more comprehensive digital representation or computing model of the transport structure. This representation often aims to simulate or reconstruct the 3D geometry of the transport structure using two or more 2D images of the transport structure. In this instance, the AI engine can apply photogrammetry, structured light projection, or stereoscopic vision to infer depth information to build a 3D model or a digital representation of the transport structure. Furthermore, each 2D image of the transport structure can provide data points that are then projected and combined in a 3D coordinate system to form a cloud of points or a polygonal mesh representing a 3D representation of the transport structure's shape and surface. This 3D digital representation or computing model of the transport structure can comprise a geometric or volumetric model where multiple 2D image data of the transport structure are fused into a single coherent computing model that represents the transport structure's spatial extent.

One benefit of this second mode of the AI engine is that it enables accurate warpage assessment or volumetric assessment of the transport structure to detect defects that span multiple surfaces of the transport structure, and/or precise localization of defects of the transport structure in 3D space. According to one embodiment, the AI engine may stitch the 2D images of the transport structure (e.g., images from different sides or overlapping views of the transport structure) into a larger, seamless 2D panoramic view. One benefit of doing this is that it provides a more complete 2D context for defect identification and analysis, eliminating blind spots between individual 2D captured images of the transport structure. In some cases, the AI engine is able to perform holistic property analysis of the transport structure based on the generated 3D model derived from 2D images of the transport structure. This allows for: global structural integrity checks that assess how a defect on one board of the transport structure might impact the overall structural integrity of the transport structure when combined with issues on adjacent components (e.g., a crack extending from one face to another); volumetric analysis that precisely measures the volume of wood, plastic, or other materials used to create the transport structure that has been damaged; complex shape analysis involving detecting subtle deformations or warpage that are hard to quantify from individual 2D projections; etc. In some instances, the second mode of operation of the AI engine can involve using robust calibration of positions of the image capture sensors and sophisticated image registration computing processes to accurately align the different image views captured by the image capture sensors of the transport structure. According to one embodiment, at least one of the image capture sensors comprises a depth image capture sensor that beneficially enables determining the height of the transport structure. This depth image capture can be one of the tunnel or side cameras.

In FIGS. 32, 33, and 36, a multi-color indicator (e.g., a light emitting diode (LED) indicator) 104 may serve as an intuitive and immediate visual communication tool of the disclosed inspection system, providing real-time operational status and fault diagnostics through distinct color codes and blinking patterns. Positioned prominently on top of the inspection system, its primary function is to quickly flag jams and issues related to the transport structure being examined, minimizing downtime and guiding operator response. In a jam detection scenario, the multi-color indicator 104 (simply called indicator 104 hereafter) can be directly linked to analysis data being generated by the AI engine. If a blockage, pile-up, or unexpected stoppage occurs based on, for example, 2D images of the transport structure, the indicator immediately illuminates or flashes with a specific, high-priority color. Beyond simple jams, the indicator 104 communicates the type and severity of issues detected on the transport structure itself, based on the analysis data from the inspection system's AI engine. This allows quickly ascertaining the nature of the problem without needing to consult a separate display. In the absence of faults, the indicator 104 can also indicate normal operation, providing reassurance that the disclosed inspection system is running smoothly.

### Exemplary Color Code Patterns of the Indicator 104

### 1. Green (Solid):

Meaning: System operating normally, no jams detected, transport structures passing inspection or meeting acceptable criteria.
Action: No action required; indicates efficient throughput.

### 2. Yellow/Amber (Solid):

Meaning: Minor Issue/Warning. A detected property or defect on the transport structure that is not critical but warrants attention. This could be a non-critical dimension deviation, a minor cosmetic flaw, or a transport structure that needs repair but is not immediately taken offline.
Action: Operator awareness; may trigger automatic diversion to a “repair” or “rework” lane, or prompt a check during a slower period.

### 3. Yellow/Amber (Slow Blink):

Meaning: Attention Required/Pending Action. This might indicate a pallet identified as “repairable” or “needs verification,” which has been diverted, or a low-priority system alert (e.g., low consumable, maintenance reminder).
Action: Acknowledge alert; proceed with designated action for the flagged pallet/system state.

### 4. Red (Solid):

Meaning: Critical Issue/System Halted. This signifies a significant problem with the transport structure that requires immediate intervention. Examples include severe structural damage (e.g., broken stringer, multiple missing boards), detection of foreign objects that could damage machinery, or critical safety violations.
Action: Immediate halt of the inspection line (or relevant section). Operator must investigate, remove/address the critical issue before resuming operations.

### 5. Red (Fast Blink):

Meaning: System Jam/Emergency Stop. The highest priority alert, indicating an active jam within the inspection area 502 that has caused the line to stop, or an emergency stop has been triggered.
Action: Immediate and urgent operator intervention to clear the jam and ensure safety. This pattern typically overrides all other signals.

### 6. Blue (Solid or Blinking):

Meaning: System Diagnostics/Setup Mode/Non-Operational State. Can be used when the system is in a setup phase, calibration, or undergoing diagnostics.
Action: Indicates the system is not in an active production state; approach with caution.

### 7. Purple (Solid or Blinking):

Meaning: Unidentified Object/Anomaly Detected. Used when the AI engine detects something it cannot classify or an unexpected object within the inspection zone. This could suggest a foreign object, or a transport structure so severely damaged it is unrecognizable.
Action: Requires manual inspection to identify the anomaly.
   Technical Implementation Considerations Associated with Indicator 104:
Logic Integration: The indicator's control logic can be integrated or synchronized with the AI engine's output (e.g., analysis data). When the AI engine classifies a transport structure or a jam detection is triggered, the appropriate color and blink pattern command is sent to the indicator driver.
Fail-Safe Design: In critical situations (e.g., power failure), the indicator 104 can default to a specific state (e.g., off or flashing red, depending on safety protocols) to avoid misleading indications.
Brightness and Visibility: The indicator 104 can be sufficiently bright and visible from multiple angles within the operational environment of the inspection system, especially in industrial settings with varying light conditions. In some embodiments, the indicator 104 comprises high-intensity LEDs or LED arrays.
Pattern Customization: The specific color-to-meaning mapping and blinking patterns of the indicator 104 can be programmable, allowing for customization based on the standard operating procedures and/or specific inspection requirements of the inspection system.
Auditory Cues: For enhanced communication, the indicator 104 can be paired with an audible alarm (e.g., a buzzer or siren) that changes tone or intensity based on the criticality of the alert, drawing attention even when the visual cue might be momentarily missed.

By leveraging a multi-color indicator 104, the disclosed inspection system provides operators with an at-a-glance understanding of the system's health and immediate action requirements, significantly enhancing operational efficiency and safety in dynamic industrial environments.

### Image Processing

According to some implementations, the inspection system leverages an AI intelligent or trainable data structure associated with an AI engine to optimally analyze or process captured images from one or more cameras of the inspection system. As previously stated above, the imaging software of each camera comprised in the inspection system may coordinate with the AI engine to detect defective transport structures which have been inspected by the inspection system. According to one embodiment, the intelligent or trainable data structure comprises one or more neural networks, and/or one or more supervised or unsupervised learning data structures, and/or one or more decision tree data structures, and/or one or more random forest data structures, and/or one or more linear regression data structures, and/or one or more logistic regression data structures, etc. The one or more neural networks of the inspection system, for example, may be based on a Pytorch framework and/or an OpenCV framework, such that pixels of the 2D high intensity images captured by the monochrome 2D cameras of the inspection system may be grouped together based on pattern recognition associated with annotating and/or training the intelligent or trainable data structure of the AI engine. When a height value is needed for finding a specific defect, logic associated with the inspection system leverages shadow data associated with the scanned transport structure to determine a height value corresponding to a set of pixels under consideration comprised in the grouped pixels (e.g., pixels grouped using the neural networks referenced above) of an image being analyzed.

The following additional features of the disclosed inspection system are provided by way of example, and not by way of limitation:
Finding transport structure top boards: In one embodiment, 2D top high resolution images captured by one or more cameras of the inspections system may be segmented using the AI engine and thereby classify and group sets of pixels together of the 2D top high intensity images. This can result in a set of bounding boxes (e.g., 2D starting coordinates indicating width and length data in pixels) representing each board of a transport structure associated with the 2D top high intensity images. From each bounding box, the inspection system extrapolates board characteristics of a transport structure under consideration including determining: 2D position data of the board, length data of the board, width data of the board, rotation data of the board, displacement data of the board, etc.
Finding cracks in top boards: Here, 2D top high resolution image data (e.g., image data captured using one or more cameras of the inspection system) associated with a scanned transport structure and machine learning can be used to find and measure any cracks within each top board bounding box.
Finding bottom boards: Here, the 2D bottom high resolution images (e.g., images captured using one or more cameras of the inspection system) may be segmented with the AI engine to classify and group sets of pixels together. This can result in a set of bounding boxes (e.g., 2D starting coordinate data, width data, and length data in pixels) representing each board of a transport structure being scanned. From each bounding box, the inspection system extrapolates board characteristics including 2D position data of the board, length data of the board, width data of the board, rotation data of the board, displacement data of the board, etc.).
Finding cracks in bottom boards: In these cases, the 2D bottom high resolution image (e.g., high intensity images captured using one or more cameras of the inspection system) of a board in combination with the AI engine can be used to find and measure any cracks within each bottom board's bounding box.
Finding discoloration of top boards: In instances such as these, the downward facing 2D color cameras can take pictures of the transport structure as it moves along the inspection system. In particular, the AI engine may be used to find and measure discolored areas within a transport structure, classifying said discolored areas by type (e.g., mold properties of the discolored areas, contamination properties of the discolored areas, paper label properties of the discolored areas, etc.).
Finding material loss, cracks, nails in transport structure blocks: A set of 2D color cameras may be placed on each horizontal side of the conveyer (e.g., conveyor of the inspection system) facing towards the transport structure path. Another set of 2D color cameras of the inspection system may be placed underneath the conveyers facing upwards at an angle towards the transport structure path. The AI engine may be used to segment the images from these cameras to find regions of the images that contain the transport structure blocks. Within these regions, the AI engine may be used to find and measure material losses, cracks, and nails, if present in a transport structure being inspected, according to some embodiments.
Verifying block logo stamps: Here, a set of 2D color cameras 308 of the inspection system may be placed on each horizontal side of the conveyer facing towards the transport structure path. The AI engine may be used to find and classify any logo or stamps on a transport structure under consideration. Such classifications may include classifying manufacturer data associated with the transport structure, production information data associated with the transport structure, and IPPC data and International Standards for Phytosanitary Measures (ISPM) heat treatment data associated with the transport structure.

When the inspection system collects the different data referenced above, it can store said data in a database proximal and/or distal relative to the inspection system. In some embodiments, a user database associated with the inspection system can contain user-specific tolerance level data that constraints or bounds or sets a data ranges between a lower and upper. The data ranges can be used to inform a calibration strategy for configuring one or more systems of the inspection system. In some cases, the data ranges can be used to analyze images captured using the inspection system to ensure that the captured image conform to, or are within appropriate expected values with outlier values indicating measurement deviations, which can trigger a retaking of images or additional analysis of images with outlier data. In one embodiment, the inspection system compares measured data via captured images with user-specific tolerance level data and generates an indication (e.g., visual indication such as lights, alarms, etc.) when measurements (e.g., image measurements comprised in a captured image) deviate from the user-specific tolerance level data. For example, the inspection system may have one or more visual indicators such as lights that are automatically activated to: indicate that captured image measurements satisfy user-specific or user defined tolerance level data (e.g., a green light indication); and indicate that captured image measurements do not satisfy the user-specific tolerance level data (e.g., a red light indication). These indications may or may not include auditory indications (e.g., alarms) as well. It is appreciated that such an approach beneficially enables customizing the operation of the inspection system to adaptively analyze transport structure image data based on user preferences and/or based on compliance requirements associated with an institution or a jurisdiction.

### Additional Features

According to some embodiments, the following process may be implemented using the inspection system to detect deckboards:
segmenting every pixel (e.g., comprised in a captured image) belonging to deckboards on each image of a transport structure based on a deep neural network (DNN) analysis of one or more images of the transport structure being scanned;
segmenting close-board cracks on each image of the transport structure based on DNN analysis of images associated with the transport structure being scanned;
stitching all images of the transport structure based on the aforementioned segmentations;
aligning a digital orientation of the transport structure being scanned based on the stitching;
if transport structure-type data of the scanned transport structure belongs to a given data category (e.g., perimeter bottom), then a deckboard (db) mask of transport structure may be split, based on the aligning, into horizontal and vertical db masks;
excluding close-board cracks from the db masks;
applying signal preprocessing on db masks;
fitting rotated rectangles over components on the db masks;
merging said rotated rectangles (e.g., if a board is broken such that merger would occur at this step; and
refining (e.g., expanding or shrinking based on fill ratio data) data boundaries associated with the merged rotated rectangles of a transport structure under inspection.

According to some embodiments, the following process may be implemented using the inspection system to detect cracks in transport structures:
segmenting cracks associated with a transport structure being scanned based on each image of the transport structure using a DNN on said image;
stitching crack masks associated with the image based on the segmenting;
finding initial crack component data associated with the transport structure based on the stitching associated with the image;
filtering-out, based on a minimum overlap with boards, to remove one or more patterns that are similar to found cracks and close to the edges of the transport structure;
filtering-out aspects outside the board parts; and
measuring width data, coverage data, distance-to-edge data associated with the transport structures.

According to some embodiments, the following process may form part of a material loss detection process implemented by the inspections system:
considering all empty spaces in deckboard mask as initial material loss (ml) mask (DNN) associated with captured images of a transport structure undergoing scanning;
stitching material loss masks associated with the inspected transport structure based on the considering;
filtering-out outside data range values of the board boundaries from the stitched ml masks;
finding/determining components data in response to the filtering;
measuring density data and edge regularity data for each component datapoint and thereby remove detected image capturing issues;
calibrating various subsystems of the inspection system based on the density data and the edge regularity data; and
filtering, by size and distance to the edges.

According to some embodiments, the following process may form part of a protruding nail detection process (associated with a transport structure with a protruding nail) implemented using the inspections system:
segmenting all nails detected in a captured image of the transport structure, using a deep neural network;
stitching nail masks based on the segmenting to generate a stitched image;
finding nail components data in the stitched image based on the stitching;
calibrating and filtering-out small nails in the stitched image based on the nail component data;
determining, using the AI engine, height data for each detected nail in the stitched image. The AI engine uses shadow data in the stitched image to first ascertain the presence or absence of a nail within each image. Upon detecting a nail via the shadow data, the AI engine proceeds to calculate the nail's height using the characteristics of said shadow data. In one embodiment, the shadow data comprises the pixels or regions within the stitched image that correspond to areas of reduced illumination caused by an object (e.g., the nail, protrusions on the transport structure, etc.) blocking a light source (e.g., an illumination unit of the inspection system and/or a flash system comprised in the image capture sensor(s) of the inspection system). In particular, the shadow data is not merely the absence of light but carries relevant geometric information about the object casting the shadow, the light source, and the surface (e.g., surface of the transport structure) on which the shadow falls
classifying, based on the determining, the nail component into two protruding and regular parts;
finding the main protruding subcomponent based on the classifying;
measuring its height (e.g., the protruding nail's height) to determine if it (e.g., the nail whose height is measured) is large enough (e.g., based on the local difference);
finding the base material (e.g., deckboard/cross board/block/background) associated with a nail whose height has been measured;
measuring a minimum distance from the nail whose height has been measured to board and thereby localize said nail and/or other nails comprised in the transport structure whose image was taken by the inspection system; and
assigning a zone identifier to each nail on the transport structure under consideration based on the minimum distance.

### Training Data

According to some embodiments, a plurality of images from multiple angles of a transport structure or other transport structures may be taken while passing one or more transport structures through the disclosed inspection system. These images may be automatically collected and annotated by drawing (e.g., computationally or digitally drawing) segmentation masks around transport structure components (e.g., boards, nails, blocks, etc.) during the imaging process by the inspection system. For example, the segmentation masks may comprise one or more binary images used to highlight specific regions or objects within subsequent images captured by the inspection system after training the AI engine of the inspection system. The one or more segmentation masks may be computationally used like a stencil, where pixels belonging to the subsequent transport structure images of interest are marked (e.g., often with the value 1) and the background pixels are typically marked with 0. This allows for isolating and analyzing specific parts of an image of a transport structure being scanned by the inspection system.

In some cases, segmentation masks for defects associated with one or more transport structures can also be annotated to indicate cracks, material losses, protruding nails, contaminations, plastic wraps, etc., associated with the plurality of transport structures being scanned. For example, some of the foregoing image annotations may be classification based where a transport structure block is developed to have a stamp showing manufacturer data (e.g., data associated with the manufacturer of the transport structure and/or data associated with the manufacturer of goods being transported using the transport structure) including other qualitative data. In some cases, the annotations can be implemented using a tool that is trained to make annotation predictions for images of transport structures being scanned. To artificially increase variations, some data transformations including skewing, resizing, and mirroring can be applied to images of transport structures captured by the inspection system.

### Exemplary Workflows

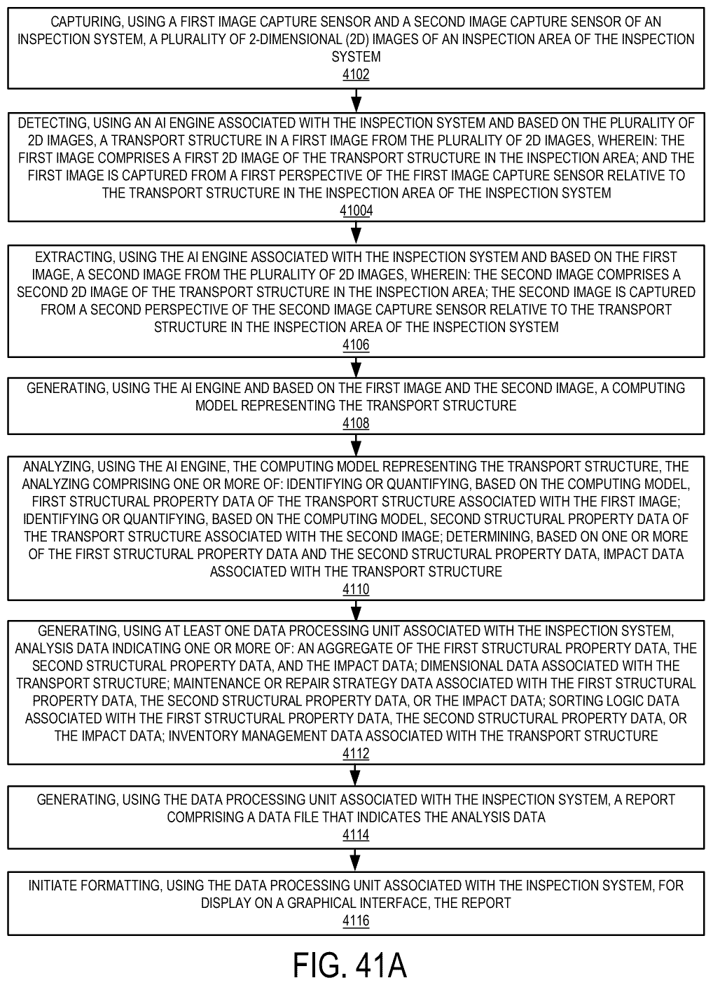

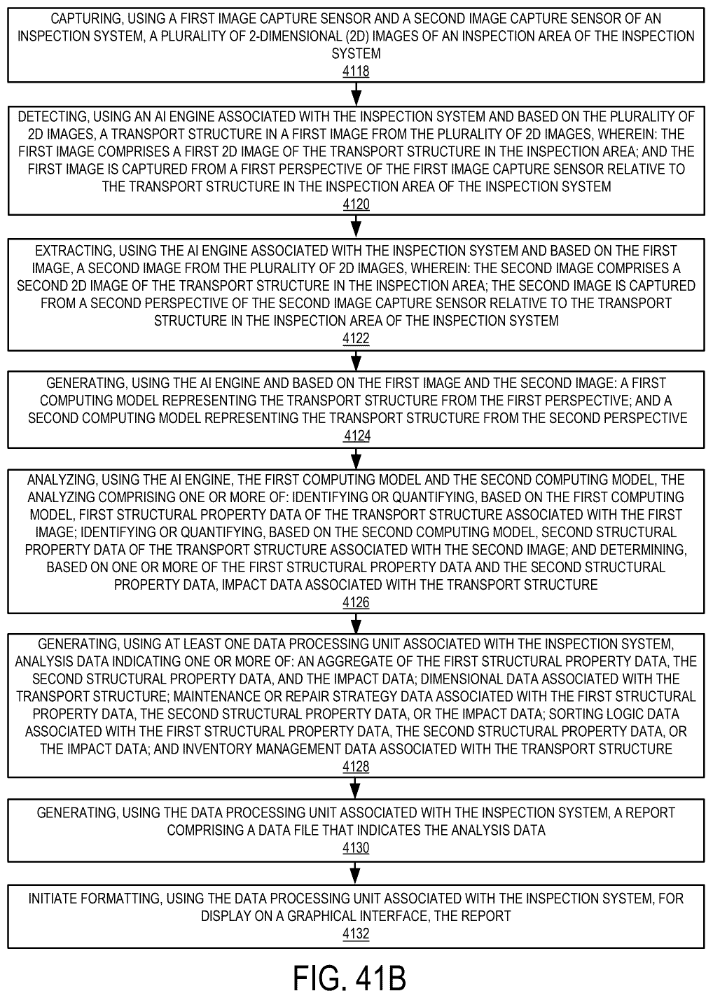

FIG. 41A illustrates another exemplary workflow for assessing, determining, or quantifying structural properties of a transport structure using the disclosed inspection system. One or more data engines, comprising control logic or applications stored in a non-transitory memory device, can enable the implementation of various stages within this workflow. The one or more data engines can operate independently or in conjunction with a logistical software tool for transport structure monitoring and management.

At block 4102, the one or more data engines can facilitate capturing, using a first image capture sensor and a second image capture sensor of an inspection system, a plurality of 2-dimensional (2D) images of an inspection area of the inspection system.

Turning to block 4104, the one or more data engine can enable an AI engine associated with the inspection system, to detect, based on the plurality of 2D images, a transport structure in a first image from the plurality of 2D images. It is appreciated that the first image can comprise a first 2D image of the transport structure in the inspection area. It is further appreciated that the first image can be captured from a first perspective of the first image capture sensor relative to the transport structure in the inspection area of the inspection system.

At block 4106, the one or more data engines can facilitate extracting, using the AI engine associated with the inspection system and based on the first image, a second image from the plurality of 2D images. In one embodiment, the second image comprises a second 2D image of the transport structure in the inspection area. In addition, the second image may be captured from a second perspective of the second image capture sensor relative to the transport structure in the inspection area of the inspection system.

At block 4108, the one or more data engines prompt the AI engine to construct a computing model representing the transport structure, derived from the first and second images. This can involve the AI engine independently extracting a first set of data features from the first image and a second set from the second image. Subsequently, the AI engine creates a computing template or digital representation using these combined feature sets. Alternatively, the AI engine may generate distinct computing templates for each image (first and second), analyzing them separately. Whether processed independently or combined, these individual computing templates serve as two fundamental data parts of the computing model referenced at step 4108. In other embodiments, the AI engine integrates or combines the first and second computing templates to form the complete computing model referenced at block 4108.

At block 4110, the one or more data engines may facilitate analyzing, using the AI engine, the computing model representing the transport structure. This analyzing step can comprise one or more of: identifying or quantifying, based on the computing model, first structural property data of the transport structure associated with the first image; identifying or quantifying, based on the computing model, second structural property data of the transport structure associated with the second image; and determining, based on one or more of the first structural property data and the second structural property data, impact data associated with the transport structure.

Turning to block 4112, the one or more data engines may cause at least one data processing unit associated with the inspection system to generate analysis data indicating one or more of: an aggregate of the first structural property data, the second structural property data, and the impact data; dimensional data associated with the transport structure; maintenance or repair strategy data associated with the first structural property data, the second structural property data, or the impact data; sorting logic data associated with the first structural property data, the second structural property data, or the impact data; and inventory management data associated with the transport structure.

At block 4114, the one or more data engines may enable data processing unit associated with the inspection system to generate a report comprising a data file that indicates the analysis data. In one embodiment, the data file comprises one of: a “Comma Separated Values” data file (e.g., .csv data file); Parquet data file; an Optimized Row Columnar (ORC) data file; a Pickle data file; an Avro data file (a row-oriented data serialization system often used in big data for efficient storage and schema evolution), a Feather data file (a fast, lightweight binary format for data frames built on Apache Arrow, ideal for quick data exchange between languages like Python and R), or any other similar structured data format.

In exemplary implementations, the one or more data engines may cause the data processing unit associated with the inspection system to initiate formatting, for display on a graphical interface (e.g., graphical user interface (GUI)), the report. For example, the one or more data engines can orchestrate the process of transforming the raw analysis into a user-consumable format. Specifically, the one or more data engines can instruct the data processing unit (a component associated with the inspection system) to format the report for display on a graphical user interface. This formatting process can be dynamic and adaptable, enabling the report to be presented effectively regardless of its underlying file type. For instance, if the report is stored in a highly optimized binary format such as an Avro file or a Feather file, which are optimized for efficient storage and high-speed data transfer but not directly human-readable, the one or more data engines can coordinate the necessary deserialization and conversion of the Avro file or Feather file. This can involve implementing a parsing and deserialization computing operation by reading the binary data from the Avro or Feather file, interpreting its schema (which is can be embedded within these file types for self-description), and converting the binary data into a structured data representation. The one or more data engines may further facilitate a data transformation computing operation by organizing and/or aggregating data extracted from the data file associated with the report. For example, if the raw data comprised in the data file of the report contains thousands of individual sensor readings, the data one or more data engines may facilitate calculating averages, identifying outliers, or group related measurements to present a more digestible summary. In some cases, the one or more data engines may facilitate implementing a layout and presentation logic that applies rules and templates to structure the data contained in the report for visual consumption. This can involve: implementing a columnar layout computing operation that arranges the data in the report into tables with clear headers (e.g., for CSV-like data); graphical element generation computing operations that generate charts (e.g., bar graphs, line charts, pie charts), plots (e.g., scatter plots of structural properties), or visual representations of the transport structure and its detected features (e.g., highlighting areas of damage, defect annotations, or other properties of the transport structure). In addition, the one or more data engines can facilitate implementing generating textual summaries that creating readable text descriptions of the inspection findings, highlighting critical issues or deviations from expected norms. In some cases, the one or more data engines can beneficially enable generation of interactive data elements that enable user interaction with the report, such as filtering data, drilling down into specific details, or changing visualization types. Thus, the output of the formatting process at block 4116 is a display-ready report, regardless of whether the original data was in any of the aforementioned data files discussed above in conjunction with block 4116. In particular, the goal here is to present complex inspection data associated with a transport structure in an intuitive, easily understandable manner on graphical interface, facilitating rapid assessment and decision-making.

Also disclosed is an inspection system for assessing, determining, or quantifying structural properties of a transport structure. According to one embodiment, the inspection system comprises: a first image capture sensor configured to capture a first plurality of 2D images from a first perspective in an inspection area of the inspection system; and a second image capture sensor configured to capture a second plurality of 2D images from a second perspective in the inspection area. In one embodiment, a first application associated with the first image capture sensor comprises computing logic that is configured to transmit the first plurality of 2D images to a non-transitory computing memory device associated with the inspection system. Similarly, a second application associated with the second image capture sensor can comprise computing logic that is configured to transmit the second plurality of 2D images to the non-transitory computing memory device associated with the inspection system.

According to one embodiment, the inspection system comprises an AI engine configured to: access the non-transitory computing memory device associated with the inspection system to retrieve a first image from the first plurality of 2D images; access, based on the first image, the non-transitory computing memory device associated with the inspection system to retrieve a second image from the second plurality of 2D images; generate, based on the first image and the second image, a computing model representing the transport structure; and analyze the computing model. The AI engine can analyze the computing model by implementing one or more of: identifying or quantifying, based on the computing model, first structural property data of the transport structure associated with the first image; identifying or quantifying, based on the computing model, second structural property data of the transport structure associated with the second image; and determining, based on one or more of the first structural property data and the second structural property data, impact data associated with the transport structure.

In some implementations, the inspection system comprises or has at least one data processing unit comprising computing logic that generates analysis data indicating one or more of: an aggregate of the first structural property data, the second structural property data, and the impact data; dimensional data associated with the transport structure; maintenance or repair strategy data associated with the first structural property data, the second structural property data, or the impact data; sorting logic data associated with the first structural property data, the second structural property data, or the impact data; and inventory management data associated with the transport structure. In some cases, the at least one data processing unit can also: generate a report comprising a data file that indicates the analysis data; and initiate formatting, for display on a graphical interface, the report.

FIG. 41B illustrates an additional exemplary workflow for assessing, determining, or quantifying structural properties of a transport structure using the disclosed inspection system. One or more data engines, comprising control logic or applications stored in a non-transitory memory device, can enable the implementation of various stages within this workflow. The one or more data engines can operate independently or in conjunction with a logistical software tool for transport structure monitoring and management.

At block 4118, the one or more data engines facilitate capturing, using a first image capture sensor and a second image capture sensor of the disclosed inspection system, a plurality of 2-dimensional (2D) images of an inspection area of the inspection system.

At block 4120, the one or more data engines enable detecting, using an AI engine associated with the inspection system and based on the plurality of 2D images, a transport structure in a first image from the plurality of 2D images. It is appreciated that: the first image comprises a first 2D image of the transport structure in the inspection area; and the first image is captured from a first perspective of the first image capture sensor relative to the transport structure in the inspection area of the inspection system.

At block 4122, the one or more data engines cause the AI engine associated with the inspection system to extract a second image from the plurality of 2D images. This image extraction can be based on the first image, meaning that the second image is extracted based on features (e.g., features associated with the transport structure) detected in the first image. It is appreciated that: the second image comprises a second 2D image of the transport structure in the inspection area; and the second image is captured from a second perspective of the second image capture sensor relative to the transport structure in the inspection area of the inspection system.

At block 4124, the one or more data engines can facilitate generating, using the AI engine and based on the first image and the second image: a first computing model representing the transport structure from the first perspective; and a second computing model representing the transport structure from the second perspective.

At block 4126, the one or more data engines can cause the AI engine to analyze the first computing model and the second computing model, the analyzing comprising one or more of: identifying or quantifying, based on the first computing model, first structural property data of the transport structure associated with the first image; identifying or quantifying, based on the second computing model, second structural property data of the transport structure associated with the second image; determining, based on one or more of the first structural property data and the second structural property data, impact data associated with the transport structure.

At block 4128, the one or more data engines can facilitate generating, using at least one data processing unit associated with the inspection system, analysis data indicating one or more of: an aggregate of the first structural property data, the second structural property data, and the impact data; dimensional data associated with the transport structure; maintenance or repair strategy data associated with the first structural property data, the second structural property data, or the impact data; sorting logic data associated with the first structural property data, the second structural property data, or the impact data; and inventory management data associated with the transport structure.

At block 4130, the one or more data engines can cause the data processing unit associated with the inspection system to generate a report comprising a data file that indicates the analysis data.

At block 4132, the one or more data engines can prompt the data processing unit associated with the inspection system to initiate formatting, for display on a graphical interface, the report. The formatting step here is similar or consistent with the processes discussed in association with block 4116 of FIG. 41A.

These and other implementations may each optionally include one or more of the following features. The transport structure referenced in association with above workflows can be a pallet or a crate.

Furthermore, the first image capture sensor can comprise at least a first color camera while the second image capture sensor can also comprise at least a second color camera.

In some cases, the AI engine comprises a plurality of vision cores configured to implement feature classification computing operations on 2D images captured using one or more image capture sensors (e.g., first image capture sensor and second image capture sensor) of the inspection system.

In some cases, at least one of the first image of the transport structure or the second image of the transport structure comprises or is associated with at least one of: 2D surface texture image data indicating material surface characteristics of the transport structure; or 2D deformable light pattern image data indicating a surface topology deviation caused by an illumination subsystem associated with the inspection system that projects one or more light patterns on the transport structure prior to, or during capturing the first image or the second image.

Furthermore, a first application associated with (e.g., comprised in) the first image capture sensor transmits, from the first image capture sensor, the first image to a non-transitory computer memory device associated with the inspection system. Similarly, a second application associated with (e.g., comprised in) the second image capture sensor transmits the second image to the non-transitory computer memory device associated with the inspection system. It is appreciated that the first application and the second application operate independent of each other. It is further appreciated that the AI engine accesses the non-transitory computer memory device to retrieve or extract the first image and the second image.

In some cases, the first image capture sensor continuously captures a first set of images of the inspection area of the inspection system. In addition, the second image capture sensor continuously captures a second set of images of the inspection area of the inspection system. Furthermore, the plurality of 2D images of the inspection area comprises the first set of images and the second set of images. In addition, the plurality of 2D images of the inspection area can be transmitted to a non-transitory memory device associated with the inspection system. In response to the AI engine retrieving at least the first image and the second image from the non-transitory memory device thereby resulting in a reduced set of images in the non-transitory memory device, such that the reduced set of images are deleted thereby optimizing a data storage capacity of the non-transitory memory device. In effect, deleting the reduced set of images optimizes the data storage capacity of the non-transitory memory device, effectively maximizing its available storage space.

According to some embodiments, the first image capture sensor or the second image capture sensor is applied to detect shadow data indicating one or more shadows projected onto the transport structure by at least an illumination unit (e.g., LED light that illumines the transport structure for imaging) associated with the inspection system. In some cases, the illumination unit (also referred to as illumination subsystem elsewhere herein) comprises one or more of an incandescent lamp, a fluorescent lamp, a strobe light, a high-intensity discharge (HID) lamp, an LED, or a plasma light.

In one embodiment, the above workflows comprise analyzing, using the AI engine, the shadow data to determine at least height information associated with protrusions on the transport structure.

In some cases, the first image capture sensor captures a top view image of the transport structure while the second image capture sensor captures a side view image of the transport structure.

In some cases, the AI engine applies depth analysis to determine a height for the transport structure.

According to some embodiments, the first image capture sensor and the second image capture sensor are arranged about the inspection system to be orthogonal relative to each other.

Furthermore, the first computing model and the second computing model are independently analyzed by the AI engine to generate the first structural property data, the second structural property data, and the impact data. In addition, the first computing model and the second computing model can be combined into an aggregate digital model representing the transport structure, such that the aggregate model is analyzed to generate the first structural property data, the second structural property data, and the impact data.

The above workflows can also comprise propelling, using a transport unit associated with the inspection system, the transport structure to the inspection area of the inspection system.

In some cases, the transport unit propels the transport structure at a velocity adjusted according to type data of the transport structure.

Furthermore, the transport unit associated with the disclosed inspection system can be integrated into the inspection system and can be directly controlled by a first control logic associated with the inspection system. In some embodiments, the transport unit associated with the inspection system is separate or distinct relative to the inspection system and is indirectly controlled by a second control logic that may or may not be associated with the inspection system.

According to some embodiments, the disclosed image capture sensors (e.g., the two or more image capture sensors referenced above) can comprise a flatbed scanner configured to capture 2D information, barcode scanner, an optical comparator, a structured light scanner, a stroboscope, etc.

In some cases, the inspection system comprises a plurality of image capture sensors including the first image capture sensor and the second image capture sensor, wherein: the first image capture is paired with a third image capture sensor such that the first image capture sensor and the third image capture sensor are positioned to be opposite relative to each other; and the second image capture is paired with a fourth image capture sensor such that the second image capture sensor and the fourth image capture sensor are positioned to be opposite relative to each other. It is appreciated that this image capture sensor pairing beneficially enable capturing front lit and back lit images from opposite perspectives in the inspection area relative to a transport structure being imaged.

In exemplary cases, the plurality of image capture sensors comprise a fifth image capture sensor opposite to a sixth image capture sensor in the inspection area of the inspection system, such that: the fifth image capture sensor is movable to have a field of view that covers a 45-degree or a 60-degree angular span; and the sixth image capture sensor is movable to have a field of view that covers a 45-degree or a 60-degree angular span.

### Data Outputs

In some instances, a data report comprising multidimensional visualizations may be generated in response to inspecting a given transport structure by the disclosed inspection system. It is appreciated that the disclosed inspection system can be used to determine, based on the data report, whether a given transport structure meets a specific operational specification.

Furthermore, the disclosed methods and systems provide a technical solution for conducting full dimensional analysis of transport structures by leveraging captured two-dimensional (2D) precision images and shadow data of an inspected transport structure, thereby eliminating the requirement for three-dimensional (3D) imaging systems.

Exemplary AI Engine Associated with the Disclosed Embodiments

In exemplary implementations, the AI engine includes, and/or controls a plurality of computing models (e.g., image and/or video models), also called vision cores, that dynamically and automatically receive and process or analyze image data associated with a plurality of transport structures. The following description regarding the various models or vision cores is provided as a non-exhaustive contextualization of certain aspects of the models or vision cores used by the AI engine of the inspection system.

### Segmentation Model

According to one embodiment, the AI engine referenced above in association with the inspection system drives or applies a segmentation model configured for real-time or near-real-time segmentation of image data captured by one or more cameras of the inspection system. It is appreciated that the segmentation model can include a plurality of sub-models that work together to optimally execute segmentation computing operations on one or more images captured by the inspection system. For example, the segmentation model can comprise a sub-model adapted for Short-Term Dense Concatenate network (STDC network) segmentation computing operations. This sub-model, for example, can enable progressively reducing the dimension of feature maps associated with transport structure images as well as using the aggregation of the reduced dimensional features for image representation.

In some cases, the segmentation model is based on a neural network architecture. In particular, the neural network architecture may comprise an efficient neural network adapted for computing tasks requiring low latency.

In some implementations, the segmentation model comprises a sub-model that analyzes one or more images captured by the inspection system using a focal loss computing process. For example, the focal loss computing process can reshape cross entropy loss information associated with the one or more captured images of transport structures such that the focal loss computing process down-weights the loss assigned to classified data comprised in the one or more captured images. Furthermore, the focal loss computing process, according to some embodiments, can be based on training the segmentation model using a sparse set of specific data points or examples associated with a plurality of transport structures and thereby prevent a vast number of inaccuracies due to false positive detections or false negative detections from overwhelming the AI engine.

### Classification Model

According to one embodiment, the AI engine adaptively customizes and uses a classification model during reception and analysis of one or more images captured by the inspection system. For example, the classification model can be based on a residual learning framework that eases the training of intelligent data structures (e.g., network data structures) associated with the classification model. Specifically, data layers associated with the classification model can be explicitly reformulated as learning residual functions relative to the data layer inputs applied to the classification model. Thus, the segmentation model can advantageously be used for optimal depth representation of the 2D images captured by the inspection system based on its deep representation features.

In some cases, the classification model comprises an efficient data mechanism that is adaptable to scale data features comprised in captured images and thereby balance network depth, network width, and resolution data associated with capturing and transmitting images for analysis. In particular, this data mechanism of the classification model can automatically and uniformly scale dimensional features (e.g., depth, width, resolution, etc.) comprised in a captured image of a transport structure using a highly effective compound coefficient.

### Stitching Model

According to one embodiment, the AI engine leverages a stitching model based on a deep neural network to learn to match local features across images captured by the inspection system. Some benefits of using the stitching model includes low memory requirements, fast computations associated with processing transport structure images, improved resolution associated with said transport structure images, accuracy of results associated with processing said transport structure images, and ease of training the stitching model. In some cases, the stitching model can be adaptively configured for specific images of transport structure under consideration.

In some implementations, the stitching model leverages one or more features of Reinforcement Learning (RL) thereby optimizing end-to-end feature matching computing operations associated with captured images of transport structures by the inspection system. In particular, probabilistic methodologies can be used to train the stitching model to implement inference computing operations that maintain model convergence properties (e.g., properties that indicate optimal model performance) to reliably use the stitching model for image analysis computing operations.

According to some embodiments, the stitching model is based on a Sparse Deformable Descriptor Head (SDDH) computing framework which learns deformable positions of supporting features for each keypoint data comprised in a captured image of a transport structure and constructs deformable descriptors for said keypoint data. Furthermore, the stitching model can use an SDDH process to extract descriptors at sparse keypoint datapoints instead of a dense descriptor map, thereby enabling efficient extraction of descriptors with strong expressiveness.

### Contrastive Learning Model

In some cases, the AI engine uses a contrastive learning model during processing images of transport structures. The contrastive learning model, for example, can be trained and/or used in a self-supervised batch contrastive process or in a fully-supervised computing process that allows effectively leveraging label information when implemented to analyze image data. It is appreciated that data clusters of points belonging to the same class within a given image of a transport structure can be pulled together in an embedding space, while simultaneously pushing apart clusters of samples from different classes to distinct embedding spaces.

In one embodiment, the contrastive learning model is based on a framework for contrastive learning of visual representations. In particular, the contrastive learning model can be trained or used as a result of a contrastive self-supervised learning process without requiring specialized architectures or a memory bank.

According to some embodiments, the contrastive learning model can be based on a Bilateral Segmentation Network (BiSeNet) adapted or configured for real-time semantic segmentation of image data associated with transport structures. In particular, BiSeNet can provide two-stream data network structures for real-time segmentation of the disclosed image analysis of transport structure images captured by the inspection system.

### Detection Model

According to one embodiment, the AI engine referenced above in association with the inspection system uses a detection model that is based on a Region Proposal Network (RPN) to analyze images captured by the inspection system. It is appreciated that the detection model can share full-image convolutional features with a detection network (e.g., an intelligent data structure network). It is further appreciated that the detection model can have an attendant convolutional network that simultaneously predicts object bounds and thereby generates data scores at each datapoint comprised in a captured transport structure image.

In some cases, the detection model referenced herein can be trained to generate high-quality region proposals comprised in an image captured by the inspection system, which is subsequently used by a Fast Region Proposal Network (RPN) of the detection model for feature detection computing operations. The region proposals referenced above can comprise a generated region of interest (ROI) within an image that is hypothesized to contain an object. These proposals can also comprise bounding box suggestions that a control logic creates, indicating potential locations of objects in an image before further analysis and classification of said objects in an image.

The above-described features and applications can be implemented as software processes or data engines include specified sets of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “application” or “software” is meant to include firmware residing in read-only memory or applications stored in magnetic storage, which can be read into memory for processing by a processor. Also, in some implementations, multiple software or application technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, application, script, or code) can be written in any form of programming language, including compiled or interpreted languages, declarative or procedural languages, and it can be deployed in any form, including as a standalone program or as a sub-system, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more sub-systems, sub programs, or portions of code). A computer program can be deployed to be executed on one computer or on multiple computers that are located at one site or distributed across multiple sites and interconnected by a communication network.

As used in this specification and any claims of this application, the terms “computer,” “server,” “processor,” and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

Various terms used herein have meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

It is appreciated that the term optimize/optimal and its variants (e.g., efficient or optimally) may simply indicate improving, rather than the ultimate form of ‘perfection’ or the like.

It is further appreciated that any portion or element of any embodiment (structure, method, etc.) disclosed herein may be combined with any portion or element of any other embodiment (structure, method, etc.) disclosed herein.

Additionally, the section headings herein are provided for consistency with the suggestions under 37 CFR 1.77 or otherwise to provide organizational cues. These headings shall not limit or characterize the disclosed embodiment(s) set out in any claims that may issue from this disclosure. Specifically, and by way of example, although the headings refer to a “Technical Field,” such claims should not be limited by the language chosen under this heading to describe the so-called technical field. Further, a description of a technology in the “Background” is not to be construed as an admission that technology is prior art to any disclosed embodiment(s) in this disclosure. Neither is the “Summary” to be considered as a characterization of the disclosed embodiment(s) set forth in issued claims. Furthermore, any reference in this disclosure to “embodiment” in the singular should not be used to argue that there is only a single point of novelty in this disclosure. Multiple embodiments may be set forth according to the limitations of the multiple claims issuing from this disclosure, and such claims accordingly define the disclosed embodiment(s), and their equivalents, which are protected thereby. In all instances, the scope of such claims shall be considered on their own merits in light of this disclosure, but should not be constrained by the headings set forth herein.

1.-40. (canceled)

41. A method for non-destructively assessing structural integrity and material properties of a transport structure, the method comprising:
illuminating, using an illumination subsystem of an inspection system, a transport structure undergoing inspection by the inspection system;
capturing, by a first image capture sensor of the inspection system, a first image of the transport structure as the transport structure traverses an inspection area of the inspection system;
capturing, by a second image capture sensor of the inspection system, a second image of the transport structure as the transport structure traverses the inspection area of the inspection system, wherein:
the first image comprises a first 2-dimensional (2D) image captured using the first image capture sensor from a first perspective relative to the transport structure as the transport structure traverses the inspection area of the inspection system, and
the second image comprises a second 2D image captured using the second image capture sensor from a second perspective relative to the transport structure as the transport structure traverses the inspection area of the inspection system;
generating, by an artificial intelligence (AI) engine associated inspection system and based on the first image, a first computing model of the transport structure from the first perspective;
generating, by the AI engine associated with the inspection system and based on the second image, a second computing model of the transport structure from the second perspective;
analyzing, using the AI engine, the first computing model and the second computing model, the analyzing comprising:
determining, based on the first computing model, first structural property data of the transport structure associated with the first image,
determining, based on the second computing model, second structural property data of the transport structure associated with the second image,
determining, based on one or more of the first structural property data and the second structural property data, impact data associated with the transport structure, and
generating, using at least one data processing unit associated with the inspection system, analysis data indicating one or more of:
an aggregate of the first structural property data, the second structural property data, and the impact data,
dimensional data associated with the transport structure,
maintenance or repair strategy data associated with the first structural property data, the second structural property data, or the impact data,
sorting logic data associated with the first structural property data, the second structural property data, or the impact data, and
inventory management data associated with the transport structure;
generating, using the data processing unit associated with the inspection system, a report comprising a data file that indicates the analysis data; and
initiate formatting, using the data processing unit associated with the inspection system, for display on a graphical interface, the report.

42. The method of claim 41, wherein the transport structure is a pallet or a crate.

43. The method of claim 41, wherein:
the illumination subsystem comprises a laser illumination system that illuminates the transport structure prior to capturing the first image or the second image, and
frequency data of the laser illumination system is matched to frequency data of at least the first image capture sensor or the second image capture sensor prior to capturing the first image or the second image.

44. The method of claim 41, wherein one of:
the first image capture sensor or the second image capture sensor comprises at least one monochrome camera, and
the first image capture sensor or the second image capture sensor comprises at least one color camera.

45. The method of claim 41, wherein:
the AI engine comprises a plurality of vision cores such that each vision core comprised in the plurality of vision cores analyzes a specific feature of:
the first computing model of the transport structure from the first perspective, and
the second computing model of the transport structure from the second perspective; and
at least one of the plurality of vision cores is used to map one or more datapoints in the first computing model or the second computing model to a height map data table and thereby determine height data for the transport structure.

46. The method of claim 41, wherein the first image capture sensor and the second image capture sensor does not capture 3-dimensional image data of the transport structure.

47. The method of claim 41, wherein the report enables confirming that the transport structure meets a predetermined structural specification.

48. The method of claim 41, wherein the inspection system is a multi-modal inspection system that leverages data from multiple modalities including:
a first data modality associated with illuminations on the transport structure caused by the illumination subsystem, and
a second data modality associated with surface indicia on the transport structure that are captured by at least one of the first image capture sensor or the second image capture sensor, the indicia comprising one or more of image or textual data.

49. The method of claim 41, wherein:
the first image capture sensor includes a first application configured to capture and transmit images of the inspection area of the inspection system from the first perspective, and
the second image capture sensor includes a second application configured to capture and transmit images of the inspection area of the inspection system from the second perspective.

50. The method of claim 41, wherein at least the first image of the transport structure or the second image of the transport structure comprises at least one of:
2D surface texture image data indicating material surface characteristics of the transport structure, and
2D deformable light pattern image data indicating a surface topology deviation caused by the illumination subsystem projecting one or more structured light patterns on the transport structure prior to capturing the first image or the second image.

51. The method of claim 41, further comprising preprocessing, by the data processing unit of the inspection system and prior to the analyzing, the first image and the second image to generate the first computing model of the transport structure and the second computing model of the transport structure, respectively, wherein the preprocessing comprises one or more of:
normalizing lighting condition data in the first image or the second image, the lighting condition data being associated with an illumination effect on the transport structure when the illumination subsystem projects a light pattern onto the transport structure;
correcting for:
a first geometric distortion introduced into the first image during capturing the first image by the first image capture sensor, or
a second geometric distortion introduced by the second image capture sensor during capturing the second image; and
in response to the normalizing and correcting, generating the first computing model of the transport structure and the second computing model of the transport structure.

52. The method of claim 41, wherein:
the transport structure is propelled by a transport unit associated with the inspection system at a predetermined velocity, and
the predetermined velocity is matched to an image acquisition timing of the first image capture sensor and the second image capture sensor.

53. The method of claim 41, wherein determining the first structural property data or determining the second structural property data comprises identifying or quantifying structural properties of the transport structure based on 2D surface topology data or 2D surface texture data associated with the transport structure, and
the identifying or quantifying comprises computationally correlating stored structural integrity metrics associated with the transport structure with data points comprised in the first computing model and the second computing model thereby generating structural anomaly data associated with the transport structure, the structural anomaly data including at least one of:
cracks data associated with the transport structure,
warps data associated with the transport structure,
delamination data associated with the transport structure,
joint failure data associated with the transport structure, and
nail protrusion data associated with the transport structure.

54. The method of claim 41, wherein the impact data indicates material degradation on the transport structure based on textual or spectral features of the transport structure comprised in the first image or the second image, the material degradation comprising one or more of:
moisture damage to the transport structure,
chemical damage to the transport structure,
operational damage due to improperly moving the transport structure from a first location to a second location, and
storage damage due to improperly storing or stacking a material on the transport structure.

55. The method of claim 41, wherein the report comprises comprehensive diagnostic data indicating one of:
structural integrity rating data representing an assessment of an ability of the transport structure to withstand various forces and conditions without failing, deforming, or compromising safety of a load carried by the transport structure;
textual or image data characterizing structural properties of the transport structure, and
maintenance recommendation data representing a prescriptive plan to repair, restore, or treat the transport structure to:
extend a useful life of the transport structure,
ensure safety of the transport structure, or
ensure that the transport structure maintains performance standards.

56. A method for assessing, determining, or quantifying structural properties of a transport structure, the method comprising:
capturing, using a first image capture sensor and a second image capture sensor of an inspection system, a plurality of 2-dimensional (2D) images of an inspection area of the inspection system;
detecting, using an AI engine associated with the inspection system and based on the plurality of 2D images, a transport structure in a first image from the plurality of 2D images, wherein:
the first image comprises a first 2D image of the transport structure in the inspection area, and
the first image is captured from a first perspective of the first image capture sensor relative to the transport structure in the inspection area of the inspection system;
extracting, using the AI engine associated with the inspection system and based on the first image, a second image from the plurality of 2D images, wherein:
the second image comprises a second 2D image of the transport structure in the inspection area, and
the second image is captured from a second perspective of the second image capture sensor relative to the transport structure in the inspection area of the inspection system;
generating, using the AI engine and based on the first image and the second image:
a first computing model representing the transport structure from the first perspective, and
a second computing model representing the transport structure from the second perspective;
analyzing, using the AI engine, the first computing model and the second computing model, the analyzing comprising one or more of:
identifying or quantifying, based on the first computing model, first structural property data of the transport structure associated with the first image,
identifying or quantifying, based on the second computing model, second structural property data of the transport structure associated with the second image,
determining, based on one or more of the first structural property data and the second structural property data, impact data associated with the transport structure, and
generating, using at least one data processing unit associated with the inspection system, analysis data indicating one or more of:
an aggregate of the first structural property data, the second structural property data, and the impact data,
dimensional data associated with the transport structure,
maintenance or repair strategy data associated with the first structural property data, the second structural property data, or the impact data,
sorting logic data associated with the first structural property data, the second structural property data, or the impact data, and
inventory management data associated with the transport structure,
generating, using the data processing unit associated with the inspection system, a report comprising a data file that indicates the analysis data; and
initiate formatting, using the data processing unit associated with the inspection system, for display on a graphical interface, the report.

57. The method of claim 56, wherein the transport structure is a pallet or a crate.

58. The method of claim 56, wherein:
the first image capture sensor comprises at least a first color camera, and
the second image capture sensor comprises at least a second color camera.

59. The method of claim 56, wherein: the AI engine comprises a plurality of vision cores configured to implement feature classification computing operations on 2D images captured using one or more image capture sensors of the inspection system.

60. The method of claim 56, wherein at least one of the first image of the transport structure or the second image of the transport structure comprises or is associated with at least one of:
2D surface texture image data indicating material surface characteristics of the transport structure, or
2D deformable light pattern image data indicating a surface topology deviation caused by an illumination subsystem associated with the inspection system that projects one or more light patterns on the transport structure prior to, or during capturing the first image or the second image.

61. The method of claim 56, wherein:
a first application associated with the first image capture sensor transmits, from the first image capture sensor, the first image to a non-transitory computer memory device associated with the inspection system, and
a second application associated with the second image capture sensor transmits the second image to the non-transitory computer memory device associated with the inspection system, such that:
the first application and the second application operate independent of each other, and
the AI engine accesses the non-transitory computer memory device to retrieve or extract the first image and the second image.

62. The method of claim 56, wherein one or more of:
the first image capture sensor continuously captures a first set of images of the inspection area of the inspection system,
the second image capture sensor continuously captures a second set of images of the inspection area of the inspection system,
the plurality of 2D images of the inspection area comprises the first set of images and the second set of images,
the plurality of 2D images of the inspection area are transmitted to a non-transitory memory device associated with the inspection system, wherein:
in response to the AI engine retrieving at least the first image and the second image from the non-transitory memory device thereby resulting in a reduced amount of images in the non-transitory memory device, the reduced amount of images are deleted thereby optimizing a data storage capacity of the non-transitory memory device.

63. The method of claim 56, wherein:
the first image capture sensor or the second image capture sensor is applied to detect shadow data indicating one or more shadows projected onto the transport structure by at least an illumination unit associated with the inspection system, and
the method further comprising analyzing, using the AI engine, the shadow data to determine at least height information associated with protrusions on the transport structure.

64. The method of claim 56, wherein:
the first image capture sensor captures a top view image of the transport structure,
the second image capture sensor captures a side view image of the transport structure, and
the first image capture sensor and the second image capture sensor are arranged about the inspection system to be orthogonal relative to each other.

65. The method of claim 56, wherein the AI engine applies depth analysis to determine a height for the transport structure.

66. The method of claim 56, wherein one of:
the first computing model and the second computing model are independently analyzed by the AI engine to generate the first structural property data, the second structural property data, and the impact data, or
the first computing model and the second computing model are combined into an aggregate model representing the transport structure, such that the aggregate model is analyzed to generate the first structural property data, the second structural property data, and the impact data.

67. The method of claim 56, further comprising propelling, using a transport unit associated with the inspection system, the transport structure to the inspection area of the inspection system, wherein:
the transport unit propels the transport structure at a velocity adjusted according to type data of the transport structure,
the transport unit is integrated into the inspection system and is directly controlled by a first control logic associated with the inspection system, or
the transport unit is separate or distinct relative to the inspection system and is indirectly controlled by a second control logic that is not associated with the inspection system.

68. An inspection system for assessing, determining, or quantifying structural properties of a transport structure, the inspection system comprising:
a first image capture sensor configured to capture a first plurality of 2D images from a first perspective in an inspection area of the inspection system;
a second image capture sensor configured to capture a second plurality of 2D images from a second perspective in the inspection area,
a first application associated with the first image capture sensor, the first application comprising computing logic that is configured to transmit the first plurality of 2D images to a non-transitory computing memory device associated with the inspection system;
a second application associated with the second image capture sensor, the second application comprising computing logic that is configured to transmit the second plurality of 2D images to the non-transitory computing memory device associated with the inspection system;
an AI engine configured to:
access the non-transitory computing memory device associated with the inspection system to retrieve a first image from the first plurality of 2D images,
access, based on the first image, the non-transitory computing memory device associated with the inspection system to retrieve a second image from the second plurality of 2D images,
generate, based on the first image and the second image, a computing model representing the transport structure;
analyze the computing model, wherein to analyze the computing model comprises one or more of:
identifying or quantifying, based on the computing model, first structural property data of the transport structure associated with the first image,
identifying or quantifying, based on the computing model, second structural property data of the transport structure associated with the second image, and
determining, based on one or more of the first structural property data and the second structural property data, impact data associated with the transport structure; and
at least one data processing unit comprising computing logic that:
generates analysis data indicating one or more of:
an aggregate of the first structural property data, the second structural property data, and the impact data,
dimensional data associated with the transport structure,
maintenance or repair strategy data associated with the first structural property data, the second structural property data, or the impact data,
sorting logic data associated with the first structural property data, the second structural property data, or the impact data, and
inventory management data associated with the transport structure, generates a report comprising a data file that indicates the analysis data, and initiates formatting, for display on a graphical interface, the report.

69. A method for assessing, determining, or quantifying structural properties of a transport structure, the method comprising:
capturing, using a first image capture sensor and a second image capture sensor of an inspection system, a plurality of 2-dimensional (2D) images of an inspection area of the inspection system;
detecting, using an AI engine associated with the inspection system and based on the plurality of 2D images, a transport structure in a first image from the plurality of 2D images, wherein:
the first image comprises a first 2D image of the transport structure in the inspection area, and
the first image is captured from a first perspective of the first image capture sensor relative to the transport structure in the inspection area of the inspection system;
extracting, using the AI engine associated with the inspection system and based on the first image, a second image from the plurality of 2D images, wherein:
the second image comprises a second 2D image of the transport structure in the inspection area, and
the second image is captured from a second perspective of the second image capture sensor relative to the transport structure in the inspection area of the inspection system;
generating, using the AI engine and based on the first image and the second image, a computing model representing the transport structure;
analyzing, using the AI engine, the computing model representing the transport structure, the analyzing comprising one or more of:
identifying or quantifying, based on the computing model, first structural property data of the transport structure associated with the first image,
identifying or quantifying, based on the computing model, second structural property data of the transport structure associated with the second image, and
determining, based on one or more of the first structural property data and the second structural property data, impact data associated with the transport structure, and
generating, using at least one data processing unit associated with the inspection system, analysis data indicating one or more of:
an aggregate of the first structural property data, the second structural property data, and the impact data,
dimensional data associated with the transport structure,
maintenance or repair strategy data associated with the first structural property data, the second structural property data, or the impact data,
sorting logic data associated with the first structural property data, the second structural property data, or the impact data, and
inventory management data associated with the transport structure,
generating, using the data processing unit associated with the inspection system, a report comprising a data file that indicates the analysis data; and
initiate formatting, using the data processing unit associated with the inspection system, for display on a graphical interface, the report.

70. The method of claim 69, wherein:
the inspection system comprises a plurality of image capture sensors including the first image capture sensor and the second image capture sensor,
the first image capture sensor is paired with a third image capture sensor such that the first image capture sensor and the third image capture sensor are positioned to be opposite relative to each other,
the second image capture sensor is paired with a fourth image capture sensor such that the second image capture sensor and the fourth image capture sensor are positioned to be opposite relative to each other
the plurality of image capture sensors comprise a fifth image capture sensor opposite to a sixth image capture sensor in the inspection area of the inspection system, wherein:
the fifth image capture sensor is movable to have a field of view that covers a 45-degree or a 60-degree angular span, and
the sixth image capture sensor is movable to have a field of view that covers a 45-degree or a 60-degree angular span.
